(19) United States
(12) Patent Application Publication
(10) Pub. No.: US 2011/0134099 A1
(43) Pub. Date: Jun. 9, 2011

(54) ACTIVE MATRIX SUBSTRATE, LIQUID CRYSTAL PANEL, LIQUID CRYSTAL DISPLAY DEVICE, LIQUID CRYSTAL DISPLAY UNIT, TELEVISION RECEIVER

(75) Inventor: Toshihide Tsubata, Osaka (JP)

(73) Assignee: SHARP KABUSHIKI KAISHA, Osaka (JP)

(21) Appl. No.: 13/057,472

(22) PCT Filed: Jul. 9, 2009
(86) PCT No.: PCT/JP2009/062544

§ 371 Date: Feb. 3, 2011

(30) Foreign Application Priority Data
Aug. 25, 2008 (JP) 2008-215910

(51) Int. Cl. G09G 3/36; G06F 3/038; G02F 1/1343

(52) U.S. Cl. 345/211; 349/143; 345/90

(57) ABSTRACT

Disclosed is an active matrix substrate comprising a data signal line (15x), scan signal lines (16a, 16b), a transistor (12a) connected to the data signal line (15x) and the scan signal line (16a), a transistor (12b) connected to the scan signal line (16b), and pixel electrodes (17a, 17b) formed within a pixel (101) area. The pixel electrode (17a) is connected to the data signal line (15x) via the transistor (12a). The pixel electrode (17b) is connected to the pixel electrode (17a) via a capacitance (C101), and is electrically connected to the pixel electrode (17a) via the transistor (12b).

### BACKGROUND OF THE INVENTION

1. Technical Field

The present invention relates to an active matrix substrate provided with a plurality of pixel electrodes in one pixel area and to a liquid crystal display device using such an active matrix substrate (pixel division system).

2. Background Art

In order to improve the viewing angle dependency of a gamma characteristic of a liquid crystal display device (for example, to prevent whitening problems of a screen), a liquid crystal display device that controls a plurality of subpixels provided in one pixel at different brightness to display a halftone by area gradation of the subpixels (pixel division system; see Patent Document 1, for example) has been proposed.

In an active matrix substrate described in Patent Document 1, as shown in FIG. 48, a pixel area is established between two adjacent gate bus lines 112; a pixel electrode 121a is arranged at an upper edge of the pixel area (a section adjacent to the gate bus line); a pixel electrode 121b is arranged in the middle thereof; a pixel electrode 121c is arranged at a lower edge thereof (a section adjacent to the next gate bus line); the pixel electrodes 121a, 121c are connected to a source-lead-out wiring 119 led out from a source electrode 116s of a transistor 116; a control electrode 118 connected to the source-lead-out wiring 119 overlaps the pixel electrode 121b via an insulating layer; and the middle pixel electrode 121b is capacitively coupled to the pixel electrodes 121a, 121c, respectively (capacitance coupling type pixel division system). In a liquid crystal display device using the above-mentioned active matrix substrate, each of subpixels corresponding to the pixel electrodes 121a, 121c can be designated as a bright subpixel, while a subpixel corresponding to the pixel electrode 121b can be designated as a dark subpixel. As a result, it becomes possible to display a halftone by area gradation of the aforementioned two bright subpixels and one dark subpixel. Here, as in the case of the pixel electrode 121b, a pixel electrode that is connected to (capacitively coupled to) pixel electrodes into which normal pixel data is written (in this example, the pixel electrodes 121a, 121c) and that becomes floating during normal writing is referred to as “pixel electrode in floating state” or “capacitance coupling electrode” in the present specification.

In the above-described liquid crystal display device using the capacitance coupling type pixel division system, it is known that a burn-in occurs at the subpixels including the pixel electrode 121b due to electric charges accumulated in the pixel electrode 121b that is capacitively coupled. This burn-in becomes particularly apparent when the pixel electrode 121b is arranged in the floating state.

Specifically, as shown in FIG. 49, a pixel electrode 61b is directly connected to a source line 55 via a transistor 56, and as the transistor 56 is turned on in every frame, the pixel electrode 61b and a data bus line 55 are electrically connected. Therefore, an electric charge accumulated in the pixel electrode 61b while the transistor 56 is off flows to the source line 55 when the transistor 56 is on. As a result, direct current voltage components rarely remain in the pixel electrode 61b, thereby making it unlikely that the burn-in occurs therein. On the other hand, in the pixel electrode 61a that is capacitively coupled to the pixel electrode 61b, an electric charge accumulated in the pixel electrode 61a remains even when the transistor 56 is turned on. Therefore, direct current voltage components remain in the pixel electrode 61a, which causes the burn-in to occur in the subpixels including the pixel electrode 61a.

As a method to solve this burn-in issue, Patent Document 1 discloses a configuration of an active matrix substrate in which a pixel electrode, which is directly linked to a transistor connected to a gate line of the current row, and a pixel electrode, which is in the floating state and capacitively coupled to the aforementioned pixel electrode, are electrically connected to each other through a transistor connected to the gate line of the previous row. Specifically, as shown in FIG. 50, a pixel electrode 121b, which is in floating state and is capacitively coupled to a pixel electrode 121a, is connected to the pixel electrode 121a via a transistor 411 connected to the gate line of the previous row 112 (n−1). According to this configuration, transistor 411 is turned on before a display voltage is applied to the subpixel electrodes 121a, 121c and to a control electrode 118 via a transistor 116, and the potential of the pixel electrode 121b becomes the same as the potential of the pixel electrodes 121a, 121c that are connected to the transistor 116 and as the potential of the control electrode 118. Therefore, the electric charge accumulated in the pixel electrode 121b flows to the pixel electrodes 121a, 121c and to the control electrode 118. As a result, the accumulation of electric charge in the pixel electrode in floating state can be suppressed, thereby preventing the occurrence of burn-in in the subpixels including the aforementioned pixel electrode.

### RELATED ART DOCUMENTS

### Patent Documents

Patent Document 1: Japanese Patent Application Laid-Open Publication No. 2006-39290 (published Feb. 9, 2006)

### SUMMARY OF THE INVENTION

### Problems to be Solved by the Invention

However, in the configuration disclosed in Patent Document 1, the workload of gate lines becomes heavy because each of the gate lines is shared between normal writing into a pixel electrode and discharging (refreshing) electric charge from a capacitively-coupled pixel electrode, which is problematic. Therefore, when the above-described configuration is applied to a liquid crystal display device that supports recent large-scale, high-definition feature or double-speed drive feature, negative influences on writing operation are anticipated, which may lead to the deterioration of display quality as a result.

In the configuration described above, subpixels are simply connected to each other. Therefore, according to the law of conservation of charge, the amount of electrical charge of the pixel electrode in the floating state decreases, but the total amount of electrical charge within a pixel area does not change. That is, the charge is simply averaged out among each of the pixel electrodes. Therefore, the direct current voltage component remains in the pixel electrode in the floating state. As a result, a desired voltage cannot be obtained when a display voltage is applied, which lowers the display quality.

The present invention proposes configurations according to which the occurrence of burn-in in subpixels can be reduced in a liquid crystal display device that uses a capacitance coupling type pixel division system and that supports a large-scale, high-definition feature or double-speed drive feature.

### Means for Solving the Problems

The present active matrix substrate includes a data signal line, first and second scan signal lines, a first transistor connected to the data signal line and to the first scan signal line, a second transistor connected to the second scan signal line, and first and second pixel electrodes formed in one pixel area. The first pixel electrode is connected to the data signal line via the first transistor, while the second pixel electrode is connected to the first pixel electrode via a capacitance and also electrically connected to the first pixel electrode via the second transistor.

In a liquid crystal display device using the present active matrix substrate, the respective pixel electrodes in one pixel area are connected to the data signal line via respective transistors that are connected to different scan signal lines. Therefore, it is possible to supply a signal potential to each of the pixel electrodes at different timings. Therefore, for example, before a signal potential for normal writing is supplied to one of pixel electrodes (first pixel electrode), a signal potential (Vcom, for example) can be supplied to the other thereof (second pixel electrode) that is capacitively coupled to the first pixel electrode by electrically connecting the second pixel electrode to the data signal line via a transistor.

As described above, prior to normal writing, it is possible to supply, without going through a capacitance, a signal potential from a data signal line to the pixel electrode (capacitance coupling electrode) that is capacitively coupled to a pixel electrode connected to a data signal line via a transistor, which then allows discharging (refreshing) of the electric charge accumulated in the this capacitance coupling electrode. As a result, the occurrence of burn-in in subpixels including the above-mentioned pixel electrode can be reduced. Additionally, unlike the conventional configuration, scan signal lines are not shared for writing of normal signals into a pixel electrode and for discharging (refreshing) of accumulated electric charges from a capacitively-coupled pixel electrode. Instead, scan signal lines are individually provided for the respective pixel electrodes. As a result, the workload of the scan signal lines is reduced, thereby allowing an application to a liquid crystal display device that supports large-scale, high-definition feature and/or double speed drive feature.

The present active matrix substrate may also be configured to further include a third pixel electrode, which is formed in the pixel area and electrically connected to the first pixel electrode.

The present active matrix substrate may also be configured to further include a third pixel electrode, which is formed in the pixel area and is electrically connected to the first pixel electrode via a capacitance and also is electrically connected to the second pixel electrode.

The present active matrix substrate may also be configured to have a storage capacitance formed between the first pixel electrode and the second scan signal line.

The present active matrix substrate may also be configured to further include a storage capacitance formed between the second pixel electrode and the second scan signal line.

The present active matrix substrate may also be configured to further include a storage capacitance wiring, which forms a storage capacitance with the first pixel electrode.

The present active matrix substrate may also be configured such that the storage capacitance wiring further forms a storage capacitance with the second pixel electrode.

The present active matrix substrate may also be configured to have a storage capacitance electrode formed in the same layer as conductive electrodes of the first and second transistors, in which the storage capacitance electrode is electrically connected to one of the first and second pixel electrodes and also overlaps the storage capacitance wiring via a gate insulating film.

The present active matrix substrate may also be configured to have a coupling capacitance electrode formed in the same layer as conductive electrodes of the first and second transistors, in which the coupling capacitance electrode is electrically connected to one of the first and second pixel electrodes and overlaps the other one thereof via an interlayer insulating film, and also overlaps the storage capacitance wiring via a gate insulating film.

The present active matrix substrate may also be configured such that the active matrix substrate further includes a storage capacitance wiring; that the pixel area is divided into two sections by the storage capacitance wiring crossing the pixel area; that the first pixel electrode is arranged at one section of the divided pixel area and the third pixel electrode is arranged at the other section thereof; and that the second pixel electrode is arranged between the first and third pixel electrodes.

The present active matrix substrate may also be configured such that the active matrix substrate further includes a storage capacitance wiring; that the pixel area is divided into two sections by the storage capacitance wiring crossing the pixel area; that the second pixel electrode is arranged at one section of the divided pixel area and the third pixel electrode is arranged at the other section thereof; and that the first pixel electrode is arranged between the second and third pixel electrodes.

The present active matrix substrate may also be configured such that the first through third pixel electrodes are arranged such that at least a portion of the first pixel electrode is adjacent to the first scan signal line; that at least a portion of the third pixel electrode is adjacent to the second scan signal line; and that at least one edge of the second pixel electrode is adjacent to the first scan signal line while the other edge thereof is adjacent to the second scan signal line.

The present active matrix substrate may also be configured such that the first through third pixel electrodes are arranged such that at least a portion of the second pixel electrode is adjacent to the first scan signal line; that at least a portion of the third pixel electrode is adjacent to the second scan signal line; and that at least one edge of the first pixel electrode is adjacent to the first scan signal line while the other edge thereof is adjacent to the second scan signal line.

The present active matrix substrate may also be configured such that the active matrix substrate includes a coupling capacitance electrode that overlaps the second pixel electrode via an interlayer insulating film; that a first lead-out wiring led out from a conductive electrode of the first transistor is connected to the coupling capacitance electrode within the same layer; that the first lead-out wiring is connected to the first pixel electrode via a contact hole; that a second lead-out wiring led out from one conductive electrode of the second transistor is connected to the second pixel electrode via a contact hole; and that a third lead-out wiring led out from the other conductive electrode of the second transistor is connected to the first pixel electrode via a contact hole.

The present active matrix substrate may also be configured such that the active matrix substrate includes a coupling capacitance electrode that overlaps the second pixel electrode via an interlayer insulating film; that a first lead-out wiring led out from a conductive electrode of the first transistor is connected to the coupling capacitance electrode within the same layer; that the first lead-out wiring is connected to the first pixel electrode via a contact hole; that a second lead-out wiring led out from one conductive electrode of the second transistor is connected to the second pixel electrode via a contact hole; and that an extended coupling capacitance electrode connected to the coupling capacitance electrode is connected to the other conductive electrode of the second transistor.

The present active matrix substrate may also be configured such that the active matrix substrate includes a coupling capacitance electrode that overlaps the second pixel electrode via an interlayer insulating film; that a first lead-out wiring led out from a conductive electrode of the first transistor is connected to the coupling capacitance electrode within the same layer; that the first lead-out wiring is connected to the first pixel electrode via a contact hole; that a second lead-out wiring led out from one conductive electrode of the second transistor is connected to the second pixel electrode via a contact hole; that a third lead-out wiring led out from the other conductive electrode of the second transistor is connected to the coupling capacitance electrode within the same layer; and that the third lead-out wiring is connected to the third pixel electrode via a contact hole.

The present active matrix substrate may also be configured such that the active matrix substrate includes a coupling capacitance electrode that overlaps the second pixel electrode via an interlayer insulating film; that a first lead-out wiring led out from a conductive electrode of the first transistor is connected to the coupling capacitance electrode within the same layer; that the first lead-out wiring is connected to the first pixel electrode via a contact hole; that a second lead-out wiring led out from one conductive electrode of the second transistor is connected to the second pixel electrode via a contact hole; that a third lead-out wiring led out from the other conductive electrode of the second transistor is connected to the first pixel electrode via a contact hole; and that the third lead-out wiring is connected to the third pixel electrode via a contact hole.

The present active matrix substrate may also be configured such that the active matrix substrate includes a coupling capacitance electrode that overlaps the second pixel electrode via an interlayer insulating film; that a first lead-out wiring led out from a conductive electrode of the first transistor is connected to the coupling capacitance electrode within the same layer; that the first lead-out wiring is connected to the first pixel electrode via a contact hole; that a second lead-out wiring led out from one conductive electrode of the second transistor is connected to the second pixel electrode via a contact hole; that the second lead-out wiring is connected to the third pixel electrode via a contact hole; and that a third lead-out wiring led out from the other conductive electrode of the second transistor is connected to the first pixel electrode via a contact hole.

The present active matrix substrate may also be configured such that at least a portion of a section of the interlayer insulating film overlapping the coupling capacitance electrode is thinned.

The present active matrix substrate may also be configured such that at least a portion of a section of the gate insulating film overlapping the storage capacitance electrode is thinned.

The present active matrix substrate may also be configured such that the interlayer insulating film is composed of an inorganic insulating film and an organic insulating film, and that the organic insulating film is removed from at least a portion of a section of the interlayer insulating film overlapping the coupling capacitance electrode.

The present active matrix substrate may also be configured such that the gate insulating film is composed of an inorganic insulating film and of an organic insulating film, and that the organic insulating film is removed from at least a portion of a section of the gate insulating film overlapping the storage capacitance electrode.

The present active matrix substrate may also be configured such that the organic insulating film may contain at least one of acrylic resin, epoxy resin, polyimide resin, polyurethane resin, novolak resin, and siloxane resin.

The present active matrix substrate may also be configured such that when the active matrix substrate is applied to a liquid crystal display device, subpixels including the first pixel electrode function as bright subpixels, while subpixels including the second pixel electrode function as dark subpixels.

The present active matrix substrate may also be configured such that when the active matrix substrate is applied to a liquid crystal display device, subpixels including the first and third pixel electrodes function as bright subpixels, while subpixels including the second pixel electrode function as dark subpixels.

The present active matrix substrate may also be configured such that when the active matrix substrate is applied to a liquid crystal display device, subpixels including the first pixel electrode function as bright subpixels, while subpixels including the second and third pixel electrodes function as dark subpixels.

The present active matrix substrate may also be configured such that a storage capacitance is formed between at least one of the first and second pixel electrodes provided in the pixel area in the current row and at least one of the first and second scan signal lines that correspond to the pixel area in the previous row.

The present active matrix substrate may also be configured such that when an extension direction of scan signal lines is regarded as the row direction, two scan signal lines correspond to two pixel areas aligned in the row direction; two pixel electrodes are aligned in the column direction in each of the pixel areas; a transistor that is connected to one of the two pixel electrodes adjacent in the row direction is connected to one of the two scan signal lines; and a transistor that is connected to the other of these two pixel electrodes is connected to the other of the two scan signal lines.

The present liquid crystal display device includes one of the above-described active matrix substrates and is configured such that the second scan signal line is selected at least once during display.

The present liquid crystal display device may also be configured such that when the second transistor is turned off, a common electrode potential has been supplied to the data signal line.

The present liquid crystal display device may also be configured such that when the second transistor is turned off, the first transistor stays on; or such that when the second transistor is turned off, the first transistor is turned off at the same time.

The present liquid crystal display device may also be configured such that when the second transistor is turned off, the potentials of the first and second pixel electrodes substantially become a common electrode potential.

The present liquid crystal display device may also be configured such that a first gate-on pulse signal supplied to the first scan signal line and a second gate-on pulse signal supplied to the second scan signal line become active during the same horizontal scanning period; that the pulse width of the second gate-on pulse signal is shorter than that of the first gate-on pulse signal; and that the second gate-on pulse signal becomes inactive before the first gate-on pulse signal becomes inactive.

The present liquid crystal display device may also be configured such that a first gate-on pulse signal supplied to the first scan signal line and a second gate-on pulse signal supplied to the second scan signal line become active during the horizontal scanning period immediately prior to a period during which a signal potential of a data signal to be displayed is supplied to the first pixel electrode; and that the second gate-on pulse signal becomes inactive while the first gate-on pulse signal is active.

The present liquid crystal display device may also be configured such that a common electrode potential is supplied to all pixel electrodes of one pixel area at least twice in each frame.

The present liquid crystal display device may also be configured such that in each frame, a common electrode potential is supplied to all pixel electrodes of one pixel area at least twice after two-thirds of a frame period has passed after a signal potential of a data signal to be displayed is supplied to the first pixel electrode.

The present liquid crystal display device may also be configured such that the polarity of a signal potential of a data signal to be supplied to each data signal line is reversed every horizontal scanning period; that when the polarity of the signal potential of the data signal is reversed, a supply of the data signals to each data signal line is terminated for a predetermined period, and each data signal line short-circuits to each other; and that the first and second transistors remain in the ON state during the above-mentioned predetermined period of time.

The present liquid crystal display device may also be configured such that the liquid crystal display device includes a scan signal line drive circuit that drives each of scan signal lines; and that first and second gate-on pulse signals to be supplied respectively to the first and second scan signal lines are generated using an output from a single stage of a shift register included in the above-mentioned scan signal line drive circuit.

The present liquid crystal display device may also be configured such that the scan signal line drive circuit includes the above-mentioned shift register, a plurality of logic circuits arranged in the column direction, and an output circuit, and that the pulse widths of the first and second gate-on pulse signals outputted from the output circuit are determined based on an output of the shift register and an output control signal that controls the output of the scan signal line drive circuit, both of which are inputted to the logic circuit.

The present liquid crystal display device may also be configured such that the polarity of a signal potential supplied to the first pixel electrode is reversed every frame.

The present liquid crystal display device may also be configured such that the polarity of a signal potential supplied to the first data signal line is reversed every horizontal scanning period.

The present liquid crystal display device may also be configured such that signal potentials having reversed polarities are supplied to a first data signal line and to a data signal line adjacent thereto, respectively, during each horizontal scanning period.

The present liquid crystal panel includes the above-described active matrix substrate. The present liquid crystal display unit includes the above-mentioned liquid crystal panel and a driver. The present liquid crystal display device includes the above-mentioned liquid crystal display unit and a light source device. The present television receiver includes the above-mentioned liquid crystal display device and also a tuner that receives television broadcasting.

### EFFECTS OF THE INVENTION

As described above, a liquid crystal display device using the present active matrix substrate is capable of discharging (refreshing) accumulated electric charges from a pixel electrode that is capacitively coupled to a pixel electrode connected to a data signal line via a transistor, thereby preventing the occurrence of burn-in in subpixels including the aforementioned pixel electrode. Therefore, it becomes possible to reduce the occurrence of burn-in in subpixels even for a liquid crystal display device that supports the large-scale, high-definition feature and/or the double-speed drive feature.

### BRIEF DESCRIPTION OF THE DRAWINGS

FIG. 1 is a circuit diagram showing a configuration of a liquid crystal panel 5a.

FIG. 2 is a plan view showing a configuration of a liquid crystal panel 5a (specific example

FIG. 3 is a plan view showing another configuration of a liquid crystal panel 5a.

FIG. 4 is a cross-sectional view showing a specific example of a cross section A-B of FIG. 2.

FIG. 5 is a cross-sectional view showing another specific example of a cross section A-B of FIG. 2.

FIG. 6 is a plan view showing another configuration of a liquid crystal panel 5a (modification 1).

FIG. 7 is a plan view showing another configuration of a liquid crystal panel 5a (modification 2).

FIG. 8 is a circuit diagram showing another configuration of a liquid crystal panel 5a (specific example 1-2).

FIG. 9 is a plan view of showing another configuration of a liquid crystal panel 5a (specific example 1-2).

FIG. 10 is a plan view showing another configuration of a liquid crystal panel 5a shown in FIG. 9.

FIG. 11 is a plan view showing another configuration of a liquid crystal panel 5a shown in FIG. 9.

FIG. 12 is a plan view showing another configuration of a liquid crystal panel 5a shown in FIG. 9.

FIG. 13 is a plan view showing another configuration of a liquid crystal panel 5a shown in FIG. 9.

FIG. 14 is a circuit diagram showing another configuration of a liquid crystal panel 5a (specific example 1-3).

FIG. 15 is a plan view showing another configuration of a liquid crystal panel 5a (specific example 1-3).

FIG. 16 is a plan view showing another configuration of a liquid crystal panel 5a shown in FIG. 15.

FIG. 17 is a timing chart showing a driving method of a liquid crystal display device that includes the liquid crystal panel 5a, 5b, or 5c (driving method 1).

FIG. 18 is a circuit diagram showing a configuration of a gate driver that drives liquid crystal panels 5a, 5b, 5c.

FIG. 19 is a timing chart showing a driving method of a gate driver shown in FIG. 18.

FIG. 20 is a timing chart showing another driving method of a liquid crystal display device that includes liquid crystal panel 5a, 5b, or 5c (driving method 2).

FIG. 21 is a circuit diagram showing another configuration of a gate driver that drives liquid crystal panels 5a, 5b, 5c.

FIG. 22 is a timing chart showing a driving method of a gate driver shown in FIG. 21.

FIG. 23 is a timing chart showing another driving method of a liquid crystal display device that includes the liquid crystal panel 5a, 5b, or 5c (driving method 3).

FIG. 24 is a circuit diagram showing another configuration of a gate driver that drives liquid crystal panels 5a, 5b, 5c.

FIG. 25 is a timing chart showing a driving method of a gate driver shown in FIG. 24.

FIG. 26 is a timing chart showing another driving method of a liquid crystal display device that the liquid crystal panel 5a, 5b, or 5c (driving method 4).

FIG. 27 is a circuit diagram showing a configuration of a liquid crystal panel 5b.

FIG. 28 is a plan view showing a configuration of a liquid crystal panel 5b (specific example 2-1).

FIG. 29 is a plan view showing another configuration of a liquid crystal panel 5b shown in FIG. 28.

FIG. 30 is a circuit diagram showing another configuration of a liquid crystal panel 5b (specific example 2-2).

FIG. 31 is a plan view showing another configuration of a liquid crystal panel 5b (specific example 2-2).

FIG. 32 is a plan view showing another configuration of a liquid crystal panel 5b shown in FIG. 31.

FIG. 33 is a plan view showing another configuration of a liquid crystal panel 5b shown in FIG. 31.

FIG. 34 is a circuit diagram showing another configuration of a liquid crystal panel 5b (specific example 2-3).

FIG. 35 is a plan view showing another configuration of a liquid crystal panel 5b (specific example 2-3).

FIG. 36 is a plan view showing another configuration of a liquid crystal panel 5b shown in FIG. 35.

FIG. 37 is a circuit diagram showing a configuration of a liquid crystal panel 5c.

FIG. 38 is a plan view showing a configuration of a liquid crystal panel 5c (specific example 3-1).

FIG. 39 is a plan view showing a configuration of a liquid crystal panel 5a having a MVA structure.

FIG. 40 is an enlarged plan view showing a portion of a liquid crystal panel 5a shown in FIG. 39.

FIG. 41(a) is a schematic view showing a configuration of the present liquid crystal display unit, and FIG. 41(b) is a schematic view showing a configuration of the present liquid crystal display device.

FIGS. 42(a) and 42(b) are circuit diagrams showing other configurations of a source driver.

FIG. 43 is a circuit diagram showing still another configuration of a source driver.

FIG. 44 is a block diagram explaining an entire construction of the present liquid crystal display device.

FIG. 45 is a block diagram explaining functions of the present liquid crystal display device.

FIG. 46 is a block diagram explaining functions of the present television receiver.

FIG. 47 is an exploded perspective view showing a configuration of the present television receiver.

FIG. 48 is a plan view showing a configuration of a conventional liquid crystal panel.

FIG. 49 is a plan view showing a configuration of a conventional liquid crystal panel.

FIG. 50 is a plan view showing a configuration of a conventional liquid crystal panel.

FIG. 51 is a plan view showing another configuration of a liquid crystal panel 5a.

FIG. 52 is a plan view showing another configuration of a liquid crystal panel 5a (specific example 1-4).

FIGS. 53(a) and 53(b) are schematic views showing a display condition in each frame when a driving method shown in FIG. 17 is used for a liquid crystal panel 5a described in FIG. 52.

### DETAILED DESCRIPTION OF EMBODIMENTS

Preferred embodiments of the present invention are described using drawings as follows. For convenience of description, the extension direction of scan signal lines is referred to as the row direction in the following. Needless to say, however, the scan signal lines may be extended in either horizontal or vertical direction when a liquid crystal display device (or a liquid crystal panel or an active matrix substrate used therein) of the present invention is in use (viewed). Also, the channel characteristics (n-type, p-type) of transistors should not be limited to what is described in the following embodiments.

Configuration examples of a liquid crystal panel of the present invention can be broadly categorized into two types: (1) a liquid crystal panel has a storage capacitance wiring, and (2) a liquid crystal panel does not have a storage capacitance wiring (“Cs on gate” structure). Here, a first embodiment is configuration type (1) in which a liquid crystal panel has a storage capacitance wiring, and a second embodiment is configuration type (2) in which a liquid crystal panel does not have a storage capacitance wiring (“Cs on gate” structure). Also, a third embodiment is a configuration example of a liquid crystal panel in which the above-mentioned configurations are combined, i.e., a liquid crystal panel display having both a storage capacitance wiring and a “Cs on gate” structure. For convenience of description, the same reference characters are given to components having the same functions in these embodiments, and terms defined in the first embodiment are used in the second and third embodiments according to the same definition thereof unless otherwise noted.

### First Embodiment

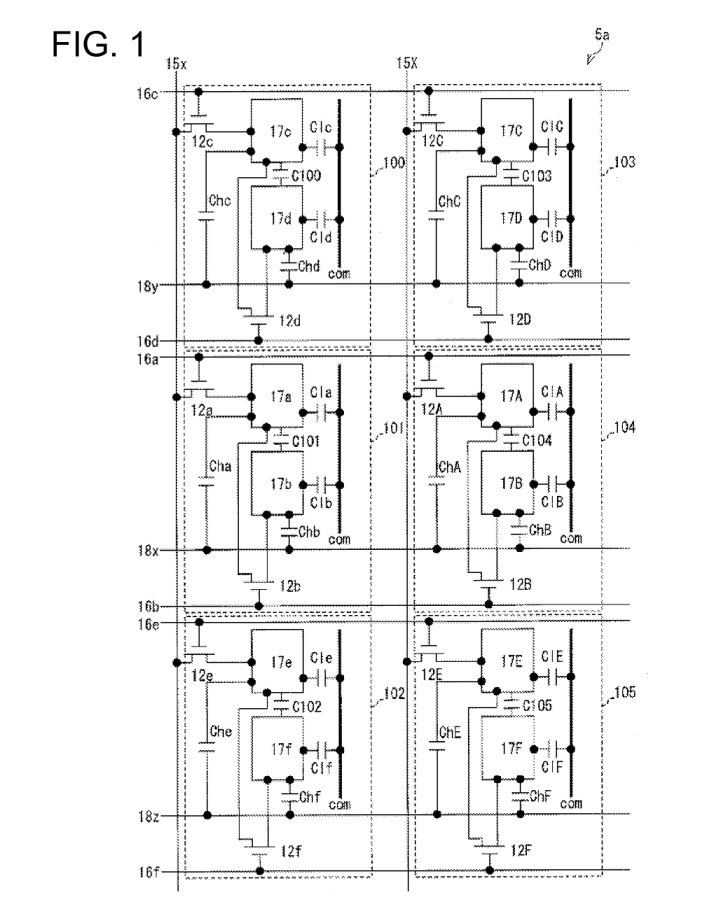

FIG. 1 is an equivalent circuit diagram showing a portion of a liquid crystal panel of a first embodiment. As shown in FIG. 1, a liquid crystal panel 5a includes data signal lines (15x, 15X) extending in the column direction (the up-down direction in the diagram); scan signal lines (16a to 16f) extending in the row direction (the left-right direction in the diagram); pixels (100 to 105) aligned in both row and column directions; storage capacitance wirings (18x to 18z); and a common electrode (an opposite electrode) “com.” Each pixel has an identical configuration. Also, a pixel column containing the pixels 100 to 102 and a pixel column containing the pixels 103 to 105 are aligned adjacently.

In the liquid crystal panel 5a, one data signal line and two scan signal lines are provided in one pixel. Two pixel electrodes 17c, 17d provided in the pixel 100, two pixel electrodes 17a, 17b provided in the pixel 101, and two pixel electrodes 17e, 17f provided in the pixel 102 are aligned in one column. Two pixel electrodes 17C, 17D provided in the pixel 103, two pixel electrodes 17A, 17B provided in the pixel 104, and two pixel electrodes 17E, 17F provided in the pixel 105 are aligned in one column. The pixel electrodes 17c, 17C, the pixel electrodes 17d, 17D, the pixel electrodes 17a, 17A, the pixel electrodes 17b, 17B, the pixel electrodes 17e, 17E, and the pixel electrodes 17f, 17F are aligned adjacently to each other in the row direction, respectively.

Because each pixel has an identical configuration, the following mainly describes the configuration of the pixel 101 as an example.

In the pixel 101, the pixel electrodes 17a, 17b (first and second pixel electrodes) are connected to each other via a coupling capacitance C101; the pixel electrode 17a is connected to the data signal line 15x via a transistor 12a (first transistor) connected to a scan signal line 16a (first scan signal line); the pixel electrode 17b is connected to a pixel electrode 17a via a transistor 12b (second transistor) connected to a scan signal line 16b (second scan signal line); a storage capacitance Cha is formed between the pixel electrode 17a and the storage capacitance wiring 18x; a storage capacitance Chb is formed between the pixel electrode 17b and the storage capacitance wiring 18x; a liquid crystal capacitance C1a is formed between the pixel electrode 17a and a common electrode “com”; and a liquid crystal capacitance C1b is formed between the pixel electrode 17b and the common electrode “com.”

According to the above-described configuration, the pixel electrode 17b is capacitively coupled to the pixel electrode 17a into which a normal signal potential is written. Therefore, the potential of the pixel electrode 17b after the transistor 12a is turned off is determined by Va×(Cα/(Cα+Co)) where the capacitance values are set as C1a=C1b=C1, Cha=Chb=Ch, and Co=C1+Ch, respectively; the capacitance value of C101 is Cα, and the potential at the pixel electrode 17a after the transistor 12a is turned off as Va. Thus, the subpixel including the pixel electrode 17a is a bright subpixel (hereinafter referred to as “bright”) and the subpixel including the pixel electrode 17b is a dark subpixels (hereinafter referred to as “dark”). As a result, a liquid crystal display device using a pixel division system can be realized.

Also, in a liquid crystal display device using a pixel division system and including the above-mentioned liquid crystal panel 5a, the pixel electrodes 17a and 17b in a pixel area of a pixel 101 are electrically connected to each other via a transistor 12b connected to a scan signal line 16b, which is different from a scan signal 16a connected to the pixel electrode 17a via the transistor 12a. Therefore, an identical signal potential can be directly supplied from the data signal line 15x to each of the pixel electrodes 17a and 17b via the transistors 12a and 12b, respectively. In other words, a signal potential can be supplied, without going through a capacitance, from the data signal line 15x to the pixel electrode 17b that is capacitively coupled to the pixel electrode 17a connected to the data signal line 15x via the transistor 12a. Further, the transistors 12a and 12b, which are connected to the pixel electrodes 17a and 17b, respectively, are connected to different scan signal lines 16a and 16b, respectively. As a result, for example, an identical signal potential can be supplied to the pixel electrodes 17a and 17b at timing which is different from the timing at which a normal signal potential is written into the pixel electrode 17a.

According to the configuration of the present invention, as described above, the capacitance coupling electrode (pixel electrode 17b) can electrically be connected to the data signal line 15x by turning the transistor 12b on. As a result, a signal potential can be supplied from the data signal line 15x to the pixel electrode 17b via the transistor 12b.

Here, when a normal signal potential is written into the pixel electrode 17a, for example, a signal potential (for example, a Vcom signal) is supplied from the data signal line 15x to the pixel electrodes 17a and 17b via the transistor 12b prior to the aforementioned writing of the normal signal potential. This signal potential (Vcom) may be supplied in a charge-sharing system or may also be supplied to all data signal lines by turning all transistors on. As a result, the signal potential (Vcom) is written into the capacitively-coupled pixel electrode 17b, thereby allowing electric charge accumulated in the pixel electrode to be discharged (refreshed). As a result, it is possible to suppress burn-in of the subpixels including the pixel electrode.

A liquid crystal display device according to the present invention is advantageous mainly because of the above-described configuration and unique advantages deriving therefrom. The following is the description of specific examples and driving methods of a liquid crystal panel 5a that constructs a liquid crystal display device of the present embodiment.

### Specific Example of Liquid Crystal Panel 1-1

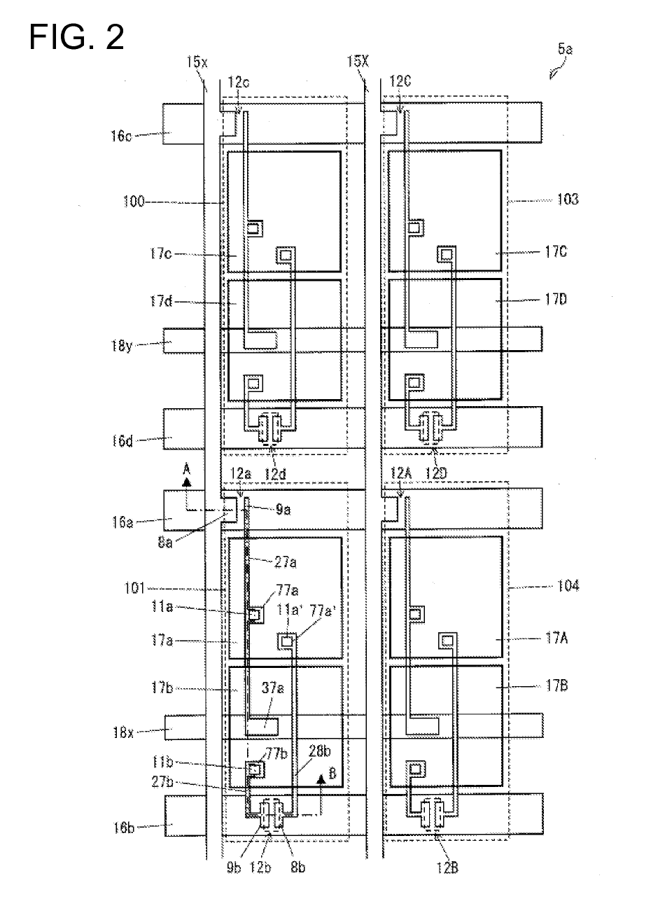

A specific example 1-1 of a liquid crystal panel 5a is shown in FIG. 2. In the liquid crystal panel 5a in FIG. 2, a data signal line 15x is provided so as to align along pixels 100, 101; a data signal line 15x is provided so as to align along pixels 103, 104; a storage capacitance wiring 18y passes across the pixels 100, 103, respectively; and a storage capacitance wiring 18x passes across the pixels 101, 104, respectively.

Here, a scan signal line 16c is arranged at one edge of the pixel 100, while a scan signal line 16d is arranged at the other edge thereof. Viewed planarly, pixel electrodes 17c, 17d are aligned in the column direction between the scan signal lines 16c, 16d. In the same manner, the scan signal line 16c is arranged at one edge of the pixel 103, while the scan signal line 16d is arranged at the other edge thereof. Viewed planarly, pixel electrodes 17C, 17D are aligned in the column direction between the scan signal lines 16c, 16d.

Additionally, a scan signal line 16a is arranged at one edge of the pixel 101, while a scan signal line 16b is arranged at the other edge thereof. Viewed planarly, pixel electrodes 17a, 17b are aligned in the column direction between the scan signal lines 16a, 16b. In the same manner, the scan signal line 16a is arranged at one edge of the pixel 104, while the scan signal line 16b is arranged at the other edge thereof. Viewed planarly, pixel electrodes 17A, 17B are aligned in the column direction between the scan signal lines 16a, 16b.

In the pixel 101, a source electrode 8a and a drain electrode 9a of a transistor 12a are formed over the scan signal line 16a, and a source electrode 8b and a drain electrode 9b of a transistor 12b are formed over the scan signal line 16b. The source electrode 8a is connected to the data signal line 15x. The drain electrode 9a is connected to a drain lead-out wiring 27a; the drain lead-out wiring 27a is connected to a contact electrode 77a and to a coupling capacitance electrode 37a; the contact electrode 77a is connected to the pixel electrode 17a via a contact hole 11a; and the coupling capacitance electrode 37a overlaps the pixel electrode 17b via an interlayer insulating film. As a result, a coupling capacitance C101 (see FIG. 1) between the pixel electrodes 17a, 17b is formed.

Also, the source electrode 8b of the transistor 12b is connected to a source lead-out wiring 28b, and the source lead-out wiring 28b is connected to the contact electrode 77a′, and the contact electrode 77a′ is connected to the pixel electrode 17a via a contact hole 11a′. The drain electrode 9b is connected to a drain lead-out wiring 27b; the drain lead-out wiring 27b is connected to a contact electrode 77b; and the contact electrode 77b is connected to the pixel electrode 17b via a contact hole 11b.

Also, the coupling capacitance electrode 37a overlaps the storage capacitance wiring 18x via a gate insulating film, thereby forming a storage capacitance Cha (see FIG. 1), and also forming a storage capacitance Chb between the pixel electrode 17b and the storage capacitance wiring 18x (see FIG. 1). When the storage capacitance Chb is formed without a storage capacitance electrode in this way, a problem that a coupling capacitance electrode 37a short-circuits a storage capacitance electrode doesn't occur. Therefore, the possibility of short-circuit between the pixel electrodes 17a, 17b can be advantageously reduced. The configuration (geometry and alignment of each component and connection relation therebetween) of other pixels is identical to that of the pixel 101.

According to the aforementioned configuration, the subpixel including the pixel electrode 17a is “bright” while the subpixel including the pixel electrode 17b is “dark.”

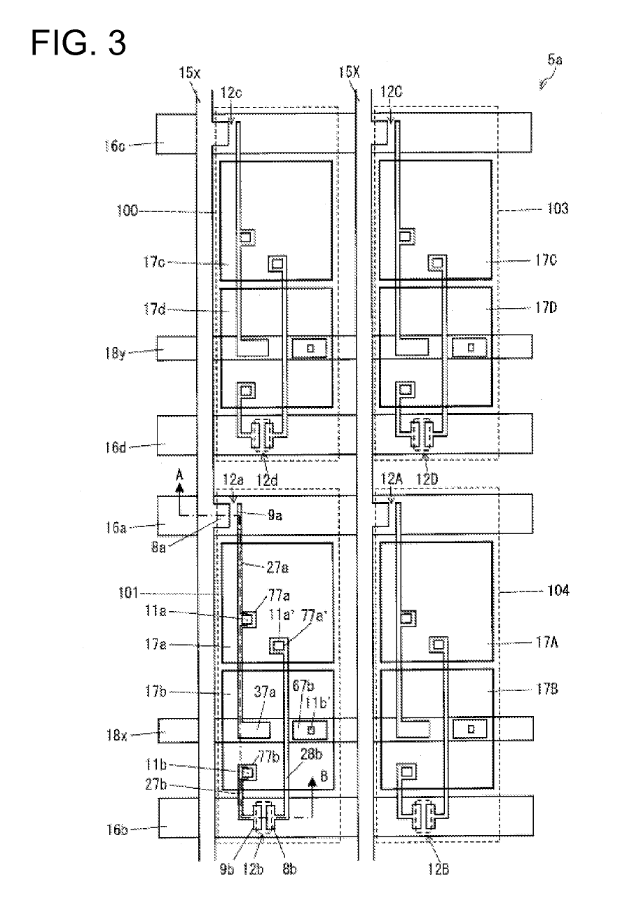

Alternatively, the above-mentioned storage capacitance Chb may be formed according to the configuration shown in FIG. 3. As shown in FIG. 3, a storage capacitance Chb is formed by a configuration in which a storage capacitance electrode 67b, which is formed in the same layer as a coupling capacitance electrode 37a, is connected to a pixel electrode 17b via a contact hole 11b'. When compared to the case shown in FIG. 2 where the storage capacitance Chb is formed between the pixel electrode 17b and the storage capacitance wiring 18x, this configuration has a less (thinner) insulating film therebetween, thereby increasing a storage capacitance value. The larger storage capacitance value is preferred from the aspect of reliability. Additionally, because the aforementioned configuration has a thinner insulating film to form a storage capacitance, the same configuration is also advantageous in that the width of the storage capacitance wiring 18x can be narrowed without changing the size of the storage capacitance value, thereby realizing the improvement of an aperture ratio without reducing reliability.

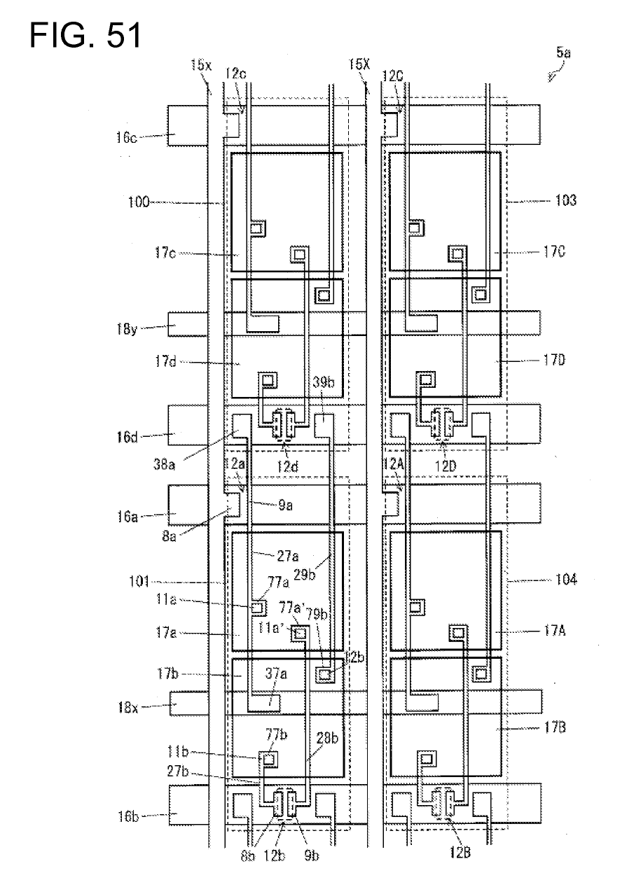

Also, the above-mentioned storage capacitances Cha, Chb may be formed according to the configuration shown in FIG. 51. Specifically, as shown in FIG. 51, a storage capacitance Cha is formed by a configuration in which a storage capacitance electrode 38a, which is formed in the same layer as a coupling capacitance electrode 37a, is connected to a drain lead-out wiring 27a and overlaps a scan signal line 16d via the gate insulating film. Further, a storage capacitance Chb is formed by a configuration in which a storage capacitance electrode 39b, which is formed in the same layer as the storage capacitance electrode 38a, overlaps a scan signal line 16d via a gate insulating film and is connected to a drain lead-out wiring 29b; the drain lead-out wiring 29b is connected to a contact electrode 79b; and the contact electrode 79b is connected to a pixel electrode 17b via a contact hole 12b.

As described above, in the liquid crystal panel 5a shown in FIG. 51, the storage capacitance Cha is a sum of a storage capacitance formed in a section where the storage capacitance electrode 37a and the storage capacitance wiring 18x overlap each other and a storage capacitance formed in a section where the storage capacitance electrode 38a and the scan signal line 16d overlap each other. This realizes a larger storage capacitance value compared to the storage capacitance Cha in the liquid crystal panel shown in FIG. 2. Also, the storage capacitance Chb is a sum of a storage capacitance formed in a section where the storage capacitance wiring 18x and the pixel electrode 17b overlap each other and a storage capacitance formed in a section where the storage capacitance electrode 39b and the scan signal line 16d overlap each other. This realizes a larger storage capacitance value compared to the storage capacitance Chb in the liquid crystal panel shown in FIG. 2. Further, in the present liquid crystal panel, the storage capacitances Cha, Chb of the storage capacitance electrodes 38a, 39b are formed with the scan signal line 16d, which is provided to discharge electric charge for a previous row pixel area for which scanning has been completed (pixel 100 in FIG. 51). Thus, variations in the storage capacitance values can be suppressed. Here, the present liquid crystal panel 5a may also be configured such that the storage capacitance electrodes 38a 39b and the scan signal line 16c for writing normal pixel data overlap each other to form the storage capacitances Cha, Chb.

Needless to say, a method of forming a storage capacitance shown in FIG. 51 can be applied to each of later-described liquid crystal panels 5a, 5b, and 5c.

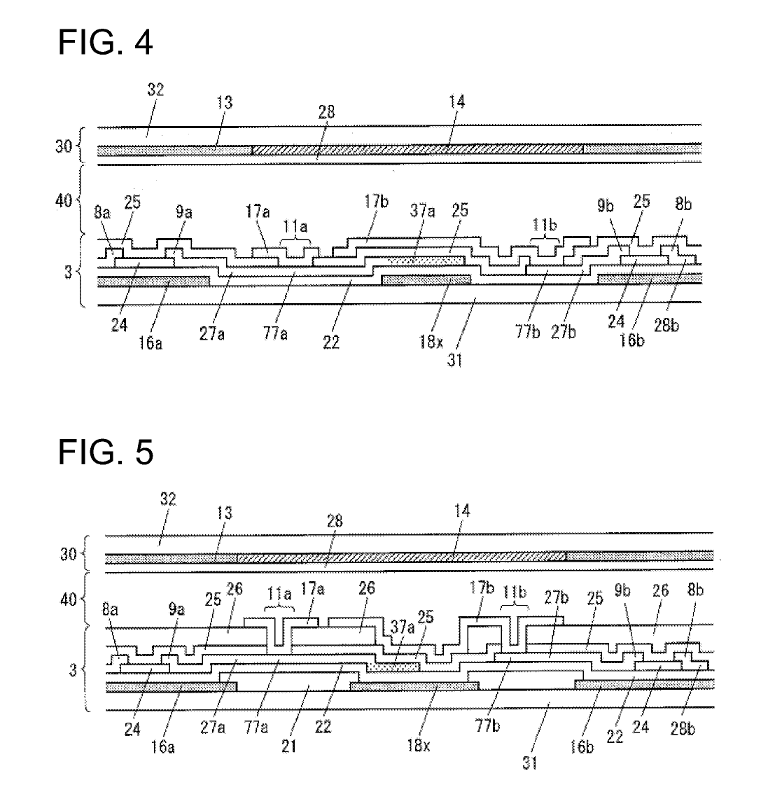

FIG. 4 shows a cross section A-B of FIG. 2. As shown in FIG. 4, a liquid crystal panel 5a includes an active matrix substrate 3, a color filter substrate 30 that faces the active matrix substrate, and a liquid crystal layer 40 interposed between both substrates 3, 30.

In the active matrix substrate 3, scan signal lines 16a, 16b and a storage capacitance wiring 18x are formed on a glass substrate 31 and are covered by an inorganic gate insulating film 22. On the inorganic gate insulating film 22, a semiconductor layer 24 (i-layer and n+-layer); source electrodes 8a, 8b in contact with the n+-layers; drain electrodes 9a, 9b; drain lead-out wirings 27a, 27b; a source lead-out wiring 28b; contact electrodes 77a, 77b (see FIG. 2); and a coupling capacitance electrode 37a are formed and are covered by an inorganic interlayer insulating film 25 formed thereover. Note that for the semiconductor layer 24 that does not overlap the source electrodes 8a, 8b and the drain electrodes 9a, 9b (typically a channel section of a transistor), the n+-layer is removed therefrom by etching or like method, and only the i-layer is left therein. On the inorganic interlayer insulating film 25, pixel electrodes 17a, 17b are formed, which (the pixel electrodes 17a, 17b) are further covered by an alignment film (not shown). Here, the inorganic interlayer insulating film 25 is removed at the contact holes 11a, 11b (see FIG. 2), respectively, thereby connecting the pixel electrode 17a to the contact electrode 77a and contacting the pixel electrode 17b to the contact electrode 77b. Also, the coupling capacitance electrode 37a that is connected to the drain lead-out wiring 27a overlaps the pixel electrode 17b via the inorganic interlayer insulating film 25, thereby forming the coupling capacitance C101 (see FIG. 1). Also, the coupling capacitance electrode 37a overlaps the storage capacitance wiring 18x via the inorganic gate insulating film 22, thereby forming the storage capacitance Cha (see FIG. 1) and also forming the storage capacitance Chb (see FIG. 1) between the pixel electrode 17b and the storage capacitance wiring 18x.

Although not shown in the figure, the source lead-out wiring 28b is connected to the contact electrode 77a′, and the inorganic interlayer insulating film 25 is removed for the contact hole, 11a′, through which the pixel electrode 17a and the contact electrode 77a′ are connected to each other.

In the color filter substrate 30, a black matrix 13 and a colored layer 14 are formed on a glass substrate 32, and a common electrode (com) 28 is formed thereon, which is further covered by an alignment film (not shown).

Here, one example of manufacturing methods of the present active matrix substrate 3 is described as follows.

First, on a transparent insulating substrate, such as glass or plastic substrate (in FIG. 4, the glass substrate 31), a metal film, such as a film of titanium, chromium, aluminum, molybdenum, tantalum, tungsten, copper, or the like, or an alloy or multilayer film thereof, is formed using sputtering or like method at a film thickness of 1000 Å to 3000 Å. The formed film is patterned using a photo-etching method into a required shape to form scan signal lines, storage capacitance wirings, and the like (to function as the gate electrodes of respective transistors).

Next, using a plasma CVD (chemical vapor deposition) or like method, a silicon nitride film (SiNx) as a gate insulating film, a high-resistance semiconductor layer made of amorphous silicon, polysilicon, or the like, and a low-resistance semiconductor layer made of n+-amorphous silicon or the like are sequentially formed. Then, using a photo-etching method, the low-resistance semiconductor layer, the high-resistance semiconductor layer, and the gate insulating film are patterned. At that time, the gate insulating film is removed at the contact hole 28a. Here, the film thickness of the silicon nitride film as the gate insulating film is approximately 3000 Å to 5000 Å, for example; the thickness of the amorphous silicon film as the high-resistance semiconductor layer is approximately 1000 Å to 3000 Å, for example; and the thickness of the n+-amorphous silicon film as the low-resistance semiconductor layer is approximately 400 Å to 700 Å, for example.

Next, using sputtering or like method, a metal film, such as a film of titanium, chromium, aluminum, molybdenum, tantalum, tungsten, copper, or the like, or an alloy film or a multilayer film thereof, is formed at the film thickness of 1000 Å to 3000 Å and is patterned into a required shape to form data signal lines, source electrodes, drain electrodes, and so forth, using photo-etching or like method.

Next, with respect to the high-resistance semiconductor layer (i-layer) of the amorphous silicon film or the like and with respect to the low-resistance semiconductor layer (n+-layer) of the n+-amorphous silicon film or the like, channel-etching is performed by dry etching using the patterns of the data signal lines, the source electrodes, the drain electrodes, and the like as a mask. By this process, the film thickness of the i-layer is optimized, and each transistor (channel area) is formed. Here, the unmasked semiconductor layer is removed by etching, leaving the i-layer at a thickness necessary for each transistor's performance.

Next, as an interlayer insulating film, an inorganic insulating film made of silicon nitride, silicon oxide, or the like is formed to cover the data signal lines, source electrodes, drain electrodes, and the like. In this example, using a plasma CVD or the like, a silicon nitride film (passivation film) at the film thickness of about 2000 Å to 5000 Å is formed.

Next, according to the locations of contact holes, the interlayer insulating film is etched to form holes. Here, for example, the etching is performed through patterning a photosensitive resist using photolithography method (exposure and development).

Next, on the interlayer insulating film, a transparent conductive film, such as a film of ITO (indium tin oxide), IZO, zinc oxide, tin oxide, or the like, is formed at the film thickness of approximately 1000 Å to 2000 Å using sputtering or like method. The formed transparent conductive film is then patterned into a required shape using photo-etching or like method to form first and second pixel electrodes in each pixel area.

Next, using inkjet or like method, an alignment film is applied so as to cover each of the pixel electrodes.

The above-described manufacturing method of the active matrix substrate can be applied to each of liquid crystal panels that are later described. For convenience of description, their descriptions are omitted below.

It is also possible to configure the cross section A-B in FIG. 4 as shown in FIG. 5. Specifically, a thick organic gate insulating film 21 and a thin inorganic gate insulating film 22 are formed on a glass substrate 31, and a thin inorganic interlayer insulating film 25 and a thick organic interlayer insulating film 26 are formed in a lower layer of the pixel electrodes. As a result, such advantages can be obtained that various parasitic capacitances are reduced and short-circuits between the wirings are prevented. In this case, as shown in FIG. 5, it is preferred that a portion of the organic gate insulating film 21 located under the coupling capacitance electrode 37a be removed, and a portion of the organic interlayer insulating film 26 located above the coupling capacitance electrode 37a be removed. As a result, the capacitance value of the coupling capacitance C101 and that of the storage capacitances Cha, Chb can be increased.

The inorganic interlayer insulating film 25, the organic interlayer insulating film 26, and the contact holes 11a, 11b shown in FIG. 5 can be formed as follows, for example. Specifically, after a transistor (TFT) is formed, an inorganic interlayer insulating film 25 (passivation film), which is made of SiNx at the thickness of approximately 3000 Å, is formed to cover an entire area of the substrate, using a mixed gas of SiH₄ gas, NH₃ gas, and N₂ gas via CVD. After that, an organic interlayer insulating film 26, which is made of positive-type photosensitive acrylic resin at the thickness of approximately 3 μm, is formed using spin coating or die coating. Next, using photolithography, patterns for areas in which the organic interlayer insulating film 26 is removed as well as for various contacts are created. Then, dry-etching is performed on the inorganic interlayer insulating film 25 by using a mixed gas of CF₄ gas and O₂ gas using the patterned organic interlayer insulating film 26 as a mask. Specifically, half exposure of the photolithography process is applied to leave a thin organic interlayer insulating film at the completion of development for the areas at which the organic interlayer insulating film is to be removed, while full exposure of the photolithography process is applied to completely remove the organic interlayer insulating film at the completion of development for the areas at which the contact holes are to be created. When the dry-etching is performed using a mixed gas of CF₄ gas and O₂ gas, the leftover film (of the organic interlayer insulating film) is removed therefrom, while the inorganic interlayer insulating film under the organic interlayer insulating film is removed from the contact holes. Here, the organic gate insulating film 21 and the organic interlayer insulating film 26 may be an insulating film made of such materials as SOG (spin-on glass), for example. The organic gate insulating film 21 and the organic interlayer insulating film 26 may also contain at least one of acrylic resin, epoxy resin, polyimide resin, polyurethane resin, novolak resin, and siloxane resin.

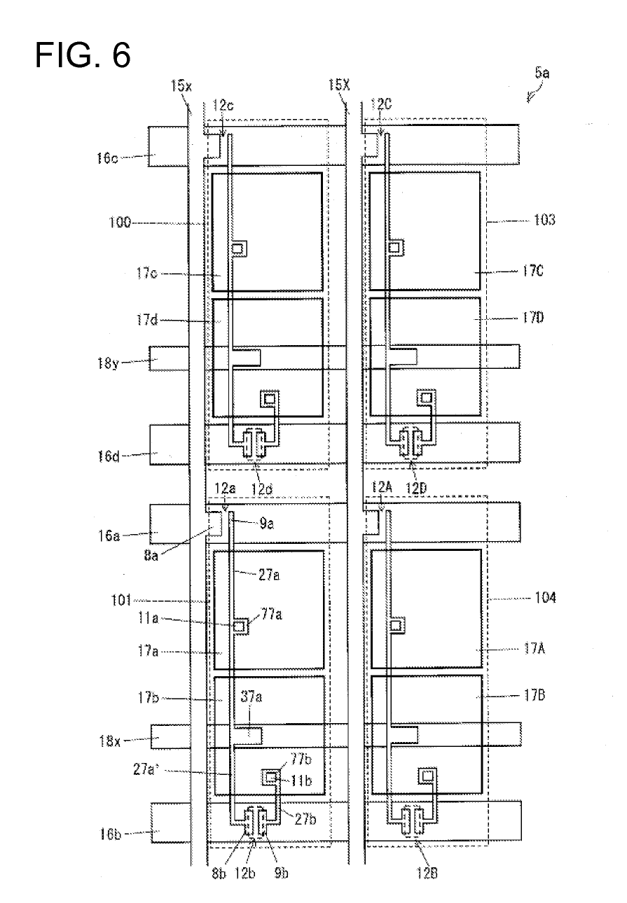

Alternatively, a liquid crystal panel 5a of the specific example 1-1 shown in FIG. 2 may be configured as follows. Specifically, in a liquid crystal panel 5a shown in FIG. 6, which is a modification 1, a coupling capacitance electrode 37a overlaps a pixel electrode 17b via an interlayer insulating film, and an extended coupling capacitance electrode 27a′ connected to the coupling capacitance electrode 37a is connected to a source electrode 8b of a transistor 12b. A drain lead-out wiring 27b led out from a drain electrode 9b of the transistor 12b is connected to a contact electrode 77b, and a contact electrode 77a is connected to the pixel electrode 17b via a contact hole 11b.

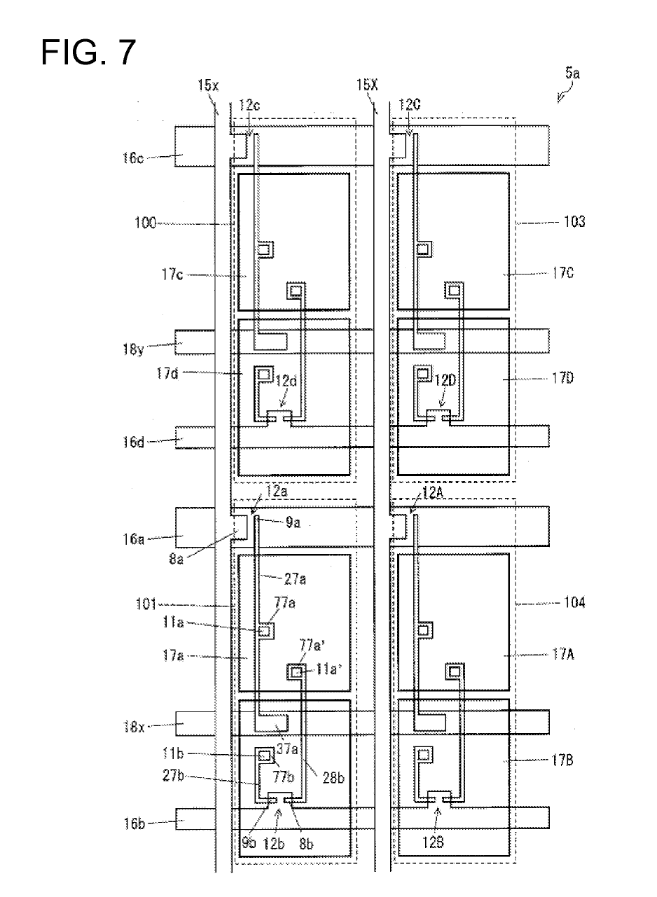

In a liquid crystal panel 5a shown in FIG. 7, which is a modification example 2, a scan signal line 16b is formed in branches (gate branch structure), and a drain electrode and a source electrode of a transistor 12b are also formed at the branch. As a result, it becomes possible to narrow the line width of the scan signal line 16b and also to reduce a parasitic capacitance formed between the source electrode 8b and the drain electrode 9b of the transistor 12b and the scan signal line 16b.

Here, the above-mentioned modifications examples 1, 2 may also be applied in the same manner to each of later-described specific examples of liquid crystal panels 5a, 5b, and 5c.

### Specific Example of Liquid Crystal Panel 1-2

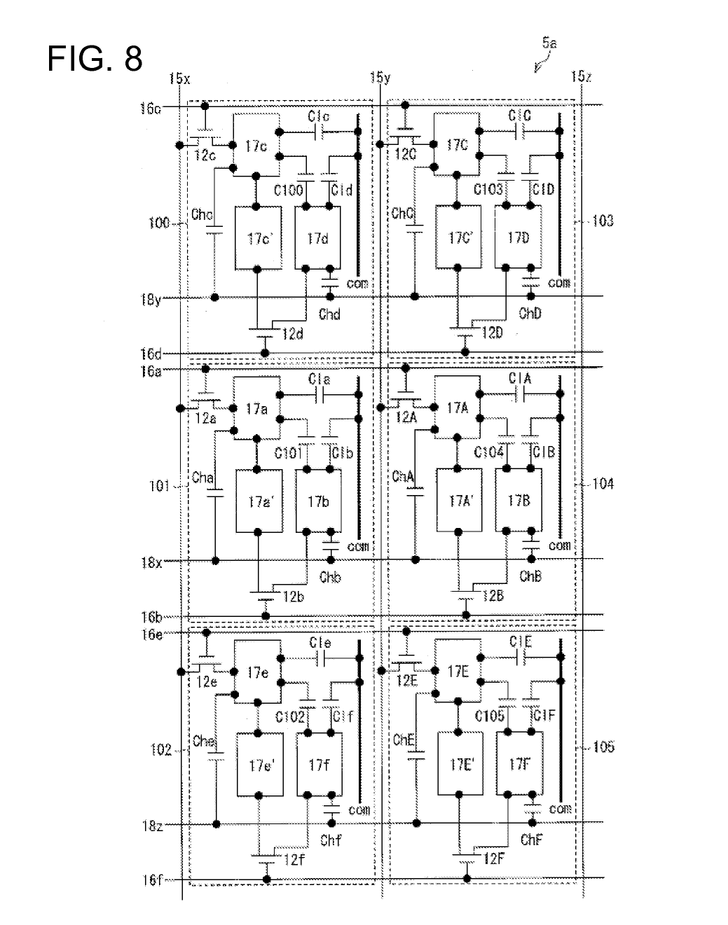

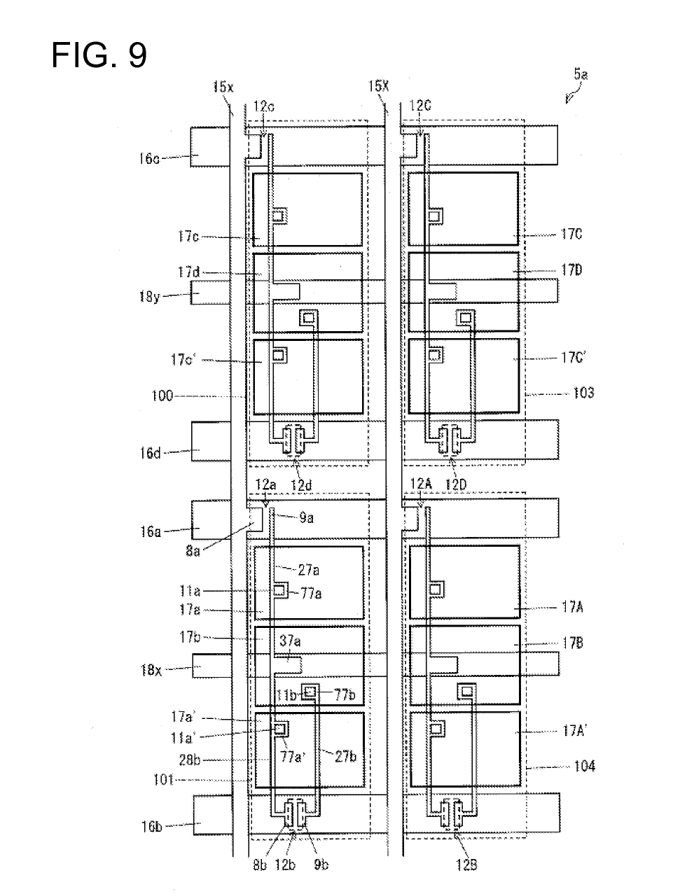

An equivalent circuit diagram that corresponds to a specific example 1-2 of a liquid crystal panel 5a is shown in FIG. 8. The specific example 1-2 of the liquid crystal panel 5a is shown in FIG. 9.

As shown in FIG. 8, each pixel has an identical configuration, in which one data signal line and two scan signal lines are provided to each pixel. Three pixel electrodes 17c, 17d, 17c′ are provided in a pixel 100 (FIG. 8 shows a condition that the pixel electrodes 17c, 17c′ are electrically connected to each other); three pixel electrodes 17a, 17b, 17a′ are provided in a pixel 101; and three pixel electrodes 17e, 17f, 17e′ are provided in a pixel 102. Also, three pixel electrodes 17C, 17D, 17C′ are provided in a pixel 103; three pixel electrodes 17A, 17B, 17A′ are provided in a pixel 104; and three pixel electrodes 17E, 17F, 17E′ are provided in a pixel 105. The pixel electrodes 17c, 17C, the pixel electrodes 17c′, 17C′, the pixel electrodes 17d, 17D, the pixel electrodes 17a, 17A, the pixel electrodes 17a′, 17A′, the pixel electrodes 17b, 17B, the pixel electrodes 17e, 17E, the pixel electrodes 17e′, 17E′, and the pixel electrodes 17f, 17F are adjacent to each other in the row direction, respectively (see FIG. 9).

Taking the pixel 101 as an example, in the pixel 101, the pixel electrodes 17a, 17b are connected to each other via a coupling capacitance C101; the pixel electrode 17a is connected to a data signal line 15x via a transistor 12a that is connected to a scan signal line 16a; and the pixel electrode 17b is electrically connected to the pixel electrode 17a′ that is electrically connected to pixel electrode 17a via a transistor 12b connected to a scan signal line 16b. A storage capacitance Cha is formed between the pixel electrodes 17a, 17a′ and the storage capacitance wiring 18x; a storage capacitance Chb is formed between the pixel electrode 17b and the storage capacitance wiring 18x; a liquid crystal capacitance C1a is formed between the pixel electrodes 17a, 17a′ and a common electrode “com”; and a liquid crystal capacitance C1b is formed between the pixel electrode 17b and the common electrode “com.”

In the liquid crystal panel 5a shown in FIG. 9, in the manner similar to that of the liquid crystal panel in FIG. 2, a data signal line 15x is provided so as to align along the pixels 100, 101; a data signal line 15x is provided so as to align along the pixels 103, 104; a storage capacitance wiring 18y passes across the pixels 100, 103, respectively; and a storage capacitance wiring 18x passes across the pixels 101, 104, respectively.

Here, a scan signal line 16c is arranged at one edge of the pixel 100; a scan signal line 16d is arranged at the other edge thereof; and viewed planarly, pixel electrodes 17c, 17d, 17c′ are aligned in the column direction between the scan signal lines 16c, 16d. In the same manner, the scan signal line 16c is arranged at one edge of the pixel 103; the scan signal line 16d is arranged at the other edge part thereof; and viewed planarly, three pixel electrodes 17C, 17D, 17C′ are aligned in the column direction between the scan signal lines 16c, 16d.

Also, a scan signal line 16a is arranged at one edge of the pixel 101; a scan signal line 16b is arranged at the other edge thereof; and viewed planarly, pixel electrodes 17a, 17b, 17a′ are aligned in the column direction between the scan signal lines 16a, 16b. In the same manner, the scan signal line 16a is arranged at one edge of the pixel 104; the scan signal line 16b is arranged at the other edge thereof; and viewed planarly, pixel electrodes 17A, 17B, 17A′ are aligned in the column direction between the scan signal lines 16a, 16b.

In the pixel 101, a source electrode 8a and a drain electrode 9a of a transistor 12a are formed over the scan signal line 16a, while a source electrode 8b and a drain electrode 9b of a transistor 12b are formed over the scan signal line 16b. The source electrode 8a is connected to the data signal line 15x. The drain electrode 9a is connected to a drain lead-out wiring 27a; the drain lead-out wiring 27a is connected to a contact electrode 77a and a coupling capacitance electrode 37a; and the contact electrode 77a is connected to the pixel electrode 17a via a contact hole 11a. The coupling capacitance electrode 37a overlaps the pixel electrode 17b via an interlayer insulating film, thereby forming a coupling capacitance C101 between the pixel electrodes 17a, 17b (see FIG. 8).

Also, the source electrode 8b of the transistor 12b is connected to a source lead-out wiring 28b, and the source lead-out wiring 28b is connected to the contact electrode 77a′ and the coupling capacitance electrode 37a, and the contact electrode 77a′ is connected to the pixel electrode 17a′ (third pixel electrode) via a contact hole 11a′. The drain electrode 9b is connected to the drain lead-out wiring 27b; the drain lead-out wiring 27b is connected to a contact electrode 77b; and the contact electrode 77b is connected to the pixel electrode 17b via a contact hole 11b.

Also, the coupling capacitance electrode 37a overlaps the storage capacitance wiring 18x via a gate insulating film, thereby forming a storage capacitance Cha (see FIG. 8), and also a storage capacitance Chb between the pixel electrode 17b and the storage capacitance wiring 18x (see FIG. 8). Here, the configuration (geometry and alignment of each component and connection relation therebetween) of other pixels is identical to that of the pixel 101.

According to the aforementioned configuration, subpixels including the pixel electrodes 17a, 17a′ are “bright” while the subpixel including the pixel electrode 17b is “dark.” Therefore, an advantage is obtained that an electric charge is prevented from jumping from the scan signal line to the pixel electrode 17b in the floating state.

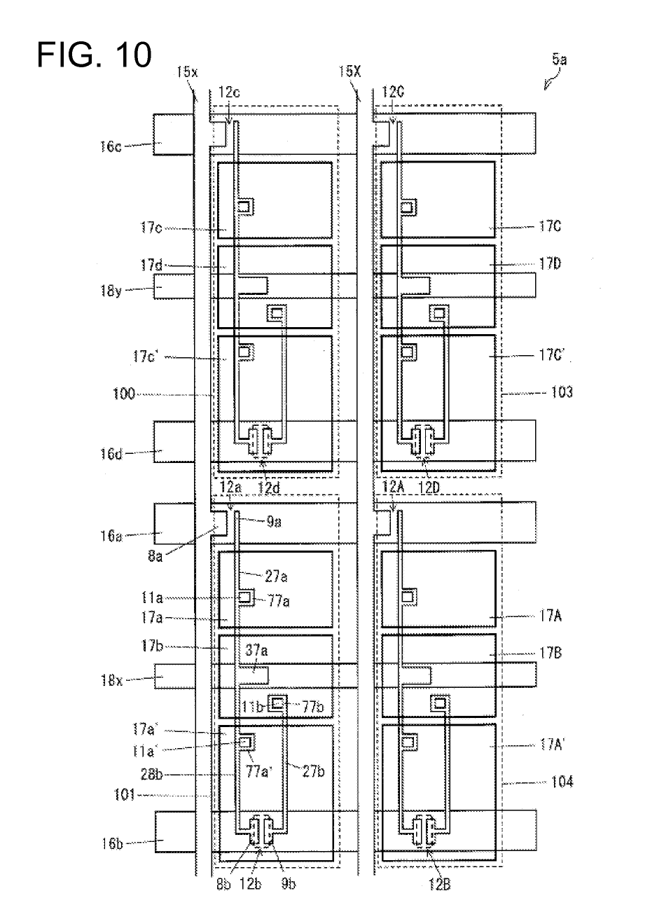

Here, in case of the configuration in which a thin inorganic interlayer insulating film 25 and a thick organic interlayer insulating film 26 are formed in a lower layer under the pixel electrode as shown in FIG. 5, a liquid crystal panel 5a can be configured as shown in FIG. 10. Specifically, a pixel electrode 17a′ is formed to overlap a scan signal line 16b via the thin inorganic interlayer insulating film 25 and the thick organic interlayer insulating film 26. As a result, it becomes possible to reduce a parasitic capacitance between the pixel electrode 17a′ and the scan signal line 16b, which is particularly advantageous in that the aperture ratio can be improved while suppressing an increase in the workload of the scan signal line 16b.

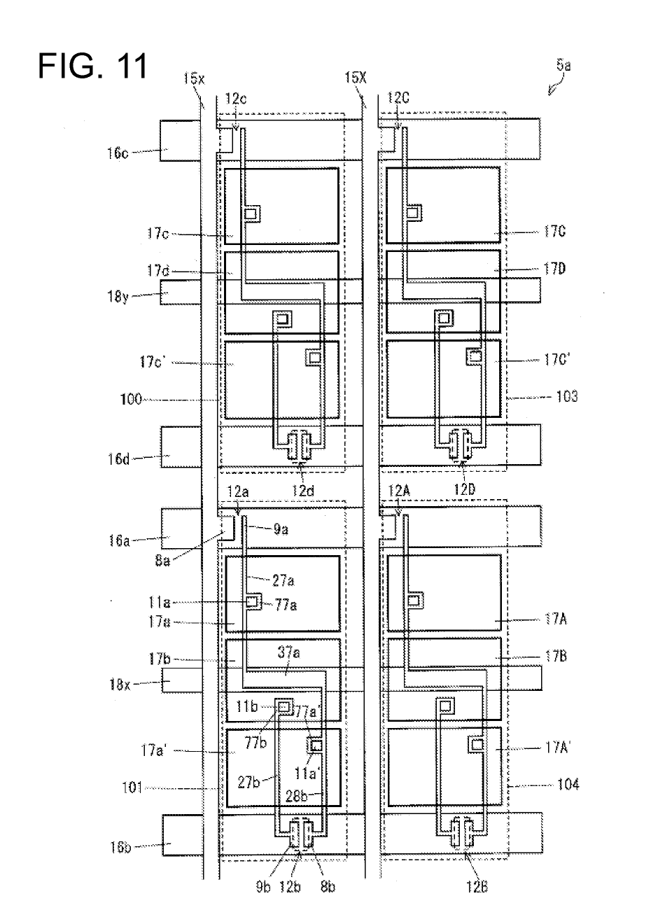

Also, as shown in FIG. 11, such a configuration is also possible that the width of the coupling capacitance electrode 37a is enlarged to increase the area of a section where the coupling capacitance electrode 37a and the storage capacitance wiring 18x overlap each other. As a result, a capacitance value of a storage capacitance Cha (see FIG. 8) can be increased.

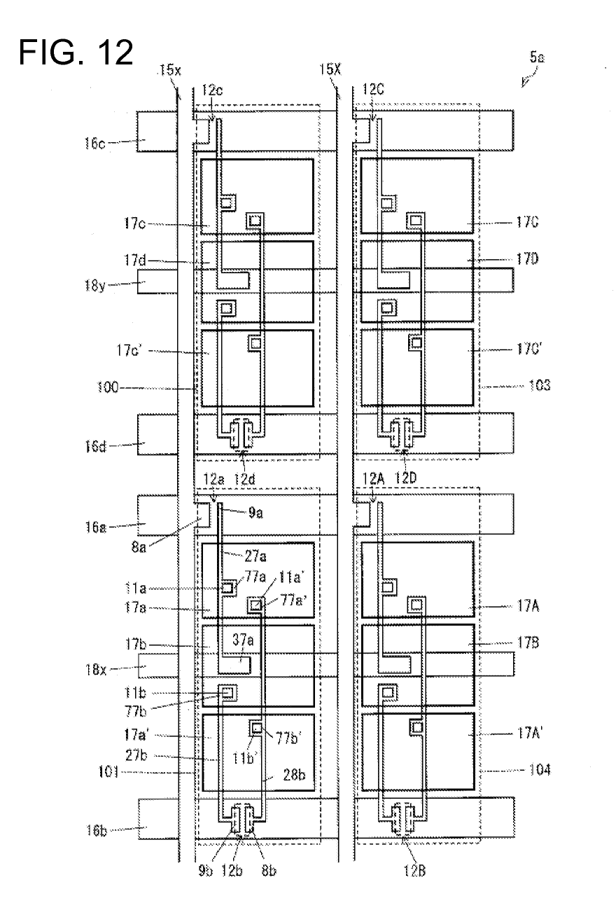

Also, in the configuration such as that of the present embodiment, in which three pixel electrodes are provided, the coupling capacitance electrode 37a and the transistor 12b do not have to be connected to each other, as in the case of the liquid crystal panel 5a of the present specific example 1-1 shown in FIG. 2. Specifically, as shown in FIG. 12, the drain lead-out wiring 27b connected to the drain electrode 9b of the transistor 12b is not connected to the coupling capacitance electrode 37a and is instead connected to the contact electrode 77b, and the contact electrode 77b is connected to the pixel electrode 17b via the contact hole 11b. According to this configuration, the area of the lead-out wiring can be reduced, thereby improving the aperture ratio.

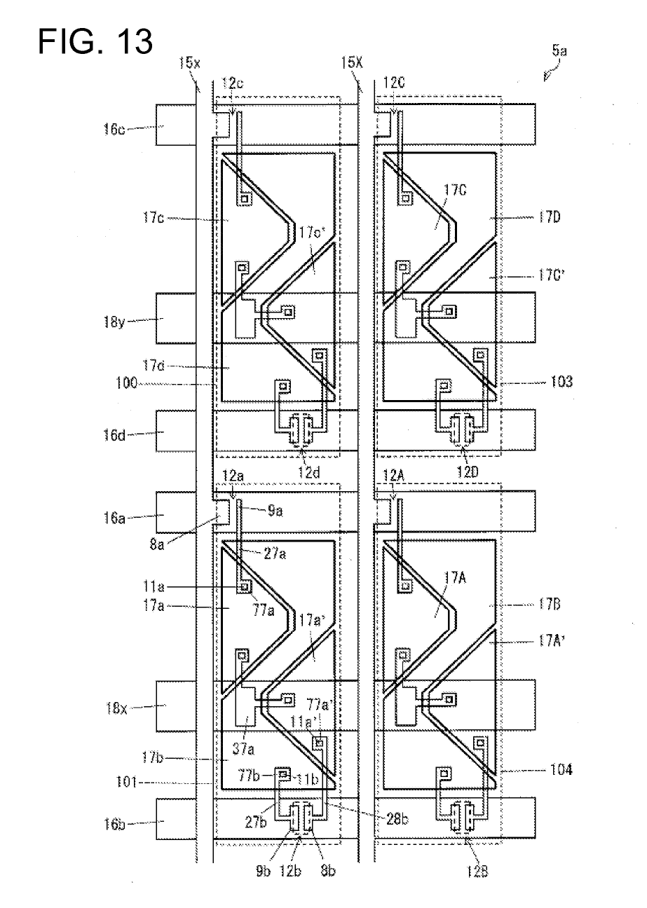

Furthermore, the liquid crystal panel 5a of the present specific example 1-2 can also be configured as shown in FIG. 13. Specifically, in the liquid crystal panel 5a shown in FIG. 13, the shapes of the pixel electrodes are different from those of the pixel electrodes of the liquid crystal panel 5a shown in FIGS. 9 to 12. In particular, in the pixel 101 for example, pixel electrodes 17a, 17b, 17a′ are arranged such that a portion of the pixel electrode 17a is adjacent to a scan signal line 16a; a portion of the pixel electrode 17a′ is adjacent to a scan signal line 16b; and one edge of the pixel electrode 17b is adjacent to the scan signal line 16a while the other edge thereof is adjacent to the scan signal line 16b. In other words, at least respective portions of the pixel electrode 17a, 17a′ are disposed near the scan signal lines 16a, 16b, respectively, while the pixel electrode 17b is arranged so as to extend in the column direction to bridge the scan signal line 16a and the scan signal line 16b. Here, because components of FIG. 13 having reference characters identical to those of FIGS. 9 to 12 possess identical functions, the description thereof is omitted herein.

According to this configuration, the subpixels including the pixel electrodes 17a, 17a′ are “bright” while the subpixel including the pixel electrode 17b is “dark.” Further, in this configuration, it is possible to shorten each of the lead-out wirings of the transistors 12a, 12b, respectively, as compared with the configuration shown in FIGS. 9 to 12. Similarly, because the pixel electrodes 17a, 17a′ can be connected at a position close to them via the coupling capacitance electrode 37a, it is possible to shorten each of the lead-out wirings of the coupling capacitance electrode 37a, as compared with the configuration shown in FIGS. 9 to 12. As a result, in addition to an advantage that the occurrence of burn-in in subpixels including the pixel electrode 17b can be prevented, advantages such as reduced chance of breakage in lead-out wirings and improved aperture ratio can also be obtained.

The above-described configurations shown in FIGS. 10 to 13 can also be applied in the same manner to each of specific examples of liquid crystal panels 5a, 5b, and 5c.

### Specific Example of Liquid Crystal Panel 1-3

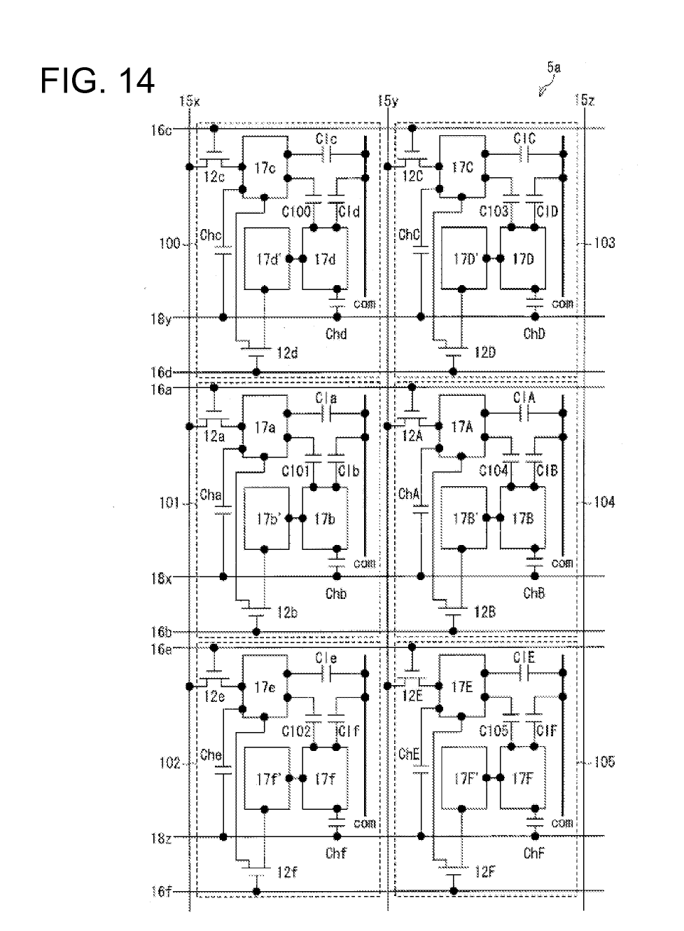

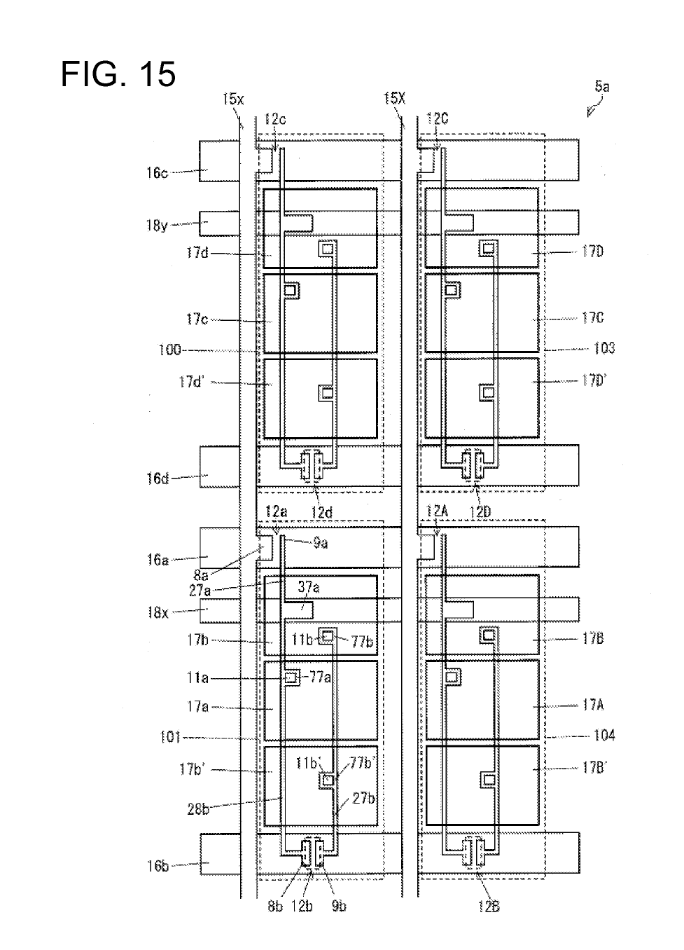

An equivalent circuit diagram that corresponds to a specific example 1-3 of a liquid crystal panel 5a is shown in FIG. 14. The specific example 1-3 of a liquid crystal panel 5a is shown in FIG. 15.

As shown in FIG. 14, each pixel has an identical configuration, in which one data signal line and two scan signal lines are provided to each pixel. Three pixel electrodes 17d, 17c, 17d′ are provided in a pixel 100 (FIG. 14 shows a condition that the pixel electrodes 17d, 17d′ are electrically connected to each other); three pixel electrodes 17b, 17a, 17b′ are provided in a pixel 101; and three pixel electrodes 17f, 17e, 17f are provided in a pixel 102. Also, three pixel electrodes 17D, 17C, 17D′ are provided in a pixel 103; three pixel electrodes 17B, 17A, 17B′ are provided in a pixel 104; and three pixel electrodes 17F, 17E, 17F′ are provided in a pixel 105. The pixel electrodes 17d, 17D, the pixel electrodes 17c, 17C, the pixel electrodes 17d′, 17D′, the pixel electrodes 17b, 17B, the pixel electrodes 17a, 17A, the pixel electrodes 17b′, 17B′, the pixel electrodes 17f, 17F the pixel electrodes 17e, 17E, and the pixel electrodes 17f, 17F′ are adjacent to each other in the row direction, respectively.

Taking the pixel 101 as an example, in the pixel 101, the pixel electrodes 17a, 17b are connected to each other via a coupling capacitance C101; the pixel electrode 17a is connected to a data signal 15x via a transistor 12a that is connected to a scan signal line 16a; the pixel electrodes 17b, 17b′ that are electrically connected to each other are capacitively coupled to the pixel electrode 17a, and are connected to a pixel electrode 17a via a transistor 12b that is connected to a scan signal line 16b; a storage capacitance Cha is formed between the pixel electrode 17a and the storage capacitance wiring 18x; a storage capacitance Chb is formed between the pixel electrodes 17b, 17b′ and the storage capacitance wiring 18x; a liquid crystal capacitance C1a is formed between the pixel electrode 17a and a common electrode “com”; and a liquid crystal capacitance C1b is formed between the pixel electrodes 17b, 17b′ and the common electrode “com.”

In the liquid crystal panel 5a shown in FIG. 15, in a manner similar to that of the liquid crystal panel in FIG. 2, a data signal line 15x is provided so as to align along the pixels 100, 101; a data signal line 15x is provided so as to align along the pixels 103, 104; a storage capacitance wiring 18y passes across the pixels 100, 103, respectively; and a storage capacitance wiring 18x passes across the pixels 101, 104, respectively.

Here, a scan signal line 16c is arranged at one edge of the pixel 100; a scan signal line 16d is arranged at the other edge thereof; and viewed planarly, pixel electrodes 17d, 17c, 17d′ are aligned in the column direction between the scan signal lines 16c, 16d. In the same manner, the scan signal line 16c is arranged at one edge of the pixel 103; the scan signal line 16d is arranged at the other edge thereof; and viewed planarly, three pixel electrodes 17D, 17C, 17D′ are aligned in the column direction between the scan signal lines 16c, 16d.

Also, a scan signal line 16a is arranged at one edge of the pixel 101; a scan signal line 16b is arranged at the other edge thereof; and viewed planarly, pixel electrodes 17b, 17a, 17b′ are aligned in the column direction between the scan signal lines 16a, 16b. In the same manner, the scan signal line 16a is arranged at one edge of the pixel 104; the scan signal line 16b is arranged at the other edge thereof; and viewed planarly, pixel electrodes 17B, 17A, 17B′ are aligned in the column direction between the scan signal lines 16a, 16b.

In the pixel 101, a source electrode 8a and a drain electrode 9a of a transistor 12a are formed over the scan signal line 16a, while a source electrode 8b and a drain electrode 9b of a transistor 12b are formed over the scan signal line 16b. The source electrode 8a is connected to the data signal line 15x. The drain electrode 9a is connected to a drain lead-out wiring 27a; the drain lead-out wiring 27a is connected to a coupling capacitance electrode 37a and to a contact electrode 77a; and the contact electrode 77a is connected to the pixel electrode 17a via a contact hole 11a. The coupling capacitance electrode 37a overlaps the pixel electrode 17b via an interlayer insulating film, thereby forming a coupling capacitance C101 between the pixel electrodes 17a, 17b (see FIG. 14).

Also, the source electrode 8b of the transistor 12b is connected to a source lead-out wiring 28b, and the source lead-out wiring 28b is connected to the contact electrode 77a. The drain electrode 9b is connected to a drain lead-out wiring 27b; the drain lead-out wiring 27b is connected to a contact electrode 77b; and the contact electrode 77b is connected to the pixel electrode 17b via a contact hole 11b. The drain lead-out wiring 27b is further connected to a contact electrode 77b′, and the contact electrode 77b′ is connected to the pixel electrode 17b′ via a contact hole 11b'. Also, the coupling capacitance electrode 37a overlaps the storage capacitance wiring 18x via a gate insulating film, thereby forming a storage capacitance Cha (see FIG. 14), and also a storage capacitance Chb between the pixel electrode 17b and the storage capacitance wiring 18x (see FIG. 14). Here, the configuration (geometry and alignment of each component and connection relation therebetween) of other pixels is identical to that of the pixel 101.

According to the aforementioned configuration, the subpixel including the pixel electrode 17a is “bright” while subpixels including the pixel electrodes 17b, 17b′ are “dark.” Therefore, the bright subpixels that belong to different pixels are not aligned adjacently to each other, and as a result, an advantage is obtained that a natural display is possible, as compared with cases in which the bright subpixels that belong to different pixels are aligned adjacently to each other.

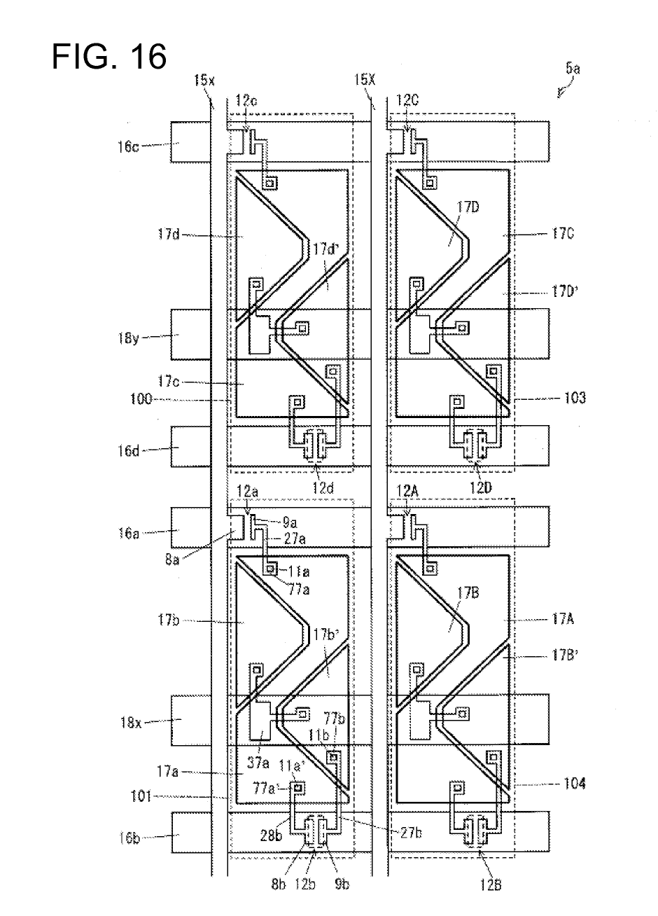

Alternatively, the liquid crystal panel 5a shown in the present specific example 1-3 can also be configured as shown in FIG. 16. Specifically, in a manner similar to that of the liquid crystal panel 5a shown in FIG. 13, the shapes of the pixel electrodes in the liquid crystal panel 5a shown in FIG. 16 are different from those of the pixel electrodes of the liquid crystal panel 5a shown in FIG. 15. In particular, in the pixel 101, for example, pixel electrodes 17b, 17a, 17b′ are arranged such that a portion of the pixel electrode 17b is adjacent to a scan signal line 16a; that a portion of the pixel electrode 17b′ is adjacent to a scan signal line 16b, and that one edge of the pixel electrode 17a is adjacent to the scan signal line 16a while the other edge thereof is adjacent to the scan signal line 16b. In other words, at least respective portions of the pixel electrodes 17b, 17b′ are arranged adjacent to the scan signal lines 16a, 16b, respectively, and the pixel electrode 17a is arranged so as to extend in the column direction to bridge the scan signal line 16a and the scan signal line 16b. Here, because components in FIG. 16 having reference characters identical to those shown in FIG. 15 possess identical functions, the description thereof is omitted herein.

According to the aforementioned configuration, the subpixel including the pixel electrode 17a is “bright” while the subpixels including the pixel electrodes 17b, 17b′ are “dark.” As a result, similar to the configuration in FIG. 13, this configuration provides advantages that the chance of breakage in the lead-out wirings can be reduced and that the aperture ratio can be improved.

(Driving Methods of Liquid Crystal Display Device)

Next, driving methods of the liquid crystal display devices that include the above-described liquid crystal panels 5a are described. Generally, the driving methods have the following characteristics.

As a first characteristic, a transistor 12b that is connected to a capacitance coupling electrode is turned on at least once in a period during which the liquid crystal display device is on (during display). As a result, as described above, the capacitance coupling electrode (pixel electrode 17b) can be electrically connected to a data signal line 15x, thereby allowing discharging (refreshing) of accumulated electric charges, suppressing the occurrence of burn-in in subpixels that include the capacitance coupling electrodes.

As a second characteristic, a transistor 12b is turned on to connect a pixel electrode 17b to a data signal line 15x at least once in a period during which a liquid crystal display device is on, and the transistor 12b is turned off while Vcom is supplied to the data signal line 15x. As a result, it becomes possible to set the potential of the pixel electrode 17b to Vcom, thereby preventing the deterioration of display quality in addition to the aforementioned advantage regarding the discharge of accumulated electric charge.

As a third characteristic, in addition to the first and second characteristics, the transistor 12b, which is connected to a pixel electrode 17b, is turned off while Vcom is supplied from the data signal line 15x to the pixel electrodes 17a and 17b, respectively, via the transistors 12a, 12b. Specifically, when the transistor 12b is turned off, the transistor 12a is in the ON state, and Vcom has been supplied to the pixel electrode 17a. As a result, it becomes possible to reset the potential of the pixel electrodes in one pixel area before a normal signal potential is written into the pixel electrode 17a. In other words, the potential of the capacitively-coupled pixel electrode 17b can be fixed at Vcom. As a result, it becomes possible to ensure the discharge of accumulated electric charges from the pixel electrode 17b and also to prevent the deterioration of display quality.

Specific driving methods possessing the above-described characteristics and also configurations of a gate driver that realizes these methods are described in detail below. Note that the driving methods described below adopt a charge-sharing method, but the present invention is not limited to such a system.

(Driving Method 1)

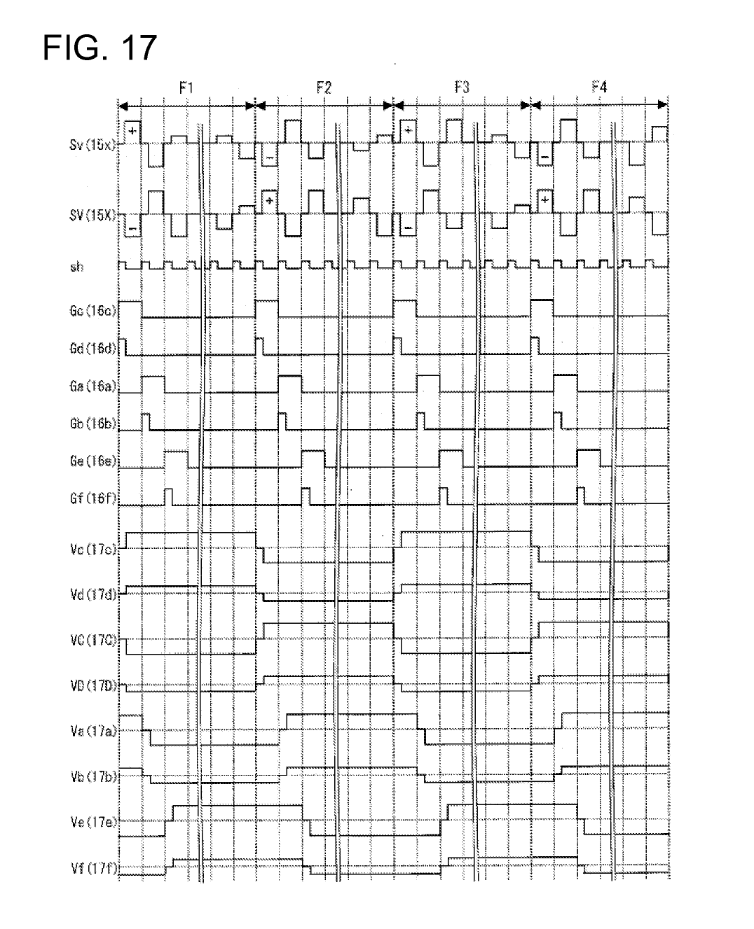

FIG. 17 is a timing chart that shows a driving method of the present liquid crystal display device equipped with the above-described liquid crystal panel 5a. Here, Sv and SV indicate signal potentials to be supplied to two adjacent data signal lines (for example, 15x, 15X), respectively; Ga to Gf indicate gate-on pulse signals to be supplied to scan signal lines 16a to 16f; Vc, Vd, Va, Vb, VC, VD indicate potentials of pixel electrodes 17c, 17d, 17a, 17b, 17C, 17D, respectively; and sh indicates a charge-sharing signal. Here, during the period in which the charge-sharing signal is active (H), a charge-sharing is performed by short-circuiting all data signal lines, or supplying an identical potential to all data signal lines from outside.

According to this driving method, as shown in FIG. 17, the polarity of a signal potential supplied to a data signal line is reversed every horizontal scanning period (1H); the polarity of a signal potential supplied for the same numbered horizontal scanning period in respective frames is reversed every frame; signal potentials having reversed polarities are supplied to two adjacent data signal lines during one horizontal scanning period; and a charge-sharing is performed at the beginning of each horizontal scanning period

Specifically, in F1 of sequential frames F1 to F4, a pair of upper and lower scan signal lines that correspond to one pixel is sequentially selected each time (for example, scan signal lines 16c, 16d->scan signal lines 16a, 16b->scan signal lines 16e, 16f; see FIG. 1). To one of the two adjacent data signal lines (for example, data signal line 15x), a signal potential having a positive polarity is supplied during the first horizontal scanning period (for example, a period including the writing period of the pixel electrodes 17c, 17d); a signal potential having a negative polarity is supplied during the second horizontal scanning period (for example, a period including the writing period of the pixel electrodes 17a, 17b); and a signal potential having a positive polarity is supplied during the third horizontal scanning period (for example, a period including the writing period of the pixel electrodes 17e, 17f). To the other one of the two data signal lines (for example, the data signal line 15X), a signal potential having a negative polarity is supplied during the first horizontal scanning period (for example, a period including the writing period of the pixel electrodes 17C, 17D); a signal potential having a positive polarity is supplied during the second horizontal scanning period (for example, a period including the writing period of the pixel electrodes 17A, 17B); and a signal potential having a negative polarity is supplied during the third horizontal scanning period (for example, a period including the writing period of the pixel electrodes 17E, 17F). Also, a charge-sharing potential (Vcom) is supplied at the beginning of each horizontal scanning period.

Here, the respective writing periods of the pixel electrode respectively connected to two scan signal lines that correspond to one pixel are set so as to differ from each other. Specifically, in FIG. 1, the period during which the scan signal line 16c is selected and therefore a signal potential having a positive polarity is written to the pixel electrode 17c is set to be longer than the period during which the scan signal line 16d is selected and therefore Vcom is written into the pixel electrode 17d; and the period during which the scan signal line 16a is selected and therefore a signal potential having a negative polarity is written to the pixel electrode 17a is set to be longer than the period during which the scan signal line 16b is selected and therefore Vcom is written into the pixel electrode 17b. Additionally, in one pixel, writing operations to the respective pixel electrodes are performed within the same horizontal scanning period, and the timings for the completion of the writing operations (active periods) to the respective pixel electrodes are set so that a shorter writing period ends before a longer writing period ends. Specifically, the writing operation into the pixel electrode 17d ends before a timing at which the writing operation into the pixel electrode 17c ends; the writing operation into the pixel 17D ends before a timing at which the writing operation into the pixel electrode 17C ends; and the writing operation into the pixel electrode 17b ends before a timing at which the writing operation into the pixel electrode 17a ends.

As described above, with regard to the gate-on pulse signal that is supplied to a scan signal line connected to a capacitively-coupled pixel electrode (second gate-on pulse signal), the pulse width thereof is shorter than that of a gate-on pulse signal that is supplied to a scan signal line connected to a pixel electrode into which a normal signal potential is written (first gate-on pulse signal). At the same time, the pulse width of the second gate-on pulse signal is set such that the second gate-on pulse signal turns inactive before the first gate-on pulse signal turns inactive. As a result, a subpixel including the pixel electrode 17c (positive polarity) becomes “bright”; a subpixel including the pixel electrode 17d (positive polarity) becomes “dark”; a subpixel including the pixel electrode 17C (negative polarity) becomes “bright”; a subpixel including the pixel electrode 17D (negative polarity) becomes “dark”; a subpixel including the pixel electrode 17a (negative polarity) becomes “bright”; and a subpixel including the pixel electrode 17b (negative polarity) becomes “dark.”

In F2, the positive polarity and the negative polarity are reversed, as compared with F1. As a result, a subpixel including the pixel electrode 17c (negative polarity) becomes “bright”; a subpixel including the pixel electrode 17d (negative polarity) becomes “dark”; a subpixel including the pixel electrode 17C (positive polarity) becomes “bright”; a subpixel including the pixel electrode 17D (positive polarity) becomes “dark”; a subpixel including the pixel electrode 17a (positive polarity) becomes “bright”; and a subpixel including the pixel electrode 17b (positive polarity) becomes “dark.” The same operations as those of F1, F2 are repeated in the subsequent frames F3, F4.

According to the present driving method, as described above, in each frame, it is possible to individually supply a signal potential to pixel electrodes (pixel electrodes 17d, 17b, 17D, 17B in FIGS. 1, 2) that are capacitively coupled to pixel electrodes (17c, 17a, 17C, 17A), which connected to data signal lines (15x, 15X) via transistors (12c, 12a, 12C, 12A), at timings different from the timings at which signal potentials are supplied to pixel electrodes (17c, 17a, 17C, 17A) to which a normal writing is performed. As a result, a liquid crystal display device using a pixel division system can be realized.

Further, in the present driving method, a Vcom signal is supplied to all pixel electrodes within one pixel area at the beginning of each horizontal scanning period, thereby resetting the potentials of the pixel electrodes to Vcom before the writing operation of normal signal potentials. Therefore, it becomes possible to discharge (refresh) electric charges accumulated in the above-described capacitively coupled pixel electrodes, and the occurrence of burn-in in subpixels including capacitively-coupled pixel electrodes are suppressed, thereby preventing the deterioration of display quality.

(Configuration of Gate Driver 1)

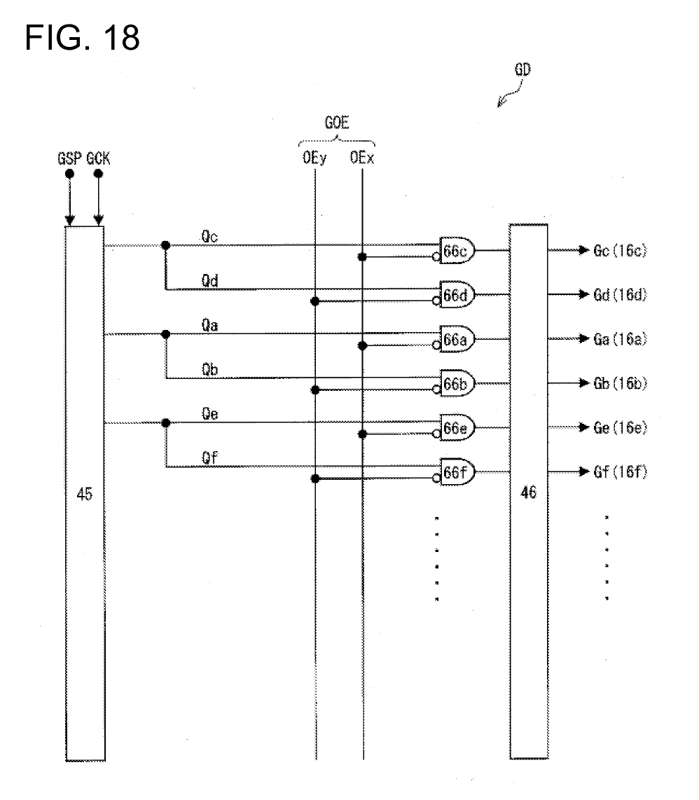

FIG. 18 is a circuit diagram showing a configuration of a gate driver of the present liquid crystal display device for realizing the driving described in FIG. 17. As shown in FIG. 18, a gate driver GD includes a shift register 45, a plurality of AND circuits (66a to 660 that are aligned in the column direction, and an output circuit 46. To the shift register 45, a gate start pulse signal GSP and a gate clock signal GCK are inputted. An output of each stage of the shift register 45 is divided into two lines, one of which is inputted to an odd-numbered AND circuit and the other one to an even-numbered AND circuit that is located adjacent to the odd-numbered AND circuit. Additionally, a gate driver output control signal GOE is composed of signals in two lines (OEx, OEy), and a reversed signal of the signal OEx is inputted to the odd-numbered AND circuits while a reversed signal of the signal OEy is inputted to the even-numbered AND circuits. Further, an output from a single AND circuit goes through the output circuit 46 to become a gate-on pulse signal, which is then supplied to a single scan signal line.

For example, an output from a certain stage of the shift register 45 is divided into two lines, one of which Qc is inputted to the AND circuit 66c, while the other one thereof. Qd is inputted to the AND circuit 66d. Additionally, a reversed signal of the signal OEx is inputted to the AND circuit 66c, while a reversed signal of the signal OEy is inputted to the AND circuit 66d. Furthermore, an output from the AND circuit 66c enters the output circuit 46 to become a gate-on pulse signal Gc, which is supplied to the scan signal line 16c. Also, an output from the AND circuit 66d enters the output circuit 46 to become a gate-on pulse signal Gd, which is supplied to the scan signal line 16d.

In the same manner, an output from another stage of the shift register 45 is divided into two lines, one of which Qa is inputted to the AND circuit 66a, while the other one thereof. Qb is inputted to the AND circuit 66b. Additionally, a reversed signal of the signal OEx is inputted to the AND circuit 66a, while a reversed signal of the signal OEy is inputted to the AND circuit 66b. Furthermore, an output from the AND circuit 66a enters the output circuit 46 to become a gate-on pulse signal Ga, which is supplied to the scan signal line 16a. Also, an output from the AND circuit 66b enters the output circuit 46 to become a gate-on pulse signal Gb, which is supplied to the scan signal line 16b.

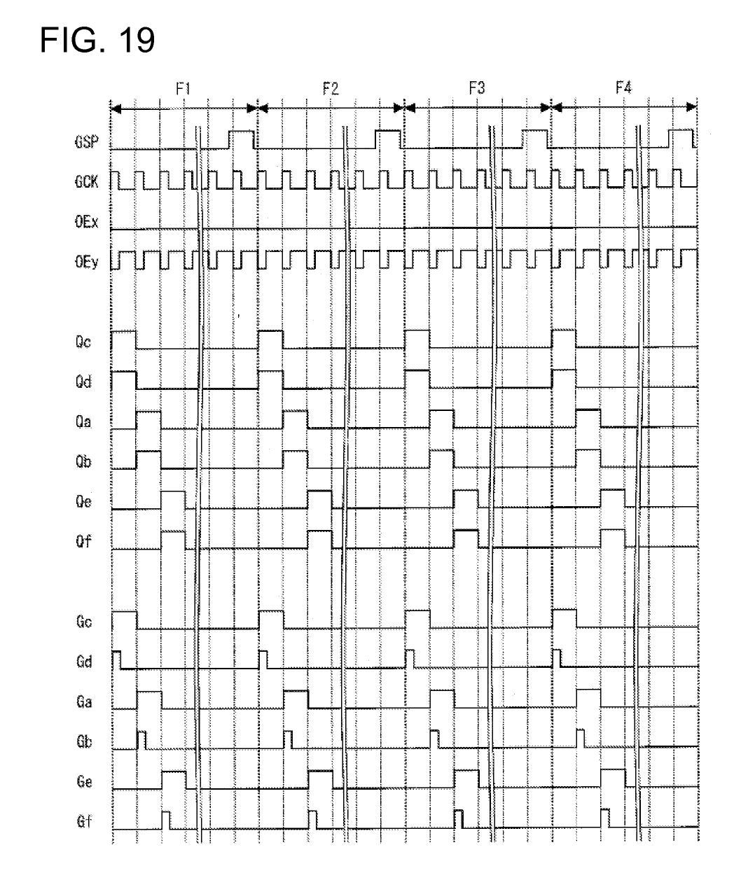

FIG. 19 is a timing chart showing an operation of a gate driver of FIG. 18. As shown in FIG. 19, for example, the signal OEx is always “L” at each frame, while the signal OEy becomes “L” at a front edge portion of each horizontal scanning period. Note that the signal OEx does not always have to be “L” and can be “H” at a rear edge portion of each horizontal scanning period when the fall of the waveform of the gate-on pulse becomes slow and overlaps the subsequent horizontal scanning period. That way, the gate-on pulse signals Gc, Ga, Ge can sequentially become “H” (active), and at the same time, the gate-on pulse signals Gd, Gb, Gf can sequentially become “H” (active). Also, the width (“H” period (active period)) of the gate-on pulse signal (writing pulse) can be set differently for the gate-on pulse signals Gc, Ga, Ge and for the gate-on pulse signals Gd, Gb, Gf, respectively. As a result, such a driving as shown in FIG. 17 can be realized.

Here, according to the configuration of FIG. 18, in addition to an advantage that the width of the gate-on pulse (writing pulse) can be accordingly set, it is also possible to generate gate-on pulse signals, which are to be supplied respectively to two scan signal lines corresponding to one pixel, using an output from the same stage of one shift register, thereby obtaining an additional advantage that the configuration of the driver can be simplified.

(Driving Method 2)

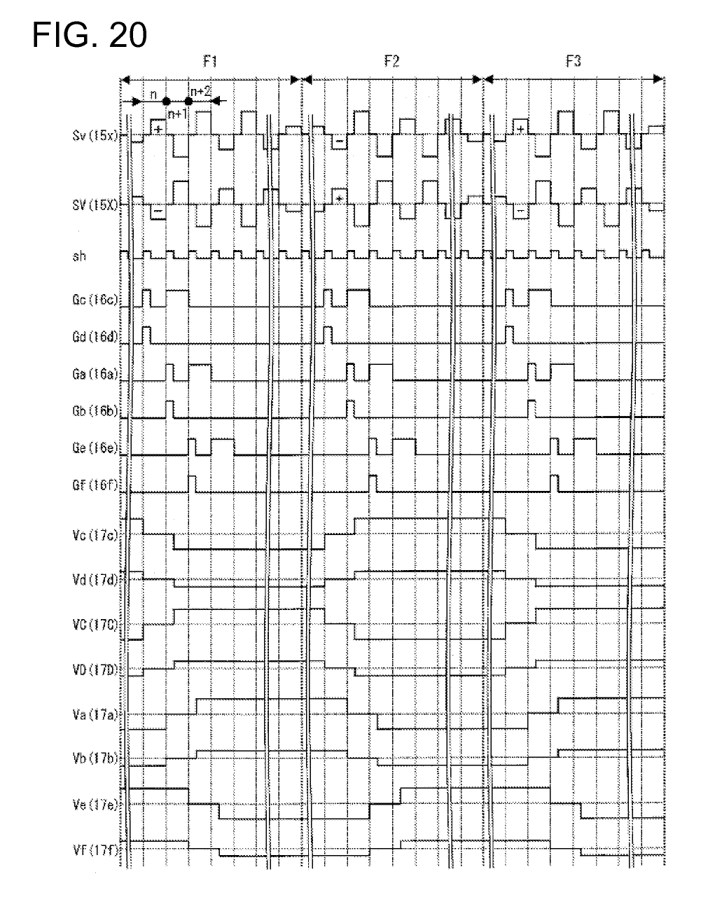

FIG. 20 is a timing chart showing another driving method of the present liquid crystal display device. Reference characters shown in this figure are identical to those shown in FIG. 17. Also in this driving method, similarly to the method shown in FIG. 17, the polarity of a signal potential supplied to a data signal line is reversed every horizontal scanning period (1H); the polarity of a signal potential supplied for the same numbered horizontal scanning period in respective frames is reversed every frame; and signal potentials having reversed polarities are supplied to two adjacent data signal lines during one horizontal scanning period; and a charge-sharing is performed at the beginning of each horizontal scanning period

This driving method supplies Vcom to all of the pixel electrodes within one pixel area by selecting at the same time a pair of the upper and lower scan signal lines for that one pixel during a horizontal scanning period immediately prior to the normal writing.

Specifically, in F1 of sequential frames F1 to F4, the upper and lower scan signal lines for each pixel is progressively selected as a pair (for example, scan signal lines 16c, 16d->scan signal lines 16a, 16b; see FIG. 1). To one of the two adjacent data signal lines (for example, a data signal line 15x), a signal potential having a positive polarity is supplied during the n-th horizontal scanning period, and a Vcom signal is supplied at the beginning of that period; a signal potential having a negative polarity is supplied during the (n+1)-th horizontal scanning period (for example, a period including the writing period of the pixel electrode 17c) and a Vcom signal is supplied at the beginning of that period; and a signal potential having a positive polarity is supplied during the (n+2)-th horizontal scanning period (for example, a period including the writing period of the pixel electrode 17a) and a Vcom signal is supplied at the beginning of that period. To the other one of the above-mentioned two data signal lines (for example, the data signal line 15X), a signal potential having a negative polarity is supplied during the n-th horizontal scanning period and a Vcom signal is supplied at the beginning of that period; a signal potential having a positive polarity is supplied during the (n+1)-th horizontal scanning period (for example, a period including the writing period of the pixel electrodes 17C) and a Vcom signal is supplied at the beginning of that period; and a signal potential having a negative polarity is supplied during the (n+2)-th horizontal scanning period (for example, a period including the writing period of the pixel electrodes 17A) and a Vcom signal is supplied at the beginning of that period.

As a result, a subpixel including the pixel electrode 17c (negative polarity) becomes “bright”; a subpixel including the pixel electrode 17d (negative polarity) becomes “dark”; a subpixel including the pixel electrode 17C (positive polarity) becomes “bright”; a subpixel including the pixel electrode 17D (positive polarity) becomes “dark”; a subpixel including the pixel electrode 17a (positive polarity) becomes “bright”; and a subpixel including the pixel electrode 17b (positive polarity) becomes “dark.”

With respect to the pixel 101, both transistors 12a, 12b are turned on during a horizontal scanning period (n+1) that is immediately prior to a horizontal scanning period (n+2) in which a normal writing is performed, and as a result, Vcom is supplied from the data signal line 15x to the pixel electrode 17a to which a normal signal potential is going to be written and to the pixel electrode 17b that is capacitively coupled to the same pixel electrode 17a, respectively. Further, while Vcom is being supplied, both transistors 12a, 12b are turned off. As a result, a signal potential having a negative polarity, which is supplied to the data signal 15x during the (n+1)-th horizontal scanning period, is supplied to the pixel electrode 17c of the previous row as a normal writing signal, but is not supplied to the pixel electrode 17a of the pixel 101. During the next (n+2)-th horizontal scanning period, only the transistor 12a is turned on, and after Vcom is supplied to the pixel electrode 17a at the beginning of that period, a signal potential having a positive polarity is supplied to the pixel electrode 17a as a normal writing signal.

According to the aforementioned driving method, in F1, a subpixel including the pixel electrode 17c (negative polarity) becomes “bright”; a subpixel including the pixel electrode 17d (negative polarity) becomes “dark”; a subpixel including the pixel electrode 17C (positive polarity) becomes “bright”; a subpixel including the pixel electrode 17D (positive polarity) becomes “dark”; a subpixel including the pixel electrode 17a (positive polarity) becomes “bright”; and a subpixel including the pixel electrode 17b (positive polarity) becomes “dark.”

Also, in F2, the positive polarity and the negative polarity are reversed, as compared with F1. As a result, a subpixel including the pixel electrode 17c (positive polarity) becomes “bright”; a subpixel including the pixel electrode 17d (positive polarity) becomes “dark”; a subpixel including the pixel electrode 17C (negative polarity) becomes “bright”; a subpixel including the pixel electrode 17D (negative polarity) becomes “dark”; a subpixel including the pixel electrode 17a (negative polarity) becomes “bright”; and a subpixel including the pixel electrode 17b (negative polarity) becomes “dark.” The same operations as those of the frames F1, F2 are repeated in the subsequent frames F3, F4.

According to the present driving method, as described above, by the time the transistor 12b is turned off, Vcom has been supplied from the data signal 15x to the pixel electrodes 17a and 17b. That is, at a time a normal signal potential is going to be written into the pixel electrode 17a, the potential of the pixel electrodes 17a, 17b has been fixed (reset) to Vcom. As a result, it becomes possible to ensure the discharge of electric charges accumulated in the capacitance coupling electrode (pixel electrode 17b) and also to prevent the deterioration of display quality.

Here, in the present driving method, it is configured such that the above-mentioned reset operation is performed during a horizontal scanning period (1H) immediately prior to a horizontal scanning period in which a normal writing is performed. However, the timing to perform this reset operation is not particularly limited and can be two or more H periods prior to the normal writing. Further, the frequency of the above-mentioned reset operation is not limited to one time, but can be multiple times.

(Configuration of Gate Driver 2)

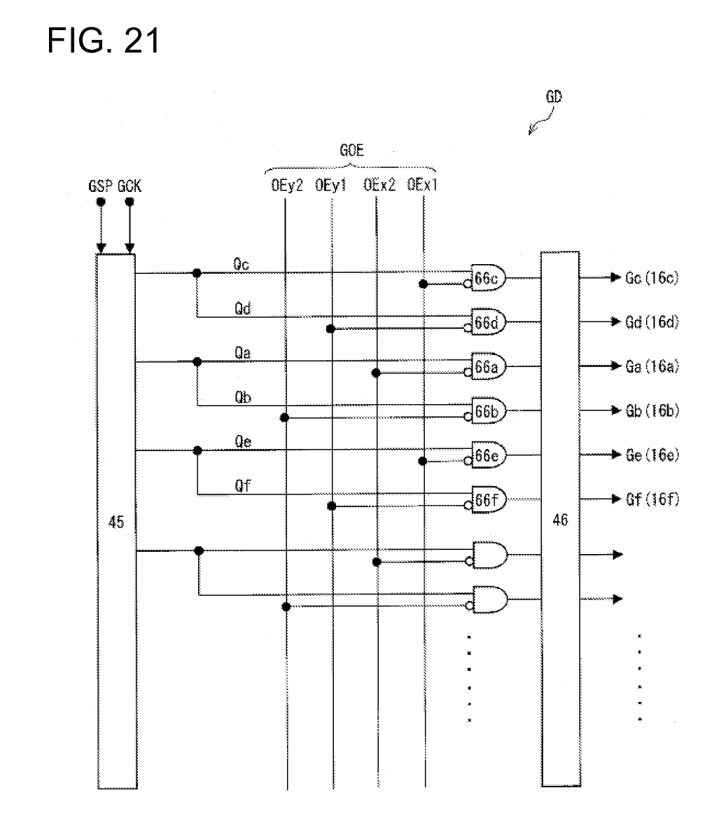

FIG. 21 is a circuit diagram showing a configuration of a gate driver of the present liquid crystal display device for realizing the driving shown in FIG. 20. As shown in FIG. 21, a gate driver GD includes a shift register 45, a plurality of AND circuits (66a to 660 aligned in the column direction, and an output circuit 46. To the shift register 45, a gate start pulse signal GSP and a gate clock signal GCK are inputted. An output of each stage of the shift register 45 is divided to two lines, one of which is inputted to an odd-numbered AND circuit, while the other one is inputted to an even-numbered AND circuit that is located adjacent to the respective aforementioned odd-numbered AND circuit. Also, a gate driver output control signal GOE is composed of four pieces of signals (OEx1, OEx2, OEy1, OEy2), and reversed signals of the signals OEx1, OEx2 are sequentially inputted to the odd-numbered AND circuits, while reversed signals of the signals OEy1, OEy2 are sequentially inputted to the even-numbered AND circuits. Further, an output from each AND circuit enters the output circuit 46 to become a gate-on pulse signal, which is supplied to a single scan signal line.

For example, an output from a given stage of the shift register 45 is divided into two lines, one of which Qc is inputted to the AND circuit 66c, while the other one thereof. Qd is inputted to the AND circuit 66d. Also, a reversed signal of the signal OEx1 is inputted to the AND circuit 66c, while a reversed signal of the signal OEy1 is inputted to the AND circuit 66d. Also, an output from the AND circuit 66c enters the output circuit 46 to become a gate-on pulse signal Gc, which is supplied to the scan signal line 16c. Also, an output from the AND circuit 66d enters the output circuit 46 to become a gate-on pulse signal Gd, which is supplied to the scan signal line 16d.

In the same manner, an output from another stage of the shift register 45 is divided into two lines, one of which Qa is inputted to the AND circuit 66a, while the other one thereof. Qb is inputted to the AND circuit 66b. Also, a reversed signal of the signal OEx2 is inputted to the AND circuit 66a, while a reversed signal of the signal OEy2 is inputted to the AND circuit 66b. Further, an output from the AND circuit 66a enters the output circuit 46 to become a gate-on pulse signal Ga, which is supplied to the scan signal line 16a. Also, an output from the AND circuit 66b enters the output circuit 46 to become a gate-on pulse signal Gb, which is supplied to the scan signal line 16b.

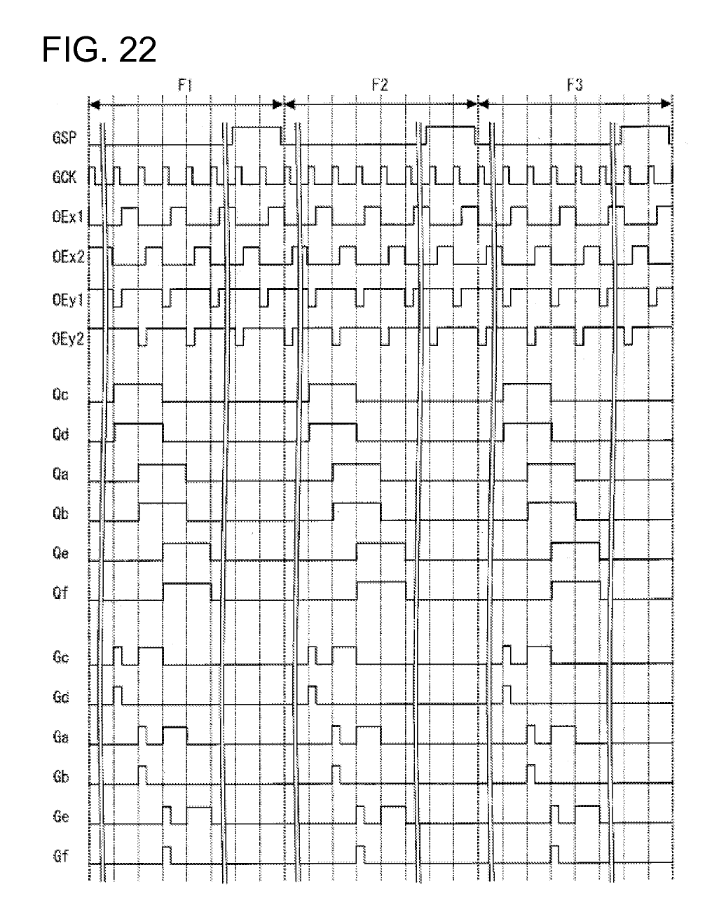

FIG. 22 is a timing chart showing an operation of a gate driver of FIG. 21. As shown in FIG. 22, signals OEx1, OEx2 are constructed, for example, in the unit of two horizontal scanning periods (2H), respectively, and respectively become “L” in one H period (1H) of the two H periods (2H), and becomes “L” in the front edge portion of the other 1H period and becomes “H” (active) during the rest. Additionally, the signals OEx1, OEx2 are shifted from each other by a 1H period. Meanwhile, signals OEy1, OEy2 are constructed in the unit of two horizontal scanning periods (2H), respectively, and respectively become “L” in the front edge portion of the 1H period of the 2H periods, and becomes “H” (active) during the rest of that 1H period and during the other 1H period. Also, the signals OEy1, OEy2 are shifted from each other by 1H period. For an output Q of the shift register 45, signals that become “H” during two horizontal scanning periods (2H) are sequentially outputted from each stage. As a result, such a driving as shown in FIG. 20 can be realized.

(Driving Method 3)

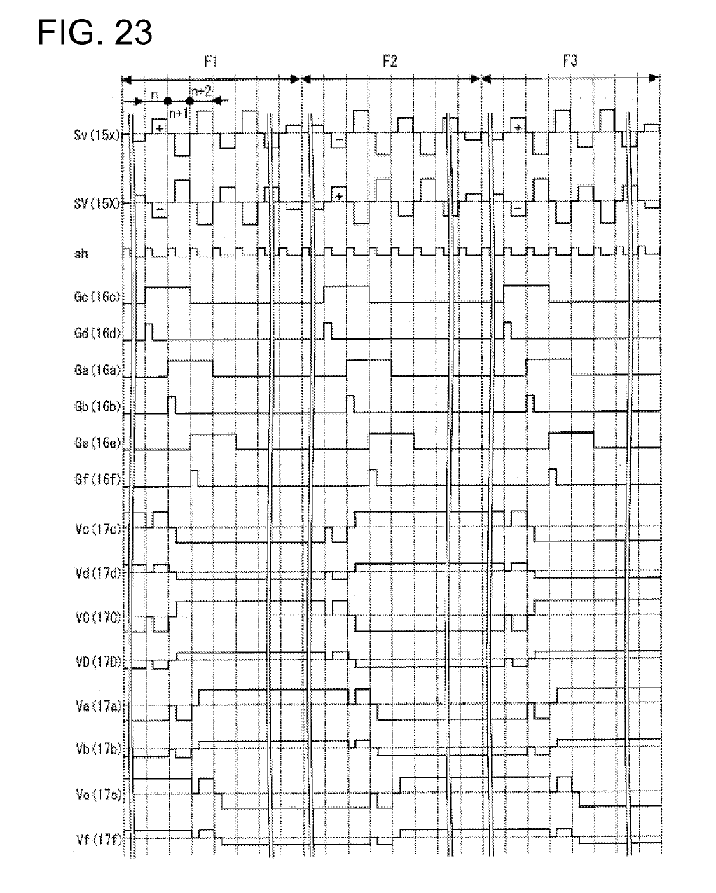

FIG. 23 is a timing chart that shows another driving method of the present liquid crystal display device. According to the above-mentioned driving method 2, during one preceding horizontal scanning period before the normal writing, both transistors 12a, 12b are turned off after Vcom is supplied to the pixel electrodes 17a, 17b and until the normal writing is performed to the pixel electrode 17a. According to the present driving method, on the other hand, during one preceding horizontal scanning period before the normal writing, only the transistor 12b is turned off after Vcom is supplied to the pixel electrodes 17a, 17b, and a signal potential is supplied to the pixel electrode 17a while the transistor 12a remains on. In the following, contents that duplicate those of the driving method 2 are omitted, and the differences from the driving method 2 are mainly explained specifically by taking a pixel 101 as an example.

With respect to the pixel 101, both transistors 12a, 12b are turned on during one preceding horizontal scanning period (n+1) before a horizontal scanning period during which a normal writing is performed (n+2), and Vcom is supplied to a pixel electrode 17a to which a normal signal potential is written and to a pixel electrode 17b that is capacitively coupled to the same pixel electrode 17a, respectively. Further, while Vcom is being supplied, only the transistor 12b is turned off. As a result, a signal potential having a negative polarity, which is supplied to the data signal line 15x during the (n+1)-th horizontal scanning period, is supplied to the pixel electrode 17c of the previous row as a normal writing signal; and at the same time, a signal potential identical to that signal potential is supplied to the pixel electrode 17a in the pixel 101. In other words, a data signal (signal potential) for the pixel electrode 17c of the previous row is written into the pixel electrode 17a during one horizontal scanning period (1H) immediately prior to the normal writing. Since the transistor 12a remains on, Vcom is supplied to the pixel electrode 17a at the beginning of the next (n+2) horizontal scanning period, and then a signal potential having a positive polarity is supplied thereto as a normal writing signal during the same period.

According to the present driving method, as described above, in a manner similar to that of the aforementioned driving method 2, Vcom has been supplied from the data signal line 15x to the pixel electrodes 17a, 17b when the transistor 12b is turned off. Because of this, when a normal signal potential is going to be written into the pixel electrode 17a, the potential of the pixel electrodes 17a, 17b can be fixed (reset) to Vcom. Therefore, even if a signal potential other than a normal signal potential is supplied to the pixel electrode 17a after the potential of both pixel electrodes 17a, 17b is once reset to Vcom, the total sum of capacitances at the pixel electrodes 17a, 17b does not change. As a result, it becomes possible to ensure the discharging of electric charges accumulated in a capacitance coupling electrode (pixel electrode 17b) and also to prevent the deterioration of display quality.

(Configuration of Gate Driver 3)

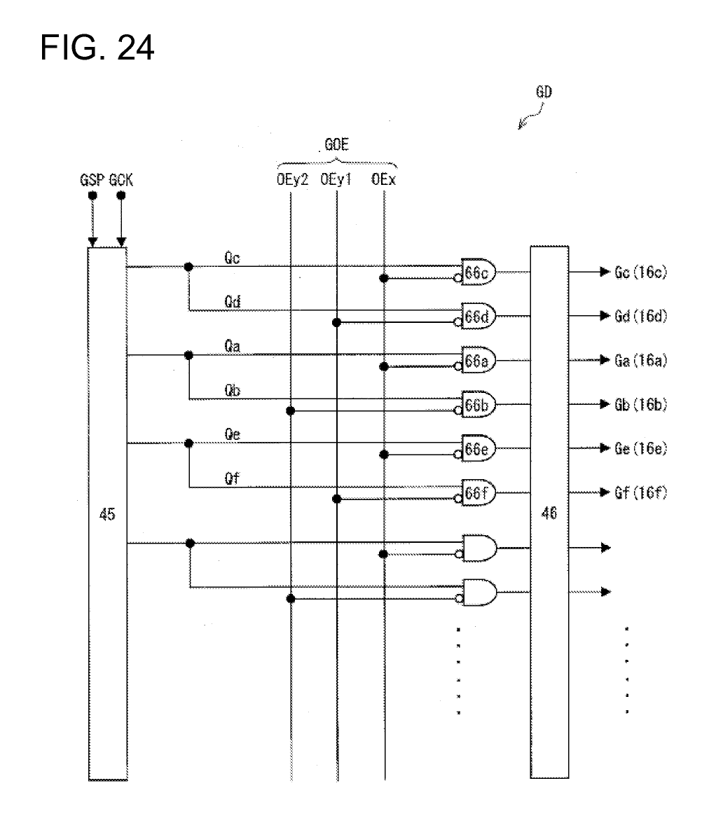

FIG. 24 is a circuit diagram showing a configuration of a gate driver of the present liquid crystal display device for realizing the driving described in FIG. 23. As shown in FIG. 24, a gate driver GD includes a shift register 45, a plurality of AND circuits (66a to 660 aligned in the column direction, and an output circuit 46. To the shift register 45, a gate start pulse signal GSP and a gate clock signal GCK are inputted. An output of each stage of the shift register 45 is divided into two lines, one of which is inputted to an odd-numbered AND circuit, while the other one is inputted to an even-numbered AND circuit that is located adjacent to the aforementioned odd-numbered AND circuit, respectively. Also, a gate driver output control signal GOE is composed of three pieces of signals (OEx, OEy1, OEy2), and a reversed signal of the signal OEx is inputted to the odd-numbered AND circuits, while reversed signals of the signals OEy1, OEy2 are sequentially inputted to the even-numbered AND circuits. Further, an output from one AND circuit enters the output circuit 46 and becomes a gate-on pulse signal, which is supplied to a single scan signal line.

An output from a certain stage of the shift register 45 is divided into two lines, one of which Qc is inputted to an AND circuit 66c, while the other one Qd is inputted to an AND circuit 66d, for example. Also, a reversed signal of the signal OEx is inputted to the AND circuit 66c, while a reversed signal of the signal OEy1 is inputted to the AND circuit 66d. And, an output from the AND circuit 66c goes through the output circuit 46 and becomes a gate-on pulse signal Gc, which is supplied to the scan signal line 16c. Also, an output from the AND circuit 66d goes through the output circuit 46 to become a gate-on pulse signal Gd, which is supplied to the scan signal line 16d.

In the same manner, an output from another stage of the shift register 45 is divided into two lines, one of which Qa is inputted to an AND circuit 66a, while the other one Qb is inputted to an AND circuit 66b. Also, a reversed signal of the signal OEx is inputted to the AND circuit 66a, while a reversed signal of the signal OEy2 is inputted to the AND circuit 66b. Further, an output from the AND circuit 66a enters the output circuit 46 to become a gate-on pulse signal Ga, which is supplied to the scan signal line 16a. Also, an output from the AND circuit 66b enters the output circuit 46 to become a gate-on pulse signal Gb, which is supplied to the scan signal line 16b.

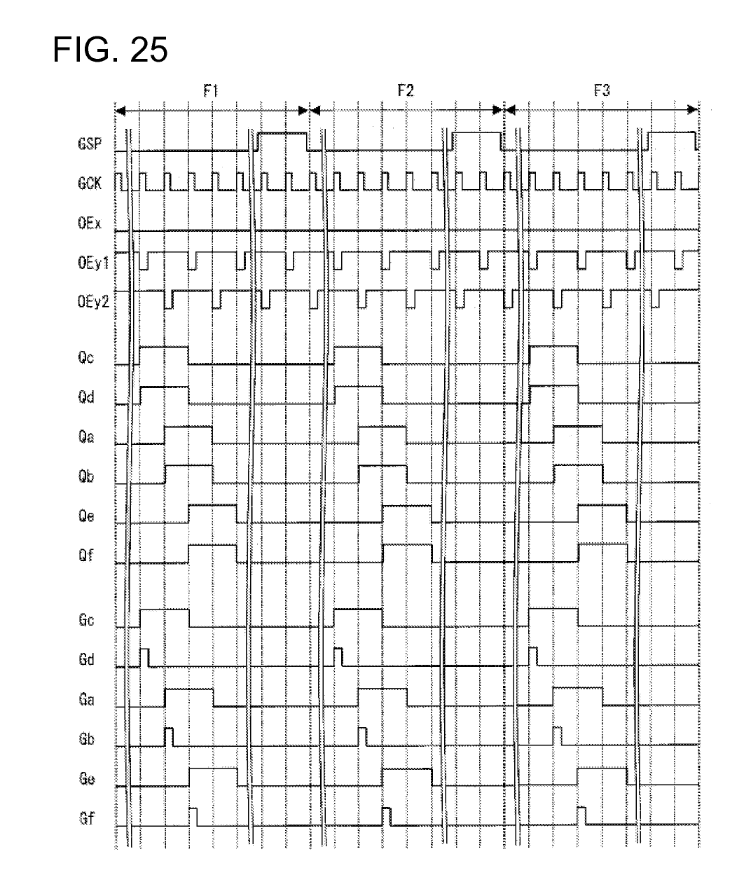

FIG. 25 is a timing chart showing an operation of a gate driver in FIG. 24. For example, as shown in FIG. 25, a signal OEx is always “L” in each frame. Here, the signal OEx does not always have to be “L” but instead can be “L” only at a rear edge portion of each horizontal scanning period when the fall of the waveforms of the gate-on pulse becomes slow and overlaps the subsequent horizontal scanning period. The signals OEy1, OEy2 are respectively constructed in the unit of two horizontal scanning periods (2H). In one 1H period of the 2H periods, the signals becomes “L” in a front edge portion of the 1H period and the rest thereof, and becomes “H” (active) in the other 1H period of the 2H periods. Further, the signals OEy1, OEy2 are shifted from each other by 1H period. For outputs Q of the shift register 45, signals that become and remain “H” during two consecutive horizontal scanning periods are outputted sequentially from respective stages. As a result, the driving shown in FIG. 23 can be realized.

(Driving method 4)

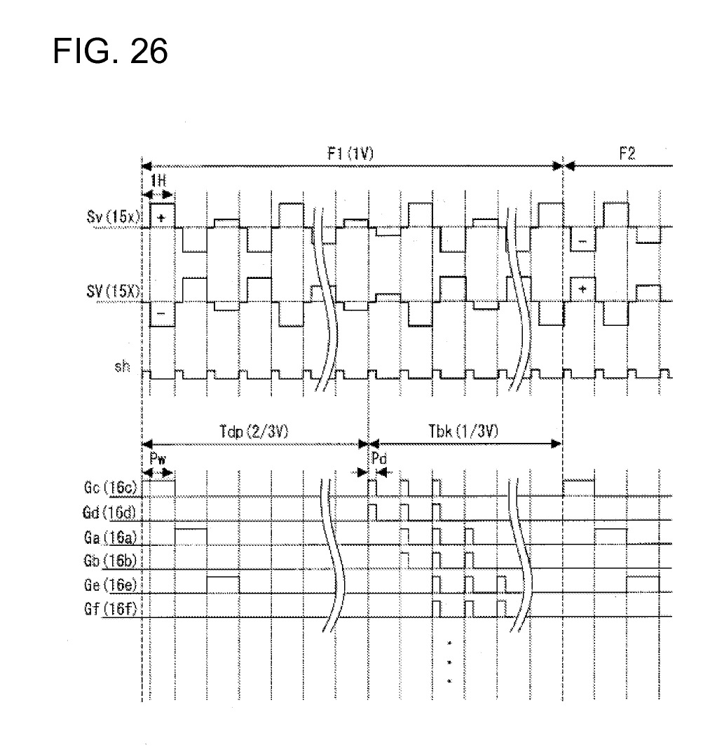

FIG. 26 is a timing chart showing another driving method of the present liquid crystal display panel. Reference characters used in this figure are the same as those used in FIG. 17. According to this driving method, similar to FIG. 17, the polarity of a signal potential that is supplied to a data signal line is reversed every horizontal scanning period (1H); the polarity of a signal potential that is supplied during the same numbered horizontal scanning period in respective frames is reversed every frame; signal potentials having reversed polarities are supplied to two adjacent data signal lines during one horizontal scanning period; and a charge-sharing is performed at the beginning of each horizontal scanning period.

According to the present driving method, conceptually, after a predetermined period (for example, approximately two-thirds (⅔V) of one vertical scanning period (1V)) has passed following the normal writing of a signal potential to a pixel electrode (pixel electrodes 17a, 17c, 17e, 17A, 17C, 17E shown in FIG. 1), a signal potential (Vcom) for discharging (refreshing) electric charges is supplied to the pixel electrode (17a, 17c, 17e, 17A, 17C, 17E) as well as to the capacitance coupling electrode (pixel electrodes 17b, 17d, 17f, 17B, 17D, 17F) that is capacitively coupled to the aforementioned pixel electrode. As a result, it becomes possible to insert a period of black display to every display line, which leads to such advantages that accumulated electric charge can be discharged from the capacitance coupling electrodes and that trailing afterimages can be reduced due to the impulse driving.

Specifically, in F1, during the ⅔ V period, one of the upper and lower scan signal lines for respective pixels is progressively selected (for example, as in the scan signal line 16c->the scan signal line 16a->the scan signal line 16e; see FIG. 1). To one of the two adjacent data signal lines (for example, the data signal line 15x), a signal potential having a positive polarity is supplied during the first horizontal scanning period (for example, a period including the writing period of the pixel electrodes 17c, 17d); a signal potential having a negative polarity is supplied thereto during the second horizontal scanning period (for example, a period including the writing period of the pixel electrodes 17a, 17b); and a signal potential having a positive polarity is supplied thereto during the third horizontal scanning period (for example, a period including the writing period of the pixel electrodes 17e, 17f). To the other one of the two data signal lines (for example, the data signal line 15X), a signal potential having a negative polarity is supplied during the first horizontal scanning period (for example, a period including the writing period of the pixel electrodes 17C, 17D); a signal potential a having positive polarity is supplied thereto during the second horizontal scanning period (for example, a period including the writing period of the pixel electrodes 17A, 17B); and a signal potential having a negative polarity is supplied thereto during the third horizontal scanning period (for example, a period including the writing period of the pixel electrodes 17E, 17F). Here, at the beginning of each horizontal scanning period, a charge-sharing potential (Vcom) is supplied.

During the remaining ⅓ V period, at the beginning of each horizontal scanning period, the pairs of upper and lower scan signal lines for respective pixels are sequentially selected (for example, the scan signal lines 16c, 16d->the scan signal lines 16a, 16b->the scan signal lines 16e, 16f; see FIG. 1), and Vcom is supplied to the corresponding data signal lines (for example, the data signal lines 15x, 15X).

With respect to the pixel 101, in the pixel electrode 17a, for example, a potential of the data signal line 15x connected to a source terminal of a transistor 12a is supplied to the pixel electrode 17a via the transistor 12a during a period when the transistor 12a is on due to a pixel data writing pulse Pw included in the gate-on pulse signal Ga. As a result, a data signal Sv as a voltage of the data signal line 15x is written into the pixel electrode 17a. Then, after an image display period Tdp passes, black voltage application pulses Pb are supplied to the respective gate terminals of the transistors 12a, 12b, and while the transistors 12a, 12b are on, the pixel electrode 17a is connected to the data signal line 15x via the transistor 12a and the pixel electrode 17b is connected to the data signal line 15x via the transistor 12b. As a result, accumulated electric charges at the pixel capacitance of the pixel electrode 17b are discharged, and a black voltage (Vcom) is maintained at the pixel capacitances of the pixel electrodes 17a, 17b.

Therefore, at the pixel 101, during the image display period Tdp, a display pixel based on a digital image signal is formed by holding, at the pixel capacitance, a voltage that corresponds to a potential of the data signal line 15x supplied to the pixel electrode 17a via the transistor 12a. Meanwhile, a pixel of black is formed by holding a black voltage (Vcom) at the pixel capacitance during the Tbk period, which includes a period after the black voltage application pulses Pb appears on gate-on pulse signals Ga, Gb that are provided to gate terminals of the transistors 12a, 12b, respectively, until a next pixel data writing pulse Pw appears on the gate-on pulse signal Ga (a period equivalent to one frame period or 1V minus an image display period Tdp).

Here, since the pulse width of the black voltage application pulses Pb is short, at least two or preferably three or more black voltage application pulses Pb are sequentially applied to the aforementioned scan signal lines at an interval of the horizontal scanning period (1H) during each frame period so as to ensure that the holding voltage in the pixel capacitance be at the black voltage. In FIG. 26, three consecutive black voltage application pulses Pb appear at an interval of one horizontal scanning period (1H) in one frame period (1V).

According to the present driving method, by inserting a period of black display to every display line, the display is impulse-driven while avoiding an increase in complexity of drive circuits and operation frequency. As a result, in addition to the advantage of discharging accumulated electric charges, trailing afterimages of moving images can be suppressed, thereby improving the display quality of moving images.

Here, while each of the above-described driving methods discusses a liquid crystal panel for which two pixel electrodes (for example, pixel electrodes 17a, 17b) are formed in one pixel (for example, pixel 101), these driving methods can also be applied to cases in which three pixel electrodes are formed. For example, the liquid crystal panel shown in FIG. 9 is configured so that the pixel electrode 17a′ is electrically connected to the pixel electrode 17a, which makes a potential change of the pixel electrode 17a′ identical to that of the pixel electrode 17a. For this reason, it is possible to apply the above-described driving methods regardless of the number of pixel electrodes formed in one pixel.

Also, each of the driving methods is configured for a charge-sharing method, but the present invention is not limited to this. As another method, for example, it can be configured such that each frame has a certain period during which all transistors are turned on and all data signal lines are supplied with Vcom.

A specific configuration of a source driver for realizing a charge-sharing method in these above-described driving methods is described later in the section entitled “Configurations of liquid crystal display unit and liquid crystal display device.”

### Specific Example of Liquid Crystal Panel 1-4

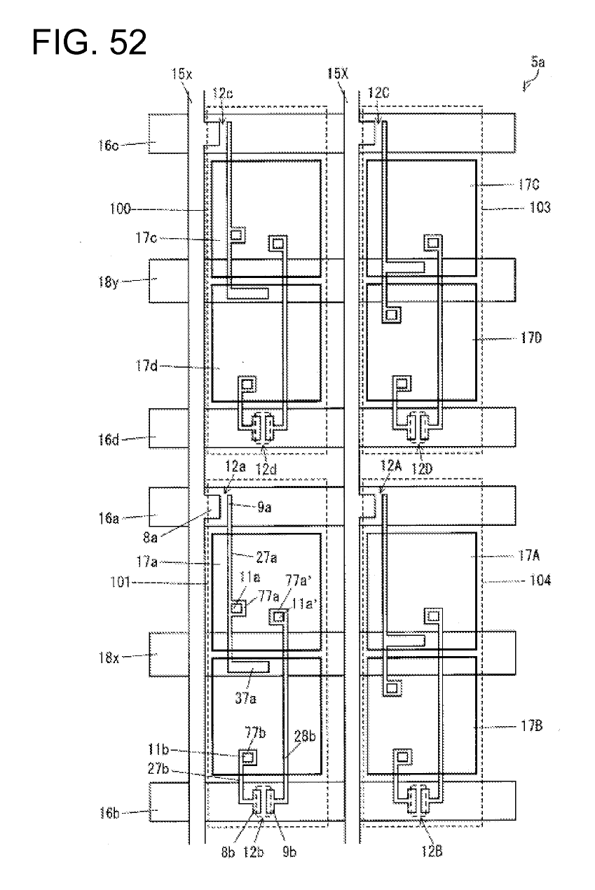

Here, the liquid crystal panel 5a shown in FIG. 2 may also be configured in a manner shown in FIG. 52. In a liquid crystal panel 5a shown in FIG. 52, two pixels (101, 104) are aligned adjacently in the row direction. In one of the pixels (pixel 101), a pixel electrode (17a) closer to a transistor (12a) is connected to the transistor (12a), while in the other pixel (pixel 104), a pixel electrode (17B) farther from a transistor (12A) is connected to that transistor (12A).

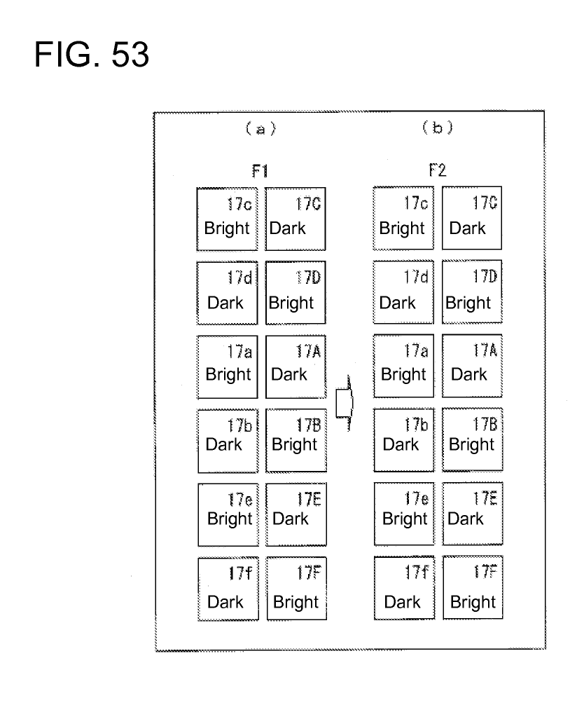

In a liquid crystal display device equipped with the liquid crystal panel 5a shown in FIG. 52, when data signal lines 15x, 15x are driven in a manner shown in FIG. 17, for example, a frame F1 appears as a whole as shown in FIG. 53(a), while a frame F2 appears as a whole as shown in FIG. 53(b). In the subsequent frames F3, F4, the operations in the frames F1, F2 are repeated.

According to the liquid crystal panel shown in FIG. 52, bright subpixels are not aligned adjacent to each other in the row direction, nor are dark subpixels aligned adjacent to each other in the row direction, thereby reducing uneven streaks in the row direction.

### Second Embodiment

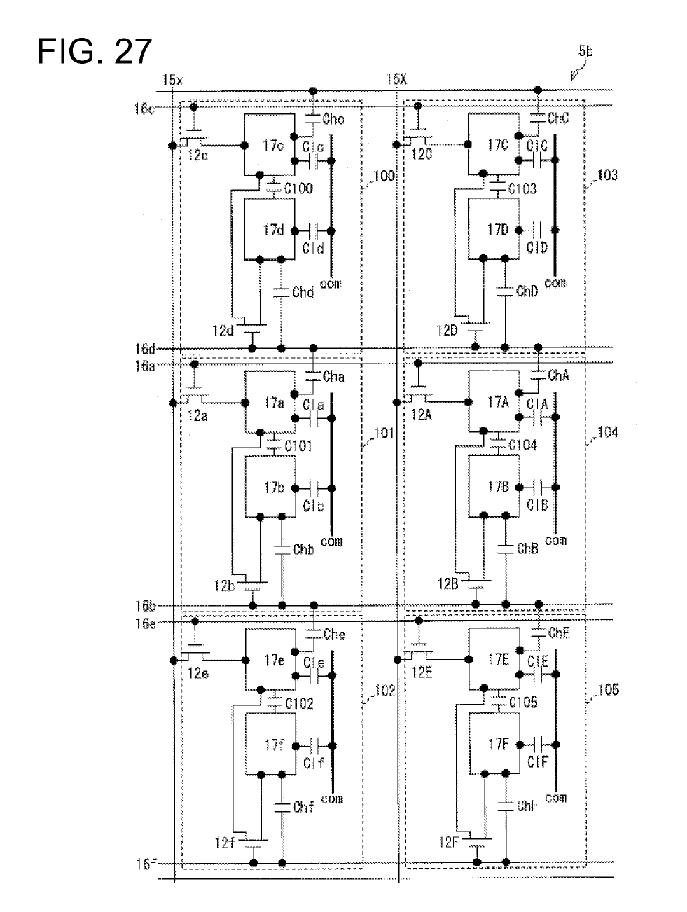

FIG. 27 is an equivalent circuit diagram that shows a portion of the present liquid crystal panel of the present second embodiment. As shown in FIG. 27, a liquid crystal panel 5b includes data signal lines (15x, 15X) extending in the column direction (up-down direction in the diagram); scan signal lines (16a to 160 extending in the row direction (left-right direction in the diagram); pixels (100 to 105) aligned in both the row and column directions; and a common electrode (counter electrode) “com.” Each pixel has an identical configuration. Also, a pixel column containing the pixels 100 to 102 and a pixel column containing the pixels 103 to 105 are aligned adjacently. Since the liquid crystal panel 5b has a “Cs on gate” structure, storage capacitance wirings (18x to 18z) provided on the liquid crystal panel 5a as shown in FIG. 1 are not required, which is an advantage.

In the liquid crystal panel 5b, one data signal line and two scan signal lines are provided for each pixel. Two pixel electrodes 17c, 17d provided in the pixel 100, two pixel electrodes 17a, 17b provided in the pixel 101, and two pixel electrodes 17e, 17f provided in the pixel 102 are aligned in one column, while two pixel electrodes 17C, 17D provided in the pixel 103, two pixel electrodes 17A, 17B provided in the pixel 104, and two pixel electrodes 17E, 17F provided in the pixel 105 are aligned in one column. The pixel electrodes 17c, 17C, the pixel electrodes 17d, 17D, the pixel electrodes 17a, 17A, the pixel electrodes 17b, 17B, the pixel electrodes 17e, 17E, and the pixel electrodes 17f, 17F are aligned adjacently to each other in the row direction, respectively.

Because each pixel has an identical configuration, the following mainly describes the configuration of the pixel 101 as an example.

In the pixel 101, the pixel electrodes 17a, 17b are connected to each other via a coupling capacitance C101; the pixel electrode 17a is connected to a data signal line 15x via a transistor 12a connected to a scan signal line 16a; and the pixel electrode 17b is connected to the pixel electrode 17a via a transistor 12b connected to a scan signal line 16b; a storage capacitance Cha is formed between the pixel electrode 17a and the scan signal line 16d; a storage capacitance Chb is formed between the pixel electrode 17b and the scan signal line 16b; a liquid crystal capacitance C1a is formed between the pixel electrode 17a and the common electrode “com”; and a liquid crystal capacitance C1b is formed between the pixel electrode 17b and the common electrode “com.”

### Specific Example of Liquid Crystal Panel 2-1

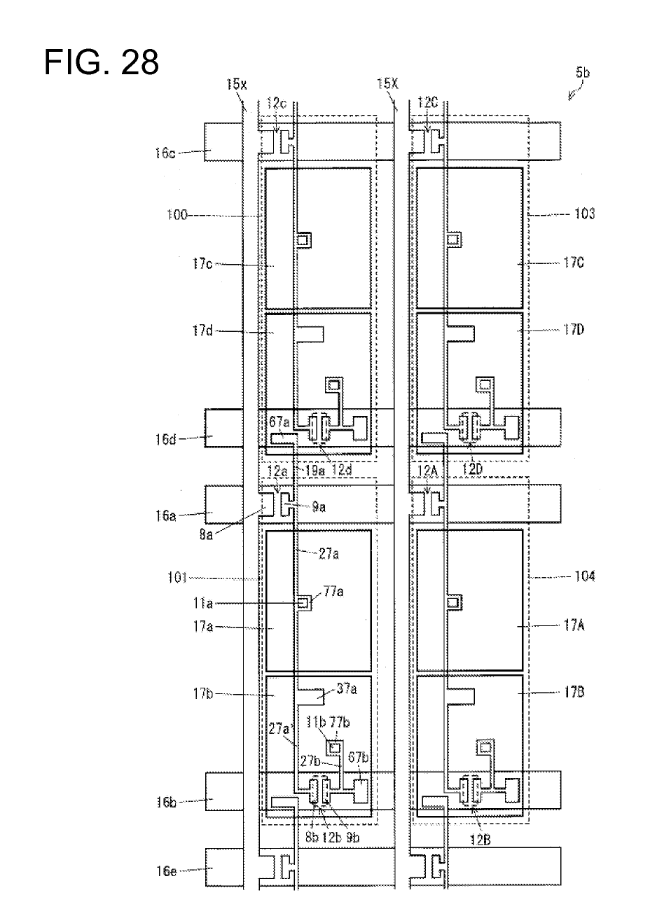

A specific example 2-1 of a liquid crystal panel 5b is shown in FIG. 28. In the liquid crystal panel 5b in FIG. 28, a data signal line 15x is provided so as to align along pixels 100, 101; and a data signal line 15x is provided along pixels 103, 104.

Here, a scan signal line 16c is arranged at one edge of the pixel 100; a scan signal line 16d is arranged at the other edge thereof; and viewed planarly, pixel electrodes 17c, 17d are aligned in the column direction between the scan signal lines 16c, 16d. In the same manner, the scan signal line 16c is arranged at one edge of the pixel 103; the scan signal line 16d is arranged at the other edge thereof; and viewed planarly, pixel electrodes 17C, 17D are aligned in the column direction between the scan signal lines 16c, 16d.

Also, a scan signal line 16a is arranged at one edge of the pixel 101; a scan signal line 16b is arranged at the other edge thereof; and viewed planarly, pixel electrodes 17a, 17b are arranged in the column direction between the scan signal lines 16a, 16b. In the same manner, the scan signal line 16a is arranged at one edge of the pixel 104; the scan signal line 16b is arranged at the other edge thereof; and viewed planarly, pixel electrodes 17A, 17B are arranged in the column direction between the scan signal lines 16a, 16b.

In the pixel 101, a source electrode 8a and a drain electrode 9a of a transistor 12a are formed over the scan signal line 16a, while a source electrode 8b and a drain electrode 9b of a transistor 12b are formed over the scan signal line 16b. The source electrode 8a is connected to the data signal line 15x. The drain electrode 9a is connected to a drain lead-out wiring 27a; the drain lead-out wiring 27a is connected to a contact electrode 77a and a coupling capacitance electrode 37a; the contact electrode 77a is connected to the pixel electrode 17a via a contact hole 11a; and the coupling capacitance electrode 37a overlaps the pixel electrode 17b via an interlayer insulating film. As a result, a coupling capacitance C101 (see FIG. 27) between the pixel electrodes 17a, 17b is formed. Also, the drain electrode 9a that is electrically connected to the pixel electrode 17a is connected to a storage capacitance electrode 67a via a drain lead-out wiring 19a, and the storage capacitance electrode 67a overlaps the scan signal line 16d that is adjacent to the scan signal line 16a via a gate insulating film, thereby forming a storage capacitance Cha (see FIG. 27).

Also, an extended coupling capacitance electrode 27a′ that is connected to the coupling capacitance electrode 37a is connected to the source electrode 8b of the transistor 12b. A drain lead-out wiring 27b led out from the drain electrode 9b of the transistor 12b is connected to a contact electrode 77b, and the contact electrode 77a is connected to the pixel electrode 17b via a contact hole 11b. Also, the drain electrode 9b that is electrically connected to the pixel electrode 17b is connected to a storage capacitance electrode 67b via a drain lead-out wiring 19b, and the storage capacitance electrode 67b overlaps the scan signal line 16b via a gate insulating film, thereby forming a storage capacitance Chb (see FIG. 27). Note that the configuration (geometry and alignment of each component as well as connection relation therebetween) of other pixels is the same as that of the pixel 101.

According to the aforementioned configuration, the subpixel including the pixel electrode 17a is “bright” while the subpixel including the pixel electrode 17b is “dark.”

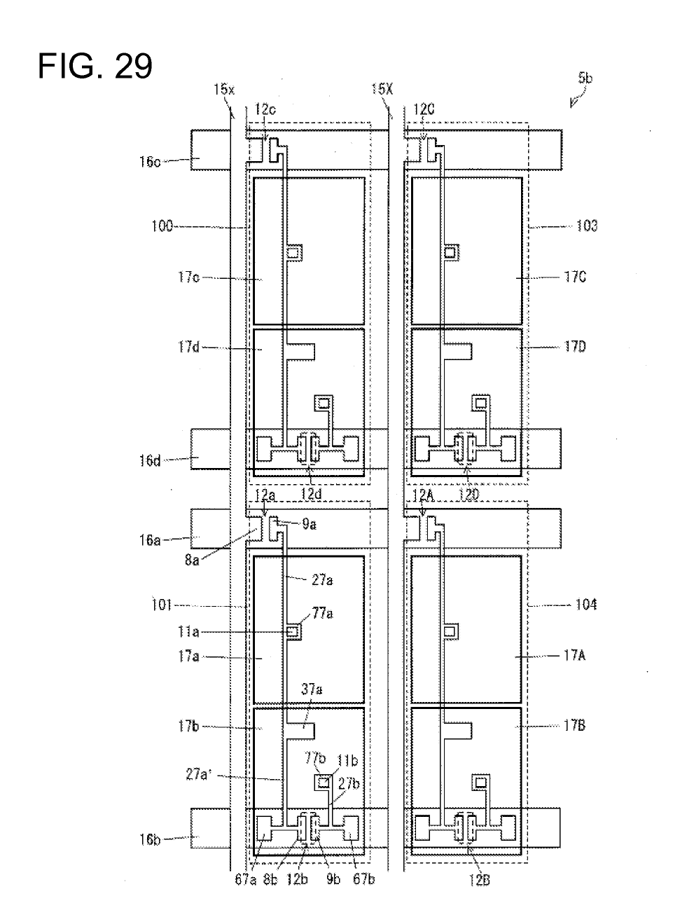

The above-mentioned storage capacitances Cha, Chb may also be formed in accordance with the configuration shown in FIG. 29. Specifically, as shown in FIG. 29, a drain electrode 9a is connected to a storage capacitance electrode 67a via a drain lead-out wiring 27a, and the storage capacitance electrode 67a overlaps a scan signal line 16b via a gate insulating film, thereby forming a storage capacitance Cha. A drain electrode 9b is connected to a storage capacitance electrode 67b via a drain lead-out wiring 27b, and the storage capacitance electrode 67b overlaps a scan signal line 16b via a gate insulating film, thereby forming a storage capacitance Chb.

Storage capacitances Cha, Chb of the liquid crystal panel 5b having a “Cs on gate” structure are preferably formed by the overlap of storage capacitance electrodes 67a, 67b and a (second) scan signal line 16d of the previous row, or the overlap of storage capacitance electrodes 67a, 67b and a (second) scan signal line 16b of the current row, as shown in FIGS. 28, 29. This is because, if the storage capacitances Cha, Chb are formed by the overlap of the storage capacitance electrodes 67a, 67b and the (first) scan signal line 16a of the current row, after the transistor 12a connected to the (first) scan signal line 16a is turned off, the fluctuation in the gate-on pulse signal supplied to the (first) scan signal line 16a can cause the fluctuation in the potential of the pixel electrodes 17a, 17b, which can lower the image quality. Therefore, in the liquid crystal panel 5b of the present embodiment, the storage capacitance Cha is preferably formed between the first pixel electrode 17a and the second scan signal line (the scan signal line 16b of the current row or the scan signal line 16d of the previous row) and that the storage capacitance Chb be formed between the second pixel electrode 17b and the second scan signal line (the scan signal line 16b of the current row or the scan signal line 16d of the previous row).

### Specific Example of Liquid Crystal Panel 2-2

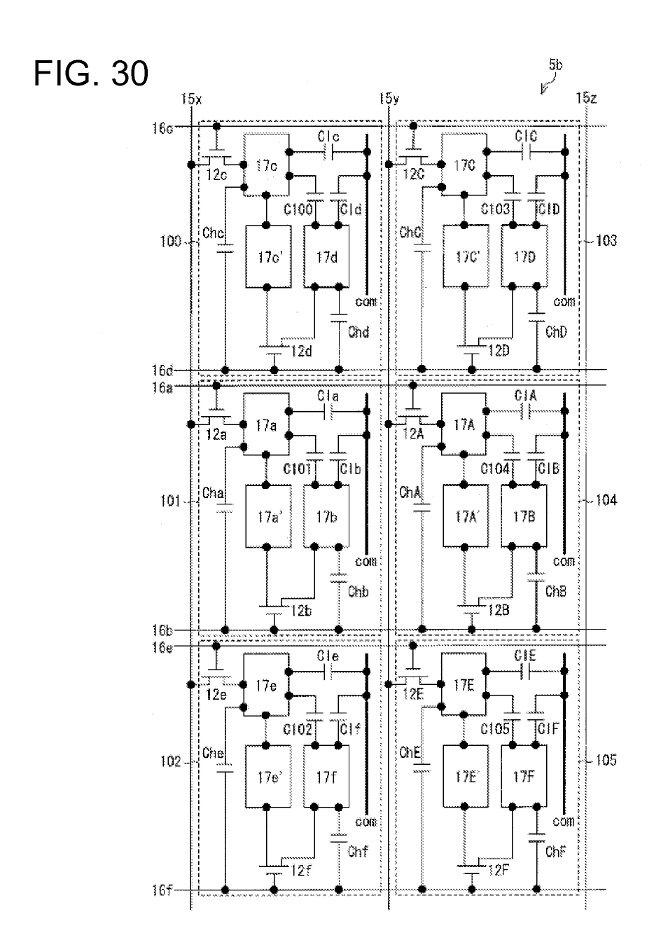

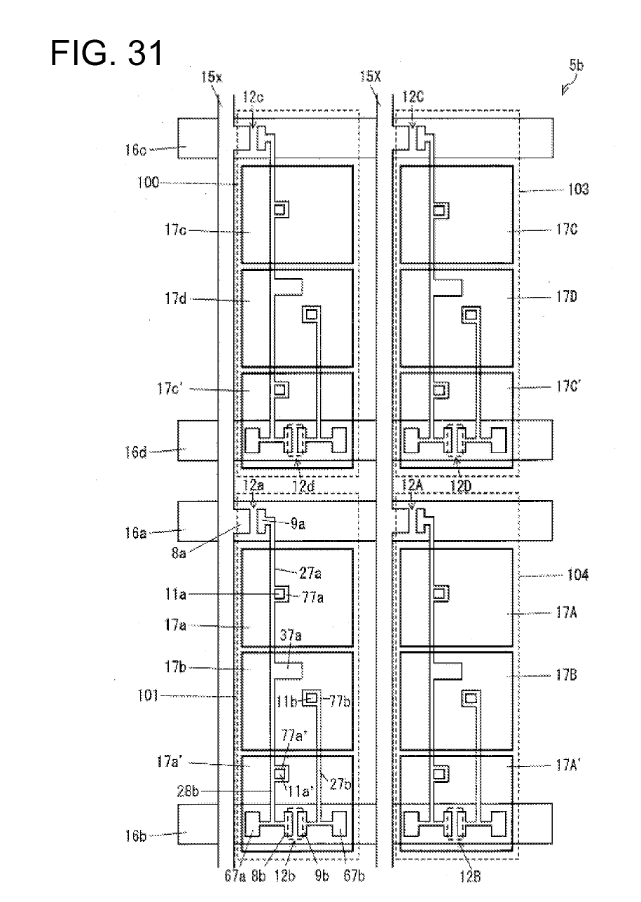

An equivalent circuit diagram for a specific example 2-2 of a liquid crystal panel 5b is shown in FIG. 30. The specific example 2-2 of the liquid crystal panel 5b is shown in FIG. 31.

As shown in FIG. 30, each pixel has an identical configuration, in which one data signal line and two scan signal lines are provided to each pixel. Three pixel electrodes 17c, 17d, 17c′ are provided in a pixel 100 (FIG. 30 shows a condition that the pixel electrodes 17c, 17c′ are electrically connected to each other); three pixel electrodes 17a, 17b, 17a′ are provided in a pixel 101 and three pixel electrodes 17e, 17f, 17e′ are provided in a pixel 102. Also, three pixel electrodes 17C, 17D, 17C′ are provided in a pixel 103; three pixel electrodes 17A, 17B, 17A′ are provided in a pixel 104; and three pixel electrodes 17E, 17F, 17E′ are provided in a pixel 105. The pixel electrodes 17c, 17C, the pixel electrodes 17c′, 17C′, the pixel electrodes 17d, 17D, the pixel electrodes 17a, 17A, the pixel electrodes 17a′, 17A′, the pixel electrodes 17b, 17B, the pixel electrodes 17e, 17E, the pixel electrodes 17e′, 17E′, and the pixel electrodes 17f, 17F are adjacent to each other in the row direction, respectively.

Taking the pixel 101 as an example, in the pixel 101, the pixel electrodes 17a, 17b are connected to each other via a coupling capacitance C101; the pixel electrode 17a is connected to the data signal line 15x via a transistor 12a that is connected to a scan signal line 16a; and the pixel electrode 17b is connected to a pixel electrode 17a′ that is electrically connected to pixel electrode 17a, via a transistor 12b connected to the scan signal line 16b. A storage capacitance Cha is formed between the pixel electrodes 17a, 17a′ and the scan signal line 16b; a storage capacitance Chb is formed between the pixel electrode 17b and the scan signal line 16b; a liquid crystal capacitance C1a is formed between the pixel electrode 17a and a common electrode “com”; and a liquid crystal capacitance C1b is formed between the pixel electrode 17b and the common electrode “com.”

In the liquid crystal panel 5b shown in FIG. 31, in the same manner as the liquid crystal panel in FIG. 28, a data signal line 15x is provided along the pixels 100, 101, and a data signal line 15x is provided along the pixels 103, 104.

Here, the scan signal line 16c is arranged at one edge of the pixel 100; the scan signal line 16d is arranged at the other edge thereof; and viewed planarly, the pixel electrodes 17c, 17d, 17c′ are arranged in a column direction between the scan signal lines 16c, 16d. In the same manner, the scan signal line 16c is arranged at one edge of the pixel 103; the scan signal line 16d is arranged at the other edge thereof; and viewed planarly, three pixel electrodes 17C, 17D, 17C′ are arranged in a column direction between the scan signal lines 16c, 16d.

Also, the scan signal line 16a is arranged at one edge of the pixel 101; the scan signal line 16b is arranged at the other edge thereof; and when observed in a plan view, the pixel electrodes 17a, 17b, 17a′ are aligned in the column direction between the scan signal lines 16a and 16b. In the same manner, the scan signal line 16a is arranged at one edge of the pixel 104; the scan signal line 16b is arranged at the other edge thereof; and when observed in a plan view, the pixel electrodes 17A, 17B, 17A′ are aligned in the column direction between the scan signal lines 16a and 16b.

In the pixel 101, a source electrode 8a and a drain electrode 9a of a transistor 12a are formed over the scan signal line 16a, while a source electrode 8b and a drain electrode 9b of a transistor 12b are formed over the scan signal line 16b. The source electrode 8a is connected to the data signal line 15x. The drain electrode 9a is connected to a drain lead-out wiring 27a; the drain lead-out wiring 27a is connected to a contact electrode 77a and a coupling capacitance electrode 37a; and the contact electrode 77a is connected to the pixel electrode 17a via a contact hole 11a. The coupling capacitance electrode 37a overlaps the pixel electrode 17b via an interlayer insulating film, thereby forming a coupling capacitance C101 (see FIG. 30) between the pixel electrodes 17a and 17b.

Also, the source electrode 8b of the transistor 12b is connected to a source lead-out wiring 28b; the source lead-out wiring 28b is connected to a contact electrode 77a′ and the coupling capacitance electrode 37a; and the contact electrode 77a′ is connected to the pixel electrode 17a′ via a contact hole 11a′. The drain electrode 9b is connected to a drain lead-out wiring 27b; the drain lead-out wiring 27b is connected to a contact electrode 77b; and the contact electrode 77b is connected to the pixel electrode 17b via a contact hole 11b.

Also, the source electrode 8b that is electrically connected to the pixel electrodes 17a and 17a′ is connected to a storage capacitance electrode 67a via the source lead-out wiring 28b; the storage capacitance electrode 67a overlaps the scan signal line 16b via a gate insulating film, thereby forming a storage capacitance Cha (see FIG. 30). Also, the drain electrode 9b that is electrically connected to the pixel electrode 17b is connected to a storage capacitance electrode 67b via the drain lead-out wiring 27b, and the storage capacitance electrode 67b overlaps the scan signal line 16b via a gate insulating film, thereby forming a storage capacitance Chb (see FIG. 30). Note that the configuration (geometry and alignment of each component and connection relation therebetween) of other pixels is the same as that of the pixel 101.

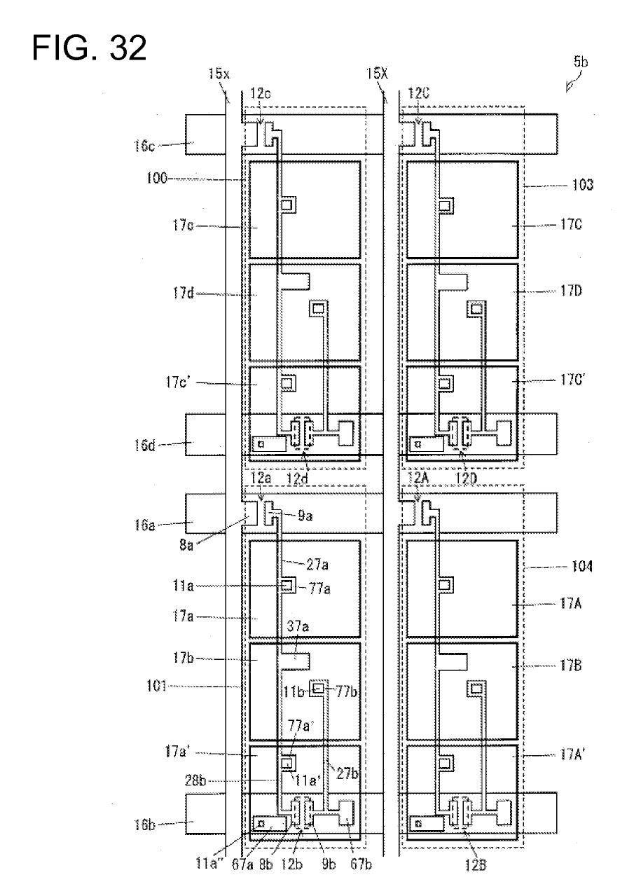

The above-mentioned storage capacitance Cha may also be formed in accordance with the configuration shown in FIG. 32. Specifically, as shown in FIG. 32, the storage capacitance electrode 67a, which is formed in the same layer as the storage capacitance electrode 37a, overlaps a storage capacitance wiring 18x via a gate insulating film and is also connected to the pixel electrode 17a′ via a contact hole 11a″, thereby forming a storage capacitance Cha.

In the configuration of the present specific example, subpixels including the pixel electrodes 17a, 17a′ are “bright” while the subpixel including the pixel electrode 17b is “dark.” An advantage of this configuration is that an electric charge is prevented from jumping from the scan signal lines to the pixel electrode 17b in the floating state.

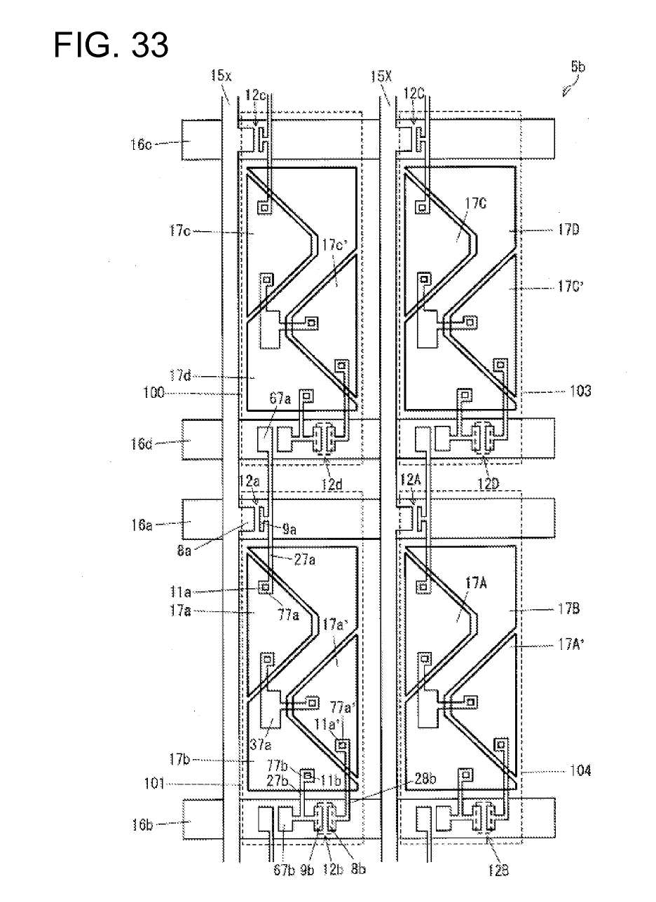

Also, the liquid crystal panel 5b shown in the present specific example 2-2 can alternatively be configured as shown in FIG. 33. Specifically, in a liquid crystal panel 5b shown in FIG. 33, the shapes of the pixel electrodes are different from those of pixel electrodes of the liquid crystal panel 5b shown in FIG. 32. In particular, in the pixel 101 for example, the pixel electrodes 17a, 17b, 17a′ are arranged respectively so that a portion of the pixel electrode 17a is adjacent to the scan signal line 16a; a portion of the pixel electrode 17a′ is adjacent to the scan signal line 16b; and one edge of the pixel electrode 17b is adjacent to the scan signal line 16a while the other edge thereof is adjacent to the scan signal line 16b. In other words, at least respective portions of the pixel electrodes 17a, 17a′ are arranged adjacent to the scan signal lines 16a, 16b, respectively, and the pixel electrode 17b is arranged so as to extend in the column direction to bridge the scan signal lines 16a, 16b. Here, because components in FIG. 33 that are given with reference characters identical to those shown in FIG. 32 possess identical functions, the description thereof is omitted herein.

According to the aforementioned configuration, subpixels including the pixel electrodes 17a, 17a′ are “bright” while the subpixel including the pixel electrode 17b is “dark.” With this configuration, it is possible to shorten each of lead-out wirings of the transistors 12a, 12b, as compared with the configuration shown in FIG. 32. Similarly, because the pixel electrodes 17a, 17a′ can be connected at a position close to each other via the coupling capacitance electrode 37a, it is also possible to shorten each of lead-out wirings of the coupling capacitance electrode 37a, as compared with the configuration shown in FIG. 32. As a result, in addition to an advantage that the occurrence of burn-in in the subpixels including the pixel electrode 17b can be prevented, this configuration provides additional advantages that the chance of breakage in the lead-out wirings can be reduced and that the aperture ratio can be improved

### Specific Example of Liquid Crystal Panel 2-3

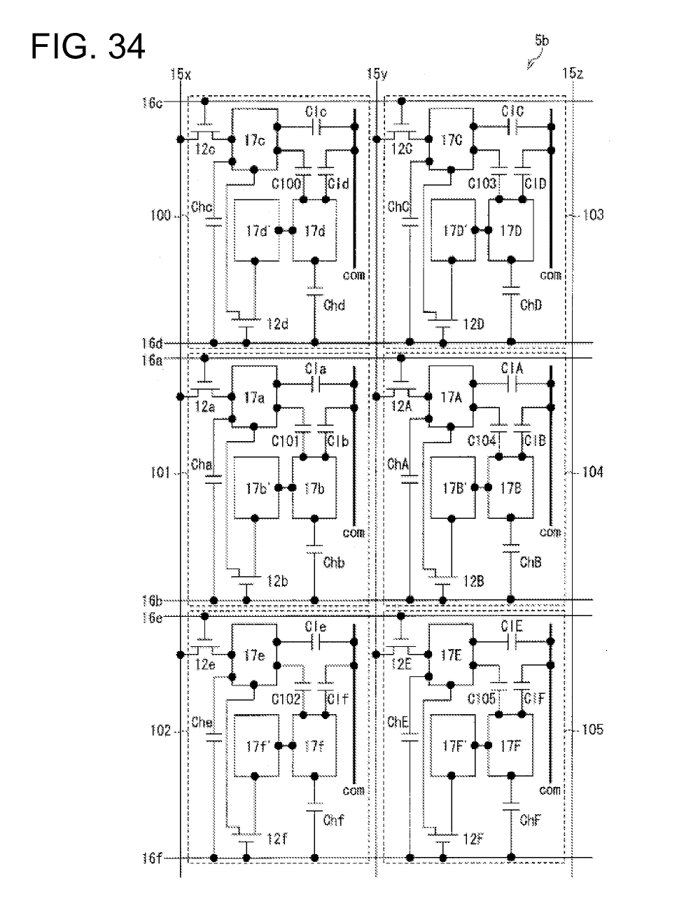

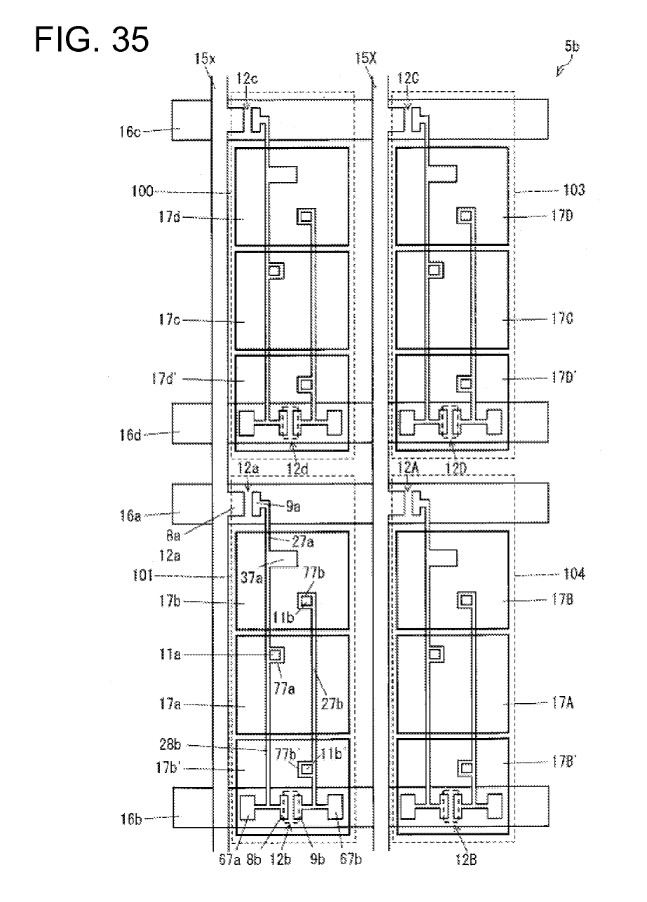

An equivalent circuit diagram for a specific example 2-3 of a liquid crystal panel 5b is shown in FIG. 34. The specific example 2-3 of the liquid crystal panel 5b is shown in FIG. 35.

As shown in FIG. 34, each pixel has an identical configuration, in which one data signal line and two scan signal lines are provided to each pixel. Three pixel electrodes 17d, 17c, 17d′ are provided in a pixel 100 (FIG. 34 shows a condition that the pixel electrodes 17d, 17d′ are electrically connected to each other); three pixel electrodes 17b, 17a, 17b′ are provided in a pixel 101, and three pixel electrodes 17f, 17e, 17f are provided in a pixel 102. Also, three pixel electrodes 17D, 17C, 17D′ are provided in a pixel 103; three pixel electrodes 17B, 17A, 17B′ are provided in a pixel 104; and three pixel electrodes 17F, 17E, 17F′ are provided in a pixel 105. The pixel electrodes 17d, 17D, the pixel electrodes 17c, 17C, the pixel electrodes 17d′, 17D′, the pixel electrodes 17b, 17B, the pixel electrodes 17a, 17A, the pixel electrodes 17b′, 17B′, the pixel electrodes 17f, 17F the pixel electrodes 17e, 17E, and the pixel electrodes 17f, 17F′ are adjacent to each other in the row direction, respectively.

Taking the pixel 101 as an example, in the pixel 101, the pixel electrodes 17a and 17b are connected to each other via a coupling capacitance C101; the pixel electrode 17a is connected to a data signal line 15x via a transistor 12a that is connected to a scan signal line 16a; the pixel electrodes 17b and 17b′ that are electrically connected to each other are capacitively coupled to the pixel electrode 17a, and are connected to the pixel electrode 17a via the transistor 12b connected to the scan signal line 16b; a storage capacitance Cha is formed between the pixel electrode 17a and the scan signal line 16b; a storage capacitance Chb is formed between the pixel electrodes 17b, 17b′ and the scan signal line 16b; a liquid crystal capacitance C1a is formed between the pixel electrode 17a and a common electrode “com”; and a liquid crystal capacitance C1b is formed between the pixel electrodes 17b, 17b′ and the common electrode “com.”

In the liquid crystal panel 5b shown in FIG. 35, in the same manner as the liquid crystal panel in FIG. 28, a data signal line 15x is provided so as to align along the pixels 100, 101, and a data signal line 15x is provided so as to align along the pixels 103, 104.

Here, a scan signal line 16c is arranged at one edge of the pixel 100; a scan signal line 16d is arranged at the other edge thereof; and viewed planarly, the pixel electrodes 17d, 17c, 17d′ are aligned in the column direction between the scan signal lines 16c, 16d. In the same manner, the scan signal line 16c is arranged at one edge of the pixel 103; the scan signal line 16d is arranged at the other edge thereof; and viewed planarly, pixel electrodes 17D, 17C, 17D′ are aligned in the column direction between the scan signal lines 16c, 16d.

Also, the scan signal line 16a is arranged at one edge of the pixel 101; the scan signal line 16b is arranged at the other edge thereof; and viewed planarly, the pixel electrodes 17b, 17a, 17b′ are aligned in the column direction between the scan signal lines 16a, 16b. In the same manner, the scan signal line 16a is arranged at one edge of the pixel 104; the scan signal line 16b is arranged at the other edge thereof; and viewed planarly, the pixel electrodes 17B, 17A, 17B′ are aligned in the column direction between the scan signal lines 16a, 16b.

In the pixel 101, a source electrode 8a and a drain electrode 9a of a transistor 12a are formed over the scan signal line 16a, while a source electrode 8b and a drain electrode 9b of a transistor 12b are formed over the scan signal line 16b. The source electrode 8a is connected to the data signal line 15x. The drain electrode 9a is connected to a drain lead-out wiring 27a; the drain lead-out wiring 27a is connected to a coupling capacitance electrode 37a and to a contact electrode 77a; and the contact electrode 77a is connected to the pixel electrode 17a via a contact hole 11a. The coupling capacitance electrode 37a overlaps the pixel electrode 17b via an interlayer insulating film, thereby forming a coupling capacitance C101 (see FIG. 34) between the pixel electrodes 17a and 17b.

Also, the source electrode 8b of the transistor 12b is connected to a source lead-out wiring 28b, and the source lead-out wiring 28b is connected to the contact electrode 77a. The drain electrode 9b is connected to a drain lead-out wiring 27b; the drain lead-out wiring 27b is connected to a contact electrode 77b; and the contact electrode 77b is connected to the pixel electrode 17b via a contact hole 11b. The drain lead-out wiring 27b is further connected to a contact electrode 77b′, and the contact electrode 77b′ is connected to the pixel electrode 17b′ via a contact hole 11b'.

Also, the source electrode 8b that is electrically connected to the pixel electrode 17a is connected to a storage capacitance electrode 67a via the source lead-out wiring 28b, and the storage capacitance electrode 67a overlaps the scan signal line 16b via a gate insulating film, thereby forming a storage capacitance Cha (see FIG. 34). Also, the drain electrode 9b that is electrically connected to the pixel electrodes 17b and 17b′ is connected to a storage capacitance electrode 67b via the drain lead-out wiring 27b, and the storage capacitance electrode 67b overlaps the scan signal line 16b via a gate insulating film, thereby forming a storage capacitance Chb (see FIG. 34). Note that the configuration (geometry and alignment of each component as well as connection relation therebetween) of other pixels is the same as that of the pixel 101.

According to the aforementioned configuration, the subpixel including the pixel electrode 17a is “bright” while the subpixels including the pixel electrodes 17b, 17b′ are “dark.” Therefore, the bright subpixels that belong to different pixels are not aligned adjacently to each other, which gives an advantage that a natural display is possible as compared with cases in which the bright subpixels that belong to different pixels are aligned adjacently to each other.

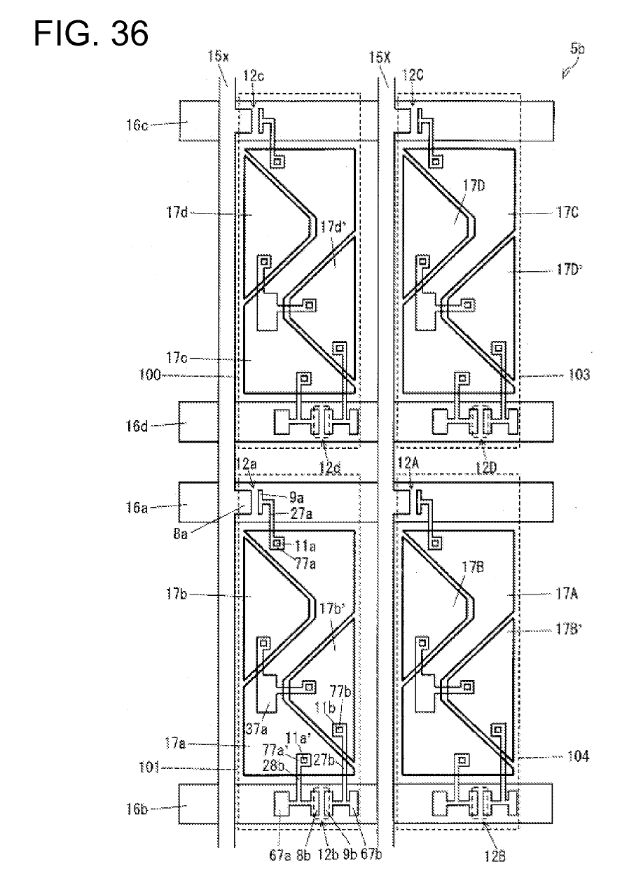

Also, the liquid crystal panel 5b shown in the present specific example 2-3 can alternatively be configured as shown in FIG. 36. Specifically, in a manner similar to that of the liquid crystal panel 5b shown in FIG. 33, the shapes of the pixel electrodes in the liquid crystal panel 5b shown in FIG. 36 are different from those of the pixel electrodes of the liquid crystal panel 5b shown in FIG. 35. In particular, taking the pixel 101 as an example, the pixel electrodes 17b, 17a, 17b′ are arranged respectively so that a portion of the pixel electrode 17b is adjacent to the scan signal line 16a; a portion of the pixel electrode 17b′ is adjacent to the scan signal line 16b; and one edge of the pixel electrode 17a is adjacent to the scan signal line 16a while the other edge thereof is adjacent to the scan signal line 16b. In other words, at least respective portions of the pixel electrodes 17b, 17b′ are arranged adjacent to the scan signal lines 16a, 16b, respectively, and the pixel electrode 17a is arranged so as to extend in the column direction to bridge the scan signal lines 16a, 16b. Here, because components in FIG. 36 that are given reference characters identical to those shown in FIG. 35 possess identical functions, the description thereof is omitted.

According to the aforementioned configuration, the subpixel including the pixel electrode 17a is “bright” while subpixels including the pixel electrodes 17b, 17b′ are “dark.” Similar to the configuration shown in FIG. 33, this configuration provides advantages that the possibility of breakage in lead-out wirings can be reduced and that the aperture ratio can be improved.

Here, regarding a liquid crystal display device having the liquid crystal panel 5b according to the present second embodiment, the driving methods discussed in the description of the aforementioned first embodiment (driving method 1, driving method 2, driving method 3, driving method 4) can be applied. That is, by applying these driving methods to a liquid crystal display device having a liquid crystal panel of the “Cs on gate” structure, the effects of these driving methods can be obtained.

### Third Embodiment

A liquid crystal panel 5c of the third embodiment has a configuration which is a combination of the above-described first and second embodiments, and has a “Cs on gate” structure equipped with storage capacitance wirings (18x to 18z). Exemplary configurations of the liquid crystal panel 5c can be realized by combinations of respective examples of the above-described first and second embodiments. As one of such examples, an example in which storage capacitance wirings are added to the liquid crystal panel 5b shown in FIG. 32 will be explained.

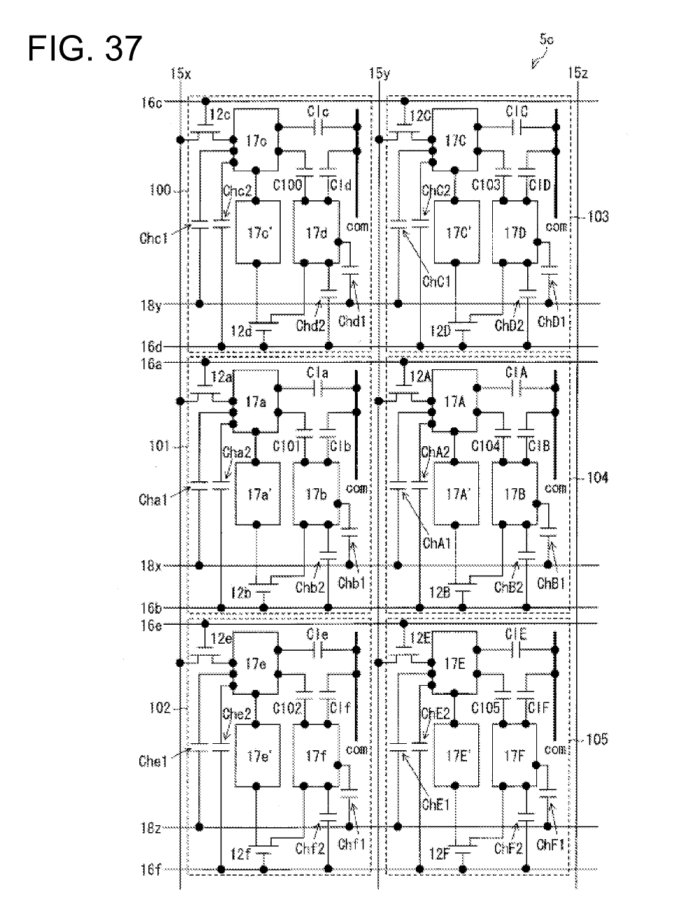

FIG. 37 is an equivalent circuit diagram showing a portion of the present liquid crystal panel 5c of the present third embodiment. As shown in FIG. 37, the liquid crystal panel 5c has data signal lines (15x, 15X) extending in the column direction (up-down direction in the diagram); scan signal lines (16a to 16f) extending in the row direction (left-right direction in the diagram); pixels (100 to 105) arranged in the directions of row and column; storage capacitance wirings (18x to 18z); and a common electrode (opposite electrode) “com.” Each pixel has an identical configuration. Also, a pixel column containing the pixels 100 to 102 and a pixel column containing the pixels 103 to 105 are disposed adjacent to each other.

In the liquid crystal panel 5c, one data signal line and two scan signal lines are provided to one pixel. Two pixel electrodes 17c, 17d, 17c′ provided in the pixel 100, two pixel electrodes 17a, 17b, 17a′ provided in the pixel 101, and two electrodes 17e, 17f, 17e′ provided in the pixel 102 are arranged in one column; two electrodes 17C, 17D, 17C′ provided in the pixel 103, two pixel electrodes 17A, 17B, 17A′ provided in the pixel 104, and two pixel electrodes 17E, 17F, 17E′ provided in the pixel 105 are arranged in one column; and the pixel electrodes 17c, 17C, the pixel electrodes 17d, 17D, the pixel electrodes 17c′, 17C′, the pixel electrodes 17a, 17A, the pixel electrodes 17b, 17B, the pixel electrodes 17a′, 17A′, the pixel electrodes 17e, 17E, the pixel electrodes 17f, 17F, and the pixel electrodes 17e′, 17E′ are arranged adjacent to each other in the row direction, respectively.

Because each pixel has an identical configuration, the following mainly describes the configuration of the pixel 101 as an example.

In the pixel 101, the pixel electrodes 17a, 17b are connected to each other via a coupling capacitance C101; the pixel electrode 17a is connected to the data signal line 15x via a transistor 12a connected to the scan signal line 16a; and pixel electrode 17b is connected to the pixel electrode 17a′ that is electrically connected to the pixel electrode 17a, via a transistor 12b that is connected to the scan signal line 16b. A storage capacitance Cha1 is formed between the pixel electrode 17a and the storage capacitance wiring 18x; a storage capacitance Cha2 is formed between the pixel electrode 17a and the scan signal line 16b; a storage capacitance Chb1 is formed between the pixel electrode 17b and the storage capacitance wiring 18x; a storage capacitance Chb2 is formed between the pixel electrode 17b and the scan signal line 16b; a liquid crystal capacitance C1a is formed between the pixel electrode 17a and a common electrode “com”; and a liquid crystal capacitance C1b is formed between the pixel electrode 17b and the common electrode “com.”

### Specific Example of Liquid Crystal Panel 3-1

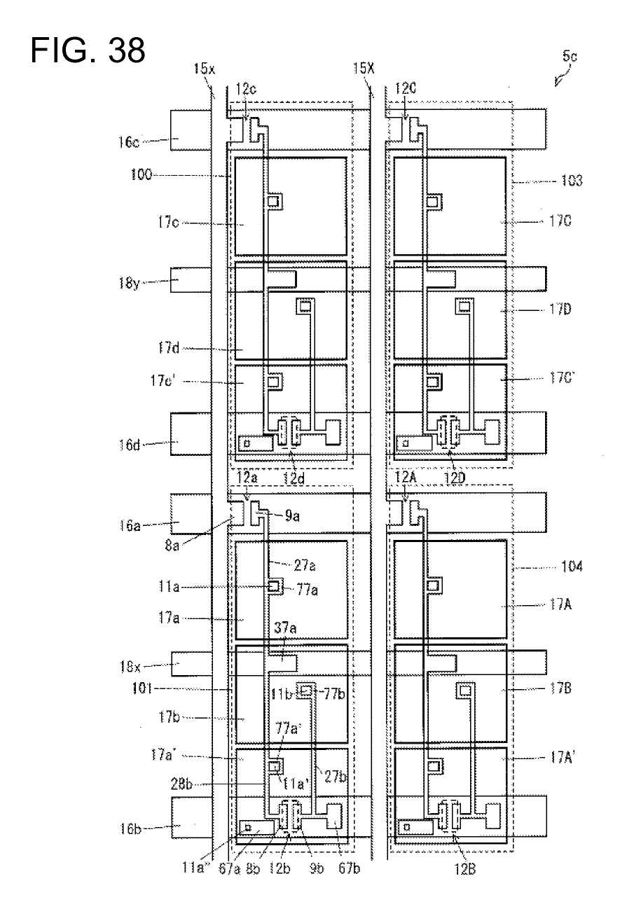

A specific example 3-1 of a liquid crystal panel 5c is shown in FIG. 38. In a liquid crystal panel 5c in FIG. 38, in the same manner as the liquid crystal panel shown in FIG. 32, a data signal line 15x is provided along pixel 100 and pixel 101; a data signal line 15x is provided along pixel 103 and pixel 104; a storage capacitance wiring 18y passes across pixels 100, 103, respectively; and a storage capacitance wiring 18x passes across pixels 101, 104, respectively.

Here, a scan signal line 16c is arranged at one edge of the pixel 100; a scan signal line 16d is arranged at the other edge thereof; and viewed planarly, pixel electrodes 17c, 17d, 17c′ are arranged in the column direction between the scan signal lines 16c, 16d. In the same manner, the scan signal line 16c is arranged at one edge of the pixel 103; the scan signal line 16d is arranged at the other edge thereof; and viewed planarly, pixel electrodes 17C, 17D, 17C′ are arranged in the column direction between the scan signal lines 16c and 16d.

Also, a scan signal line 16a is arranged at one edge of the pixel 101; a scan signal line 16b is arranged at the other edge thereof; and viewed planarly, pixel electrodes 17a, 17b, 17a′ are arranged in the column direction between the scan signal lines 16a and 16b. In the same manner, the scan signal line 16a is arranged at one edge of the pixel 104; the scan signal line 16b is arranged at the other edge thereof; and viewed planarly, pixel electrodes 17A, 17B, 17A′ are aligned in the column direction between the scan signal lines 16a and 16b.

In the pixel 101, a source electrode 8a and a drain electrode 9a of a transistor 12a are formed over the scan signal line 16a, while a source electrode 8b and a drain electrode 9b of a transistor 12b are formed over the scan signal line 16b. The source electrode 8a is connected to the data signal line 15x. The drain electrode 9a is connected to a drain lead-out wiring 27a; the drain lead-out wiring 27a is connected to a contact electrode 77a and a coupling capacitance electrode 37a; and the contact electrode 77a is connected to the pixel electrode 17a via a contact hole 11a. The coupling capacitance electrode 37a overlaps the pixel electrode 17b via an interlayer insulating film, thereby forming a coupling capacitance C101 between the pixel electrodes 17a, 17b (see FIG. 37).

Also, the source electrode 8b of the transistor 12b is connected to a source lead-out wiring 28b; the source lead-out wiring 28b is connected to a contact electrode 77a′ and the coupling capacitance electrode 37a; and the contact electrode 77a′ is connected to the pixel electrode 17a′ via a contact hole 11a′. The drain electrode 9b is connected to a drain lead-out wiring 27b; the drain lead-out wiring 27b is connected to a contact electrode 77b; and the contact electrode 77b is connected to the pixel electrode 17b via a contact hole 11b.

Also, a storage capacitance electrode 67a that is formed in the same layer as the coupling capacitance electrode 37a overlaps the scan signal line 16b via a gate insulating film and also is connected to the pixel electrode 17a′ via a contact hole 11a″, thereby forming a storage capacitance Cha2 (see FIG. 37). Also, the drain electrode 9b that is electrically connected to the pixel electrode 17b is connected to a storage capacitance electrode 67b via the drain lead-out wiring 27b, and the storage capacitance electrode 67b overlaps the scan signal line 16b via a gate insulating film, thereby forming a storage capacitance Chb2 (see FIG. 37).

Further, the coupling capacitance electrode 37a overlaps the storage capacitance wiring 18x via a gate insulating film, thereby forming a storage capacitance Cha1 (see FIG. 37), and also forming a storage capacitance Chb1 (see FIG. 37) between the pixel electrode 17b and the storage capacitance wiring 18x. Note that the configuration (geometry and alignment of each component and connection relation therebetween) of other pixels is identical to that of the pixel 101.

The configuration of the third embodiment, as described above, can be realized by combining the respective configurations discussed in the aforementioned descriptions of the first and second embodiments. Specifically, this is achieved by providing a storage capacitance wiring 18x in a lower layer under the coupling capacitance electrode 37a in the “Cs on gate” structure of the second embodiment.

Needless to say, regarding a liquid crystal display device including a liquid crystal panel 5c according to the present third embodiment, each of the driving methods discussed in the description of the aforementioned first embodiment (driving method 1, driving method 2, driving method 3, driving method 4) can be applied.

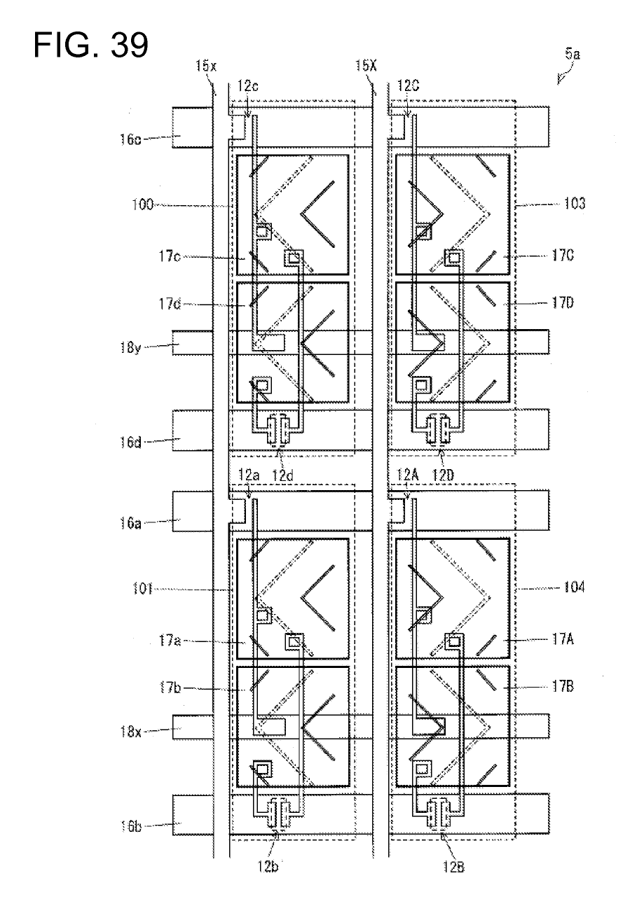

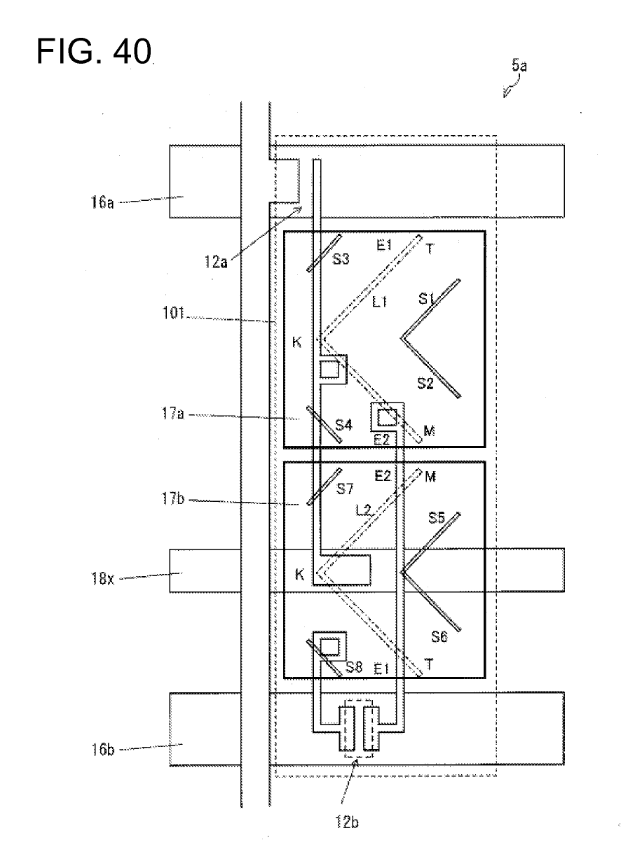

The liquid crystal panels 5a, 5b, 5c of the first, second, and third embodiments may also be combined with a known configuration, such as the MVA (Multidomain Vertical Alignment) structure, for example, as shown in FIG. 39. FIG. 39 shows a configuration in which the liquid crystal panel 5a shown in FIG. 2 is modified to have an MVA structure. Here, while the present liquid crystal panel 5a includes an active matrix substrate, a liquid crystal layer, and a color filter substrate, the liquid crystal layer is not shown in FIG. 39, and only the ribs of the color filter substrate thereof is shown therein. FIG. 40 is a plan view that shows an enlarged portion of FIG. 39. The following description uses a pixel 101 as an example.

As shown in FIG. 40, the pixel 101 includes a subpixel including a pixel electrode 17a (hereinafter referred to as a first subpixel) and also includes a subpixel including a pixel electrode 17b (hereinafter referred to as a second subpixel). The first subpixel is provided with a first alignment control structure, which includes a first rib L1 and slits (pixel electrode slits) S1 to S4. The second subpixel is provided with a second alignment control structure, which includes a second rib L2 and slits (pixel electrode slits) S5 to S8.

In the pixel 101, the first subpixel, which is located on the side of a scan signal line 16a, possesses an edge E1 that lies along the scan signal line 16a and an opposing edge E2; and the second subpixel, which is located on the side of a scan signal line 16b, possesses an edge E1 that lies along the scan signal line 16b and an opposing edge E2. Here, at a portion of the color filter substrate corresponding to the first subpixel, the first rib L1, which forms a V-shape when viewed in the row direction (left-right direction in the diagram), is provided so that a beginning edge T is located at the edge E1 and an ending edge M is located at the edge E2. Also, at a portion of the color filter substrate corresponding to the second subpixel, the second rib L2, which forms a V-shape when viewed in the row direction (left-right direction in the diagram), is provided so that a beginning edge T is located at the edge E1 and an ending edge M is located at the edge E2. In other words, the orientations of the first rib L1 and that of the second rib L2 are the same.

Further, in the pixel electrode 17a, a plurality of slits S1 to S4 are provided in correspondence with the first rib L1, while in the pixel electrode 17b, a plurality of slits S5 to S8 are provided in correspondence with the second rib L2. Here, the slits S1, S3 are provided on respective sides of a section of the first rib L1 between the beginning edge T and a bend K so as to be approximately in parallel with that section; the slits S2, S4 are provided on respective sides of a section of the first rib L1 between the bend K and the ending edge M so as to be approximately in parallel with that section; the slits S6, S8 are provided on respective sides of a section of the second rib L2 between the beginning edge T and a bend K so as to be approximately in parallel with that section; and the slits S5, S7 are provided on respective sides of a section of the second rib L2 between the bend K and the ending edge M so as to be approximately in parallel with that section. As a result, the geometry of the slits S5 to S8 and arrangement positions thereof respect to the second rib L2 are the same as the geometry of the slits S1 to S4 and the arrangement positions thereof with respect to the first rib L1. Here, in each of the first and second ribs L1, L2, an angle formed by the beginning edge T, the bend K, and the ending edge M (∠TKM) is approximately 90 degrees.

As described above, the slit S1, one side (section TK) of the first rib L1, and the slit S3 are parallel to each other and extend diagonally with respect to the scan signal line 16a (forming an angle of approximately −135°); the slit S2, one side (section KM) of the first rib L1, and the slit S4 are parallel to each other and extend diagonally respect to the scan signal line 16a (forming an angle of approximately −45°); and a portion of the one side (section TK) of the first rib L1 and a portion of the slit S3 are located at the edge E1 of the first subpixel (a section lying along the scan signal line 16a). Meanwhile, the slit S6, one side (section TK) of the second rib L2, and the slit S8 are parallel to each other and extend diagonally with respect to the scan signal line 16b (forming an angle of 135°); the slit S5, one side (section KM) of the second rib L2, and the slit S7 are parallel to each other and extend diagonally with respect to the scan signal line 16b (forming an angle of 45°); and a portion of the one side (section TK) of the second rib L2 and a portion of the slit S8 are located at the edge E1 of the second subpixel (a section lying along the scan signal line 16b).

According to the liquid crystal display device using the present liquid crystal panel 5a, an advantage of a wider viewing range can be realized. Also, in the present liquid crystal panel 5a, as shown in FIG. 39, the orientation of the ribs L1, L2 is set to be opposite between two pixels that are adjacent in the column direction (for example, the pixels 101, 104), thereby eliminating the influence of alignment disorder caused by a bias towards a certain alignment area. As a result, a liquid crystal display device with superior viewing angle characteristics can be realized.

Here, the present liquid crystal panel shows an example in which the ribs are provided to the color filter substrate. However, the configuration does not have to be limited thereto, and slits may be provided instead of the ribs on the color filter substrate.

(Configurations of Liquid Crystal Display Unit and Liquid Crystal Display Device)

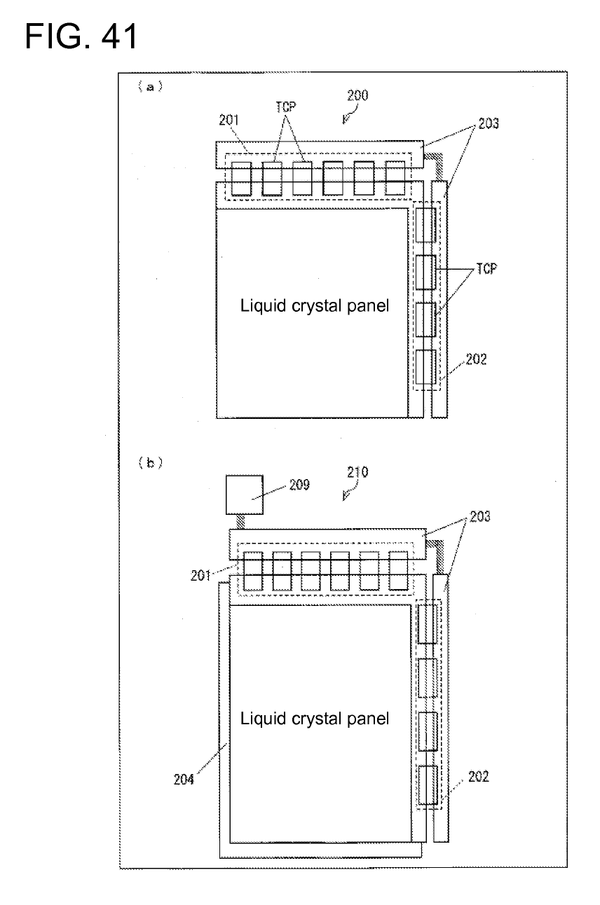

Lastly, configuration examples of a liquid crystal display unit and a liquid crystal display device of the present invention are described in the following. According to each of the above-described embodiments, the present liquid crystal display unit and liquid crystal display device are configured as follows. That is, two polarizers A, B are attached to respective sides of liquid crystal panel 5a, 5b, 5c so that the polarizing axis of the polarizer A and that of the polarizer B are perpendicular to each other. Here, an optical compensation sheet and or the like may be laminated on the polarizer, if necessary. Next, as shown in FIG. 41(a), drivers (gate driver 202, source driver 201) are connected. Here, as one example, a connection of drivers using a TCP (Tape Career Package) method is described as follows. First, an ACF (Anisotropic Conductive Film) is temporarily attached by pressure to terminals of the liquid crystal panel. Next, TCPs on which the drivers are mounted are cut out from a carrier tape, aligned to the panel terminal electrodes, heated, and are permanently bonded by pressure. After that, circuit substrates 209 (PWB (Printed Wiring Board)) for linking the driver TCPs are connected to input terminals of the TCPs via ACF. As a result, a liquid crystal display unit 200 is completed. After that, as shown in FIG. 41(b), a display control circuit 209 is connected to each of the drivers (201, 202) of the liquid crystal display unit via the circuit substrate 203 and is combined with a lighting device (backlight unit) 204 to construct a liquid crystal display device 210.

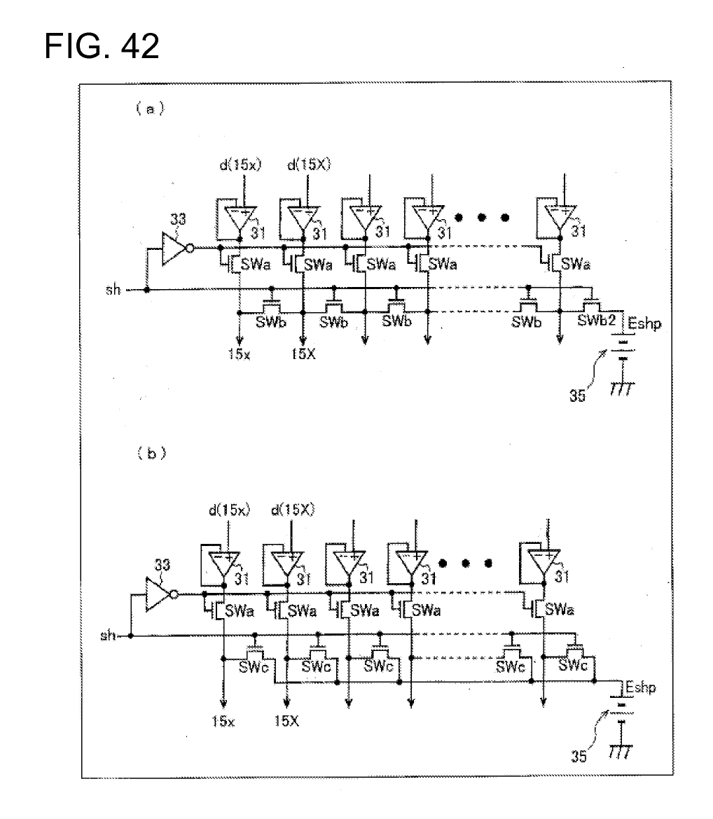

FIG. 42(a) shows a configuration of a source driver in case that a refreshing period is provided for the present liquid crystal display device. As shown in FIG. 42(a), the source driver in this case is equipped with a buffer 31, a data output switch SWa, and a refresh switch SWb for each data signal line. Corresponding data d is inputted to the buffer 31, and an output from the buffer 31 is connected to an output terminal for a data signal line via the data output switch SWa. Also, the output terminals that correspond respectively to two adjacent data signal lines are connected to each other via the refresh switch SWb. In other words, each of the refresh switches Swb is connected in series, and one end thereof is connected to a refresh potential supply source 35 (Vcom). Here, to the gate terminal of the data output switch SWa, a charge-sharing signal sh is inputted via an inverter 33, and the charge-sharing signal sh is inputted to a gate terminal of the refresh switch SWb.

Here, the source driver shown in FIG. 42(a) may alternatively be configured as shown in FIG. 42(b). Specifically, in this configuration, a refresh switch SWc is connected only to a corresponding data signal line and a refresh potential supply source 35 (Vcom), thereby not connecting the refresh switches SWc in series. As a result, it becomes possible to supply a refresh potential quickly to each data signal line.

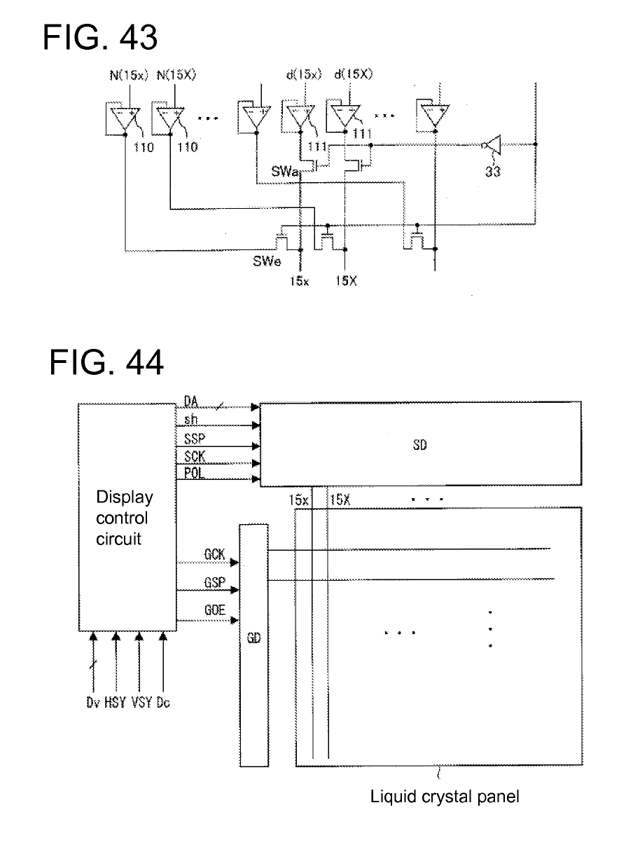

Here, according to the above-described configuration of the source driver, the refresh potential is designated as Vcom. But the present invention is not limited to such an example. For example, an appropriate refresh potential for a given data signal line may be calculated according to the level of a signal potential supplied to that data signal line during one previous horizontal scanning period and also according to a signal potential to be supplied to that data signal line during the current horizontal scanning period. The calculated refresh potential then is supplied to that data signal line. A configuration of the source driver in such a case is shown in FIG. 43. According to this configuration, for each data signal line, a data output buffer 110, a refresh buffer 111, a data output switch SWa, and a refresh switch SWe are provided. To the data output buffer 110, corresponding data d is inputted, and an output from the data output buffer 110 is connected to an output terminal for the data signal line via the data output switch SWa. To the refresh buffer 111, corresponding non-image data N (data corresponding to an appropriate refresh potential that is determined according to the level of a signal potential supplied during one preceding horizontal scanning period and also according to a signal potential to be supplied during the current horizontal scanning period) is inputted. An output from the refresh buffer 111 is connected to the output terminal for the data signal line via the refresh switch SWe.

The expression “polarity of a potential” in the present invention indicates high (positive) or low (negative) relative to a reference potential. Here, the reference potential may be Vcom (common potential), which is a potential of a common electrode (the opposite electrode), or any other potential that may arbitrarily be selected.

FIG. 44 is a block diagram showing a configuration of the present liquid crystal display device. As shown in the diagram, the present liquid crystal display device is equipped with a display unit (liquid crystal panel), a source driver (SD), a gate driver (GD), and a display control circuit. The source driver drives data signal lines; the gate driver drives scan signal lines; and the display control circuit controls the source driver and the gate driver.

The display control circuit receives from an outside signal source (for example, a tuner) a digital video signal Dv expressing an image that should be displayed; horizontal and vertical synchronizing signals HSY and VSY for the digital video signal Dv; and a control signal Dc for controlling display operations. Also, based on the received signals Dv, HSY, VSY, Dc, the display control circuit generates and outputs a data start pulse signal SSP, a data clock signal SCK, a charge-sharing signal sh, a digital image signal DA expressing an image to be displayed (a signal corresponding to the video signal Dv), a gate start pulse signal GSP, a gate clock signal GCK, and a gate driver output control signal (scan signal output control signal) GOE, as the signals instructing the display unit to display the image expressed by the digital video signal Dv.

More specifically, after performing, if necessary, a timing adjustment on the video signal Dv using an internal memory, the display control circuit outputs the digital image signal DA; generates the data clock signal SCK as a signal that is composed of pulses corresponding to respective pixels of the image expressed by the digital image signal DA; generates the data start pulse signal SSP as a signal that becomes high (level H) only for a predetermined period during every one horizontal scanning period based on the horizontal synchronizing signal HSY; generates the gate start pulse signal GSP as a signal that becomes high (level H) only for a predetermined period during every one frame period (every one vertical scanning period) based on the vertical synchronizing signal VSY; generates the gate clock signal GCK based on the horizontal synchronizing signal HSY; and generates the charge-sharing signal sh and the gate driver output control signal GOE based on the horizontal synchronizing signal HSY and the control signal Dc.

Of the signals generated by the display control circuit as describe above, the digital image signal DA, the charge-sharing signal sh, a signal POL that controls the polarity of a signal potential (data signal potential), the data start pulse signal SSP, and the data clock signal SCK are inputted to the source driver; while the gate start pulse signal GSP, the gate clock signal GCK, and the gate driver output control signal GOE are inputted to the gate driver.

Based on the digital image signal DA, the data clock signal SCK, the charge-sharing signal sh, the data start pulse signal SSP, and the polarity reversing signal POL, the source driver sequentially generates analogue potentials (signal potential) that correspond to pixel values on each scan signal line of the image expressed by the digital image signal DA in every horizontal scanning period, and outputs the resultant data signals to the data signal lines (such as 15x, 15X).

Based on the gate start pulse signal GSP, the gate clock signal GCK, and the gate driver output control signal GOE, the gate driver generates gate-on pulse signals and outputs the gate-on pulse signals to the scan signal lines, thereby selectively driving the scan signal lines.

As the source driver and the gate driver drive the data signal lines and the scan signal lines of the display (liquid crystal panel) as described above, the signal potentials are written from the data signal lines to the respective pixel electrode via the transistors (TFTs) connected to the selected scan signal line. As a result, a voltage is applied to the liquid crystal layer of each subpixel, thereby controlling the amount of light transmission from the backlight to display the image indicated by the digital video signal Dv on each subpixel.

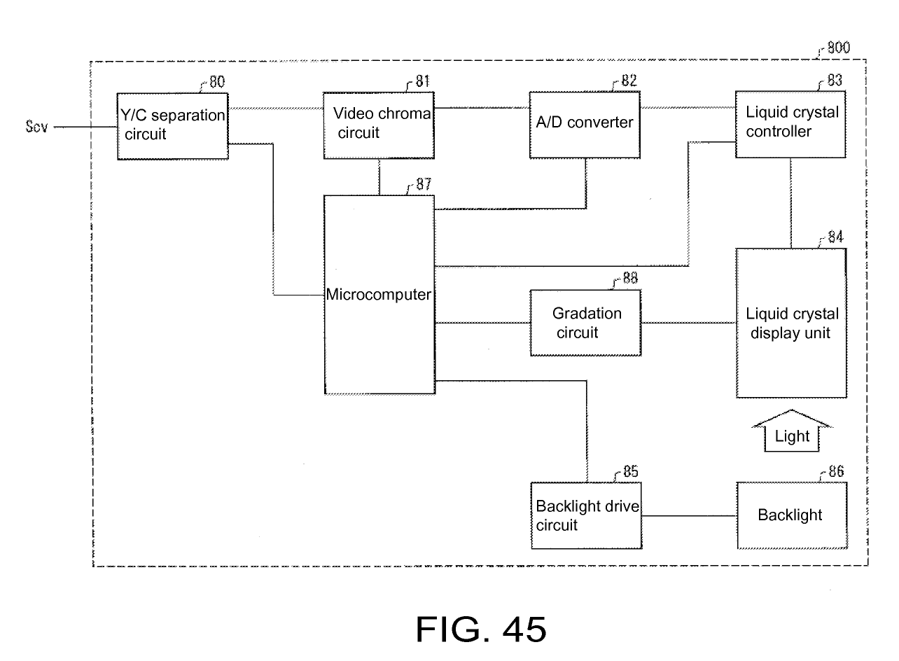

Next, one configuration example of the present liquid crystal display device that is applied to a television receiver is described as follows. FIG. 45 is a block diagram showing a configuration of a liquid crystal display device 800 for a television receiver. The liquid crystal display device 800 is equipped with a liquid crystal display unit 84, a Y/C separation circuit 80, a video chroma circuit 81, an A/D converter 82, a liquid crystal controller 83, a backlight drive circuit 85, a backlight 86, a microcomputer 87, and a gradation circuit 88. Here, the liquid crystal display unit 84 is composed of a liquid crystal panel as well as a source driver and a gate driver for driving the liquid crystal panel.

First, in the liquid crystal display device 800 according to the above-described configuration, a multi-color image signal Scv as a television signal is inputted from outside to the Y/C separation circuit 80 and is separated into a luminance signal and a color signal. The luminance signal and the color signal are converted via the video chroma circuit 81 into analogue RGB signals that correspond to three primary colors of light. These analogue RGB signals are further converted via the A/D converter 82 into digital RGB signals. These digital RGB signals are inputted to the liquid crystal controller 83. At the Y/C separation circuit 80, horizontal and vertical synchronizing signals are also extracted from the multi-color image signal Scv inputted from outside and are inputted into the liquid crystal controller 83 via the microcomputer 87.

The digital RGB signals from the liquid crystal controller 83 are inputted to the liquid crystal display unit 84 at a predetermined timing along with a timing signal determined by the above-mentioned synchronizing signals. Also, in the gradation circuit 88, a gradation potential is generated respectively for each of three primary colors R, G, B, for color display and is supplied to the liquid crystal display unit 84. In the liquid crystal display unit 84, driving signals (data signal (signal potential), scan signal, and such) are generated by the internal source and gate drivers and the like in accordance with the aforementioned RGB signals, the timing signals and the gradation potentials. According to these driving signals, a color image is displayed on the internal liquid crystal panel. Here, to display an image using this liquid crystal display unit 84, it is necessary to radiate light from behind the liquid crystal panel of the liquid crystal display unit. In this liquid crystal display device 800, the backlight drive circuit 85 drives the backlight 86 under the control of the microcomputer 87 to radiate light to the back side of the liquid crystal panel. The microcomputer 87 controls the entire system, including the above-described processes. Here, image signals (multi-color image signals) inputted from outside are not limited to image signals based on the television broadcasting, but can be image signals captured by cameras or supplied via the Internet. This liquid crystal display device 800 is capable of displaying images based on various image signals.

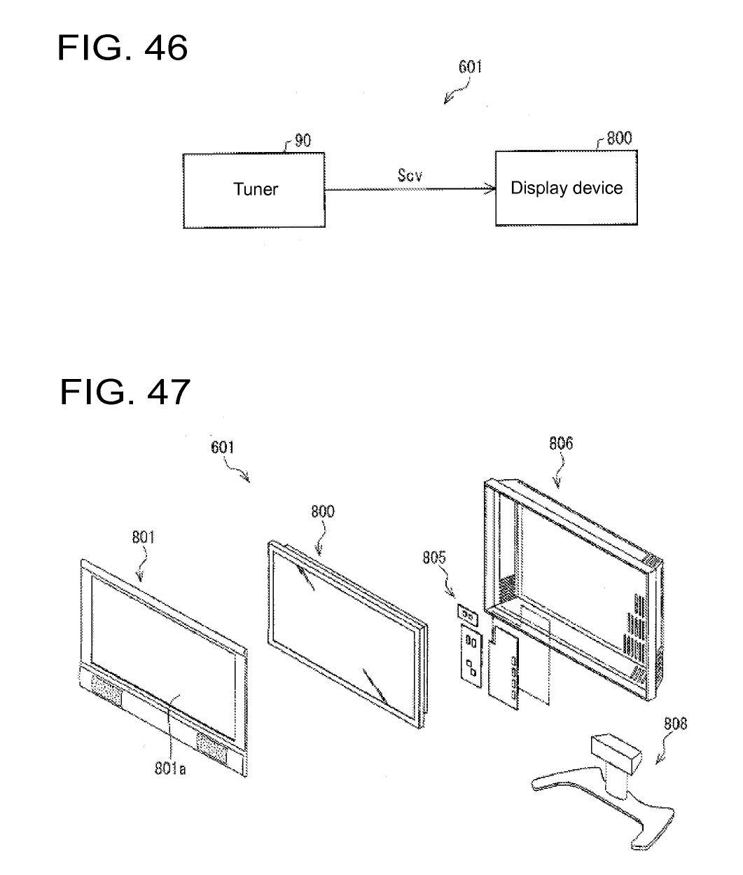

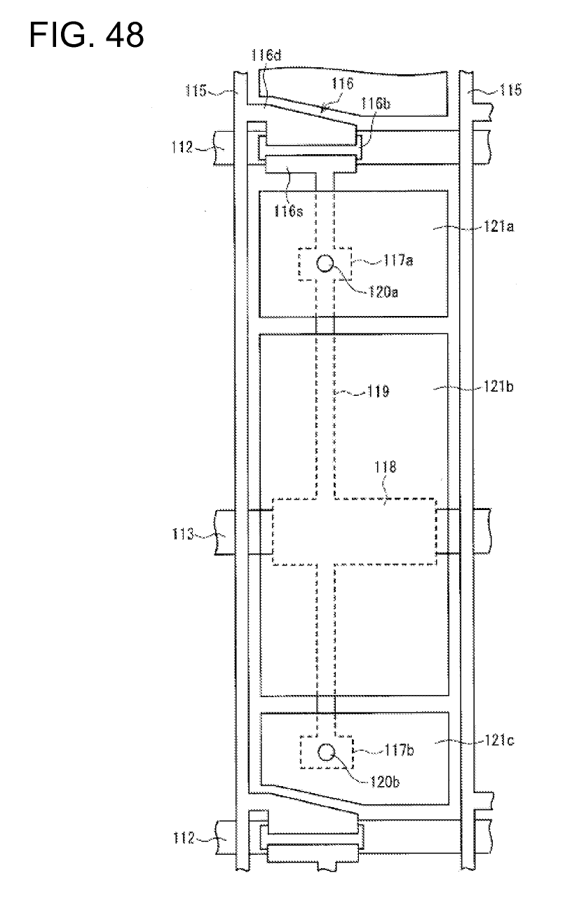

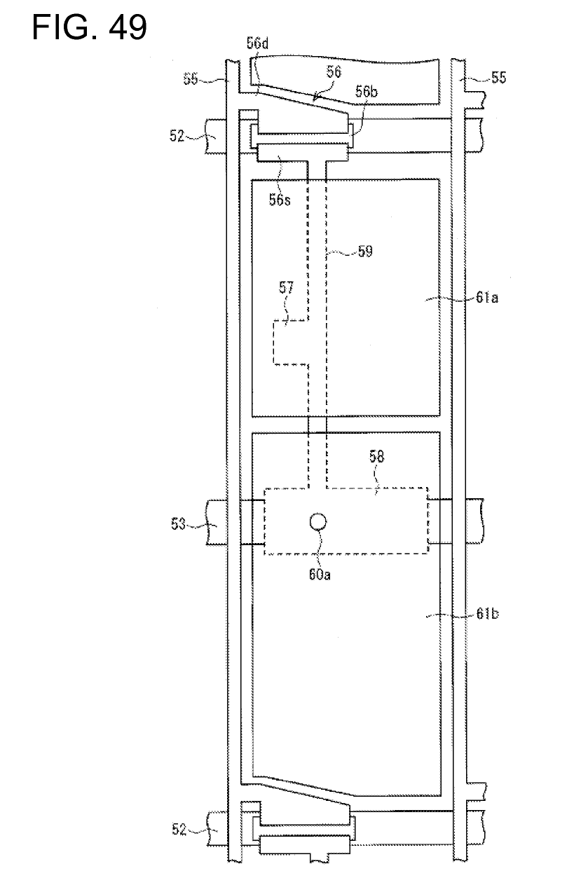

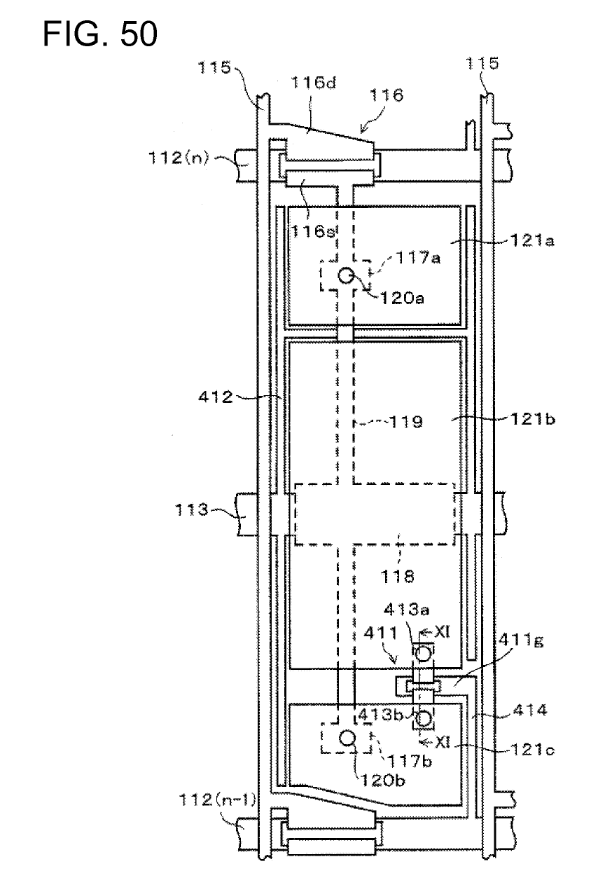

When displaying an image by the liquid crystal display device 800 based on the television broadcasting, a tuner 90 is connected to the liquid crystal display device 800 as shown in FIG. 46, thereby constructing the present television receiver 601. The tuner 90 extracts signals for a channel that should be received from reception waves (high frequency signals) received by an antenna (not shown); converts the extracted signals to intermediate frequency signals; and extracts multi-color image signals Scv as television signals by detection through the intermediate frequency signals. The multi-color image signals Scv are inputted to the liquid crystal display device 800, as already explained, and an image based on these multi-color image signals Scv is displayed by the liquid crystal display device 800.

FIG. 47 is an exploded perspective view showing one configuration example of the present television receiver. As shown in the figure, the present television receiver 601 possesses a first case 801 and a second case 806 in addition to the liquid crystal display device 800 as its components and is configured such that the liquid crystal display device 800 is sandwiched between, and is enclosed in, the first and second cases 801, 806. In the first case 801, an aperture 801a is formed to transmit an image displayed by the liquid crystal display device 800. Also, the second case 806 is provided to cover the back side of the liquid crystal display device 800 and is provided with an operation circuit 805 for operating the display device 800 and with a supporter 808 attached to the bottom thereof.

The present invention is not limited to the above-described embodiments, but includes various other embodiments, which may be obtained by modifying the above-described embodiments based on common technical knowledge or by combining any of such modifications.

### INDUSTRIAL APPLICABILITY

A liquid crystal panel and a liquid crystal display device of the present invention are particularly suitable for a liquid crystal television, for example.

### DESCRIPTION OF REFERENCE CHARACTERS

5a, 5b, 5c liquid crystal panel
8a, 8b source electrode
9a, 9b drain electrode
12a to 12f, 12A to 12F transistor
15x, 15x data signal line
16a to 16f scan signal line
17a to 17f pixel electrode
17A to 17F pixel electrode
17a′ to 17f′ pixel electrode
17A′ to 17F′ pixel electrode
18x to 18z storage capacitance wiring
21 organic gate insulating film
22 inorganic gate insulating film
24 semiconductor layer
25 inorganic interlayer insulating film
26 organic interlayer insulating film
27a, 27b drain lead-out wiring
27a′ extended coupling capacitance electrode
28b source lead-out wiring
37a coupling capacitance electrode
67b storage capacitance electrode
11a, 11a′, 11a″, 11b, 11b′ contact hole
77a, 77a′, 77b, 77b′ contact electrode
84 liquid crystal display unit
100 to 105 pixel
200, 210 liquid crystal display unit
601 television receiver
800 liquid crystal display device
C100 to C105 coupling capacitance

1. An active matrix substrate comprising:
a data signal line;
a first scan signal line and a second scan signal line;
a first transistor connected to the data signal line and to the first scan signal line;
a second transistor connected to the second scan signal line; and
first and second pixel electrodes formed in a pixel area, the first pixel electrode being connected to the data signal line via the first transistor, the second pixel electrode being connected to the first pixel electrode via a capacitance, the second pixel electrode being electrically connected to the first pixel electrode via the second transistor.

2. The active matrix substrate according to claim 1, further comprising:
a third pixel electrode formed in the pixel area, the third pixel electrode being electrically connected to the first pixel electrode.

3. The active matrix substrate according to claim 1, further comprising:
a third pixel electrode formed in the pixel area, the third pixel electrode being connected to the first pixel electrode via a capacitance, the third pixel electrode being electrically connected to the second pixel electrode.

4. The active matrix substrate according to claim 1, wherein a storage capacitance is formed between the first pixel electrode and the second scan signal line.

5. The active matrix substrate according to claim 4, wherein a storage capacitance is further formed between the second pixel electrode and the second scan signal line.

6. The active matrix substrate according to claim 1, further comprising a storage capacitance wiring, the storage capacitance wiring forming a storage capacitance with the first pixel electrode.

7. The active matrix substrate according to claim 6, wherein the storage capacitance wiring further forms a storage capacitance with the second pixel electrode.

8. The active matrix substrate according to claim 7, further comprising a storage capacitance electrode formed in the same layer as conductive electrodes of the first transistor and the second transistor, the storage capacitance electrode being electrically connected to one of the first pixel electrode and the second pixel electrode, the storage capacitance electrode overlapping the storage capacitance wiring via a gate insulating film.

9. The active matrix substrate according to claim 7, further comprising a coupling capacitance electrode formed in the same layer as conductive electrodes of the first transistor and the second transistor, the coupling capacitance electrode being electrically connected to one of the first pixel electrode and the second pixel electrode, the coupling capacitance electrode overlapping the other one of the first pixel electrode and the second pixel electrode via an interlayer insulating film, the coupling capacitance electrode overlapping the storage capacitance wiring via a gate insulating film.

10. The active matrix substrate according to claim 2, further comprising:
a storage capacitance wiring,
wherein the pixel area is divided into two sections by the storage capacitance wiring crossing the pixel area, the first pixel electrode is arranged at one of the two sections while the third pixel electrode is arranged at the other thereof, and the second pixel electrode is arranged between the first pixel electrode and the third pixel electrode.

11. The active matrix substrate according to claim 3, further comprising a storage capacitance wiring,
wherein the pixel area is divided into two sections by the storage capacitance wiring crossing the pixel area, the second pixel electrode is arrange at one of the two sections, the third pixel electrode is arranged at the other thereof, and the first pixel electrode is arranged between the second pixel electrode and the third pixel electrode.

12. The active matrix substrate according to claim 2, wherein the first pixel electrode, the second pixel electrode, and the third pixel electrode are arranged such that at least a portion of the first pixel electrode lies adjacent to the first scan signal line, such that at least a portion of the third pixel electrode lies adjacent to the second scan signal line, and such that one edge of the second pixel electrode lies adjacent to the first scan signal line while the other edge thereof lies adjacent to the second scan signal line.

13. The active matrix substrate according to claim 3, wherein the first pixel electrode, the second pixel electrode, and the third pixel electrode are arranged such that at least a portion of the second pixel electrode lies adjacent to the first scan signal line, such that at least a portion of the third pixel electrode lies adjacent to the second scan signal line, and such that one edge of the first pixel electrode lies adjacent to the first scan signal line while the other edge thereof lies adjacent to the second scan signal line.

14. The active matrix substrate according to claim 1, further comprising:
a coupling capacitance electrode overlapping the second pixel electrode via an interlayer insulating film,
wherein a first lead-out wiring led out from a conductive electrode of the first transistor and the coupling capacitance electrode are connected to each other in a same layer, and the first lead-out wiring and the first pixel electrode are connected to each other via a contact hole,
wherein a second lead-out wiring led out from one conductive electrode of the second transistor is connected to the second pixel electrode via a contact hole, and a third lead-out wiring led out from another conductive electrode of the second transistor is connected to the first pixel electrode via a contact hole.

15. The active matrix substrate according to claim 1, further comprising:
a coupling capacitance electrode overlapping the second pixel electrode via an interlayer insulating film,
wherein a first lead-out wiring led out from a conductive electrode of the first transistor and the coupling capacitance electrode are connected to each other in a same layer, and the first lead-out wiring and the first pixel electrode are connected to each other via a contact hole,
wherein a second lead-out wiring led out from one conductive electrode of the second transistor is connected to the second pixel electrode via a contact hole, and an extended coupling capacitance electrode connected to the coupling capacitance electrode is connected to another conductive electrode of the second transistor.

16. The active matrix substrate according to claim 2, further comprising:
a coupling capacitance electrode overlapping the second pixel electrode via an interlayer insulating film,
wherein a first lead-out wiring led out from a conductive electrode of the first transistor and the coupling capacitance electrode are connected to each other in a same layer, and the first lead-out wiring and the first pixel electrode are connected to each other via a contact hole,
wherein a second lead-out wiring led out from one conductive electrode of the second transistor is connected to the second pixel electrode via a contact hole, and
wherein a third lead-out wiring led out from another conductive electrode of the second transistor is connected to the coupling capacitance electrode in a same layer, and the third lead-out wiring is connected to the third pixel electrode via a contact hole.

17. The active matrix substrate according to claim 2, comprising:
a coupling capacitance electrode overlapping the second pixel electrode via an interlayer insulating film,
wherein a first lead-out wiring led out from a conductive electrode of the first transistor and the coupling capacitance electrode are connected to each other in a same layer, and the first lead-out wiring and the first pixel electrode are connected to each other via a contact hole,
wherein a second lead-out wiring led out from one conductive electrode of the second transistor is connected to the second pixel electrode via a contact hole,
wherein a third lead-out wiring led out from another conductive electrode of the second transistor is connected to the first pixel electrode via a contact hole, and a third lead-out wiring is connected to the third pixel electrode via a contact hole.

18. The active matrix substrate according to claim 3, comprising:
a coupling capacitance electrode overlapping the second pixel electrode via an interlayer insulating film,
wherein a first lead-out wiring led out from a conductive electrode of the first transistor and the coupling capacitance electrode are connected to each other in a same layer, and the first lead-out wiring and the first pixel electrode are connected via a contact hole,
wherein a second lead-out wiring led out from one conductive electrode of the second transistor is connected to the second pixel electrode via a contact hole, and the second lead-out wiring and the third pixel electrode are connected to each other via a contact hole, and
wherein a third lead-out wiring led out from another conductive electrode of the second transistor is connected to the first pixel electrode via a contact hole.

19. The active matrix substrate according to claim 9, wherein at least a portion of a section of the interlayer insulating film overlapping the coupling capacitance electrode is thinned.

20. The active matrix substrate according to claim 8, wherein at least a portion of a section of the gate insulating film overlapping the storage capacitance electrode is thinned.

21. The active matrix substrate according to claim 19, wherein the interlayer insulating film is composed of an inorganic insulating film and an organic insulating film, and the organic insulating film is removed from at least a portion of a section of the interlayer insulating film overlapping the coupling capacitance electrode.

22. The active matrix substrate according to claim 20, wherein the gate insulating film is composed of an inorganic insulating film and an organic insulating film, and an organic insulating film is removed from at least a portion of a section of the gate insulating film overlapping the storage capacitance electrode.

23. The active matrix substrate according to claim 21, wherein the organic insulating film contains at least one of acrylic resin, epoxy resin, polyimide resin, polyurethane resin, novolak resin, and siloxane resin.

24. The active matrix substrate according to claim 1, wherein when applied to a liquid crystal display device, a subpixel including the first pixel electrode becomes a bright subpixel, and a subpixel including the second pixel electrode becomes a dark subpixel.

25. The active matrix substrate according to claim 2, wherein when applied to a liquid crystal display device, subpixels including the first pixel electrode and the third pixel electrode become bright subpixels, and a subpixel including the second pixel electrode becomes a dark subpixel.

26. The active matrix substrate according to claim 3, wherein when applied to a liquid crystal display device, a subpixel including the first pixel electrode becomes a bright subpixel, and subpixels including the second pixel electrode and the third pixel electrode become dark subpixels.

27. The active matrix substrate according to claim 1, wherein a storage capacitance is formed between at least one of the first pixel electrode and the second pixel electrode provided in a pixel area of a current row and at least one of the first scan signal line and the second scan signal line for a pixel area of a previous row.

28. The active matrix substrate according to claim 1, wherein when an extension direction of the scan signal lines is regarded as a row direction, two scan signal lines correspond to two pixel areas arranged in the row direction, and two pixel electrodes are arranged in a column direction in each of the pixel areas, and
wherein a transistor connected to one of the two pixel electrodes adjacent in the row direction is connected to one of the two scan signal lines, and a transistor connected to the other of the two pixel electrodes is connected to the other of the two scan signal lines.

29. A liquid crystal display device comprising:
the active matrix substrate according to claim 1,
wherein the second scan signal line is selected at least once during display.

30. The liquid crystal display device according to claim 29, wherein a common electrode potential has been supplied to the data signal line when the second transistor is turned off.

31. The liquid crystal display device according to claim 30, wherein the first transistor remains on when the second transistor is turned off, or the first transistor is turned off at the same time as the second transistor is turned off.

32. The liquid crystal display device according to claim 29, wherein potentials of the first pixel electrode and the second pixel electrode become substantially a common electrode potential when the second transistor is turned off.

33. The liquid crystal display device according to claim 29, wherein a first gate-on pulse signal supplied to the first scan signal line and a second gate-on pulse signal supplied to the second scan signal line become active during a same horizontal scanning period, and
wherein the second gate-on pulse signal has a pulse width shorter than that of the first gate-on pulse signal, and the second gate-on pulse signal becomes inactive before the first gate-on pulse signal becomes inactive.

34. The liquid crystal display device according to claim 29, wherein a first gate-on pulse signal supplied to the first scan signal line and a second gate-on pulse signal supplied to the second scan signal line become active during a horizontal scanning period immediately prior to a period during which a signal potential of a data signal to be displayed is supplied to the first pixel electrode, and
wherein the second gate-on pulse signal becomes inactive while the first gate-on pulse signal is active.

35. The liquid crystal display device according to claim 29, wherein a common electrode potential is supplied at least twice in each frame to all pixel electrodes of one pixel area.

36. The liquid crystal display device according to claim 35, wherein the common electrode potential is supplied at least twice in each frame to all pixel electrodes of one pixel area after two-thirds of a frame period has passed after a signal potential of a data signal to be displayed is supplied to the first pixel electrode.

37. The liquid crystal display device according to claim 29, wherein a polarity of a signal potential of a data signal supplied to each data signal line is reversed every horizontal scanning period,
wherein when the polarity of the signal potential of the data signal is reversed, a supply of a data signal to each data signal line is terminated for a predetermined period, and each data signal line is short-circuited to each other, and
wherein the first transistor and the second transistor remain on during the predetermined period.

38. The liquid crystal display device according to claim 29, further comprising:
a scan signal line drive circuit driving each scan signal line,
wherein a first gate-on pulse signal and a second gate-on pulse supplied to the first scan signal line and the second scan signal line, respectively, are generated using an output from a same stage of a single shift register included in the scan signal line drive circuit.

39. The liquid crystal display device according to claim 38, wherein the scan signal line drive circuit comprises the shift register, a plurality of logic circuits arranged in the column direction, and an output circuit, and
wherein pulse widths of the first gate-on pulse signal and the second gate-on pulse signal that are outputted from the output circuit are determined based on an output of the shift register and an output control signal controlling an output of the scan signal line drive circuit, both of which are inputted to the logic circuit.

40. The liquid crystal display device according to claim 29, wherein a polarity of a signal potential supplied to the first pixel electrode is reversed every frame.

41. The liquid crystal display device according to claim 29, wherein a polarity of a signal potential supplied to a first data signal line is reversed every horizontal scanning period.

42. The liquid crystal display device according to claim 29, wherein during a single horizontal scanning period, signal potentials having reversed polarities are supplied, respectively, to a first data signal line and to a data signal line adjacent thereto.

43. A liquid crystal panel comprising:
the active matrix substrate according to claim 1.

44. A liquid crystal display unit comprising:
the liquid crystal panel according to claim 43; and
a driver.

45. A liquid crystal display device comprising:
the liquid crystal display unit according to claim 44; and
a light source device.

46. A television receiver comprising:
the liquid crystal display device according to claim 29; and
a tuner for receiving television broadcasting.
